(19) United States
(12) Patent Application Publication
(10) Pub. No.: US 2024/0106601 A1
(43) Pub. Date: Mar. 28, 2024

(54) SIDELINK COHERENCY MANAGEMENT

(71) Applicant: QUALCOMM INCORPORATED, San Diego, CA (US)

(72) Inventors: Alexandros Manolakos, Escondido, CA (US); Kianoush Hosseini, San Diego, CA (US); Wei Yang, San Diego, CA (US); Alberto Rico Alvarino, San Diego, CA (US)

(21) Appl. No.: 18/262,372

(22) PCT Filed: Mar. 18, 2022
(86) PCT No.: PCT/US2022/071225

§ 371 Date: Jul. 20, 2023

(30) Foreign Application Priority Data
Mar. 23, 2021 (GR) 20210100184

(51) Int. Cl. H04L 5/00; H04L 5/14

(52) U.S. Cl. CPC H04L 5/0051; H04L 5/001; H04L 5/0096; H04L 5/14; H04W 92/18

(57) ABSTRACT

Methods, systems, and devices for wireless communications are described. To support sidelink coherency management, a user equipment (UE) may transmit a sidelink reference signal to a second UE on an active bandwidth part (BWP) or on a first component carrier (CC), the sidelink reference signal associated with a subsequent transmission of a sidelink message on the active BWP or on the first CC. The UE or the second UE may determine whether the UE switches to a second active BWP or transmits a second sidelink message on a second CC prior to transmitting the sidelink message. Additionally, or alternatively, the UE or the second UE may determine whether the UE switches between full-duplex mode and/or a half-duplex mode prior to or concurrent with transmitting the sidelink message. Based on the determination, the UE may transmit the sidelink message according to a first set of coherency transmission characteristics.

### CROSS REFERENCES

The present Application is a 371 national stage filing of International PCT Application No. 20210100184 by MANOLAKOS et al. entitled “SIDELINK COHERENCY MANAGEMENT,” filed Mar. 23, 2021; and claims priority to International Patent Application No. PCT/US2022/071225 by MANOLAKOS et al. entitled “SIDELINK COHERENCY MANAGEMENT,” filed Mar. 18, 2022, each of which is assigned to the assignee hereof, and each of which is expressly incorporated by reference in its entirety herein.

### INTRODUCTION

The following relates generally to wireless communications, and more specifically to managing sidelink communications.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

A method for wireless communications at a first wireless device is described. The method may include communicating, with a second wireless device, a sidelink reference signal on a first active bandwidth part (BWP), the sidelink reference signal associated with a subsequent communication of a sidelink message on the first active BWP. The method may further include determining whether a switch to a second active BWP occurs prior to communicating the sidelink message and after communicating the sidelink reference signal. The method may further include communicating the sidelink message on the first active BWP according to a first set of coherency transmission characteristics based on the determining.

An apparatus for wireless communications at a first wireless device is described. The apparatus may include a processor; and memory coupled with the processor, the processor configured to communicate, with a second wireless device, a sidelink reference signal on a first active BWP, the sidelink reference signal associated with a subsequent communication of a sidelink message on the first active BWP. The processor may further be configured to determine whether a switch to a second active BWP occurs prior to communicating the sidelink message and after communicating the sidelink reference signal. The processor may further be configured to communicate the sidelink message on the first active BWP according to a first set of coherency transmission characteristics based on the determining.

Another apparatus for wireless communications at a first wireless device is described. The apparatus may include means for communicating, with a second wireless device, a sidelink reference signal on a first active BWP, the sidelink reference signal associated with a subsequent communication of a sidelink message on the first active BWP. The apparatus may further include means for determining whether a switch to a second active BWP occurs prior to communicating the sidelink message and after communicating the sidelink reference signal. The apparatus may further include means for communicating the sidelink message on the first active BWP according to a first set of coherency transmission characteristics based on the determining.

A non-transitory computer-readable medium storing code for wireless communications at a first wireless device is described. The code may include instructions executable by a processor to communicate, with a second wireless device, a sidelink reference signal on a first active BWP, the sidelink reference signal associated with a subsequent communication of a sidelink message on the first active BWP. The code may further include instructions executable by the processor to determine whether a switch to a second active BWP occurs prior to communicating the sidelink message and after communicating the sidelink reference signal. The code may further include instructions executable by the processor to communicate the sidelink message on the first active BWP according to a first set of coherency transmission characteristics based on the determining.

In some examples of the method, apparatuses, and non-transitory computer-readable medium described herein, communicating the sidelink message may include operations, features, means, or instructions for communicating, based on determining that the switch fails to occur, the sidelink message according to the first set of coherency transmission characteristics such that a relative difference between first communication characteristics associated with communicating the sidelink reference signal and second communication characteristics associated with communicating the sidelink message satisfies a threshold relative difference.

In some examples of the method, apparatuses, and non-transitory computer-readable medium described herein, communicating the sidelink message may include operations, features, means, or instructions for communicating, based on determining that the switch occurs, the sidelink message according to the first set of coherency transmission characteristics such that a relative difference between first communication characteristics associated with communicating the sidelink reference signal and second communication characteristics associated with communicating the sidelink message fails to satisfy a threshold relative difference.

In some examples of the method, apparatuses, and non-transitory computer-readable medium described herein, first communication characteristics associated with communicating the sidelink reference signal include a phase associated with communicating the sidelink reference signal, a transmission power associated with communicating the sidelink reference signal, a time at which the sidelink reference signal may be communicated, or a combination thereof and second communication characteristics associated with communicating the sidelink message include a phase associated with communicating the sidelink message, a transmission power associated with communicating the sidelink message, a time at which the sidelink message may be communicated, or a combination thereof.

Some examples of the method, apparatuses, and non-transitory computer-readable medium described herein may further include operations, features, means, or instructions for communicating, based on determining whether the switch occurs, an indication of whether a relative difference between first communication characteristics associated with communicating the sidelink reference signal and second communication characteristics associated with communicating the sidelink message satisfies a threshold relative difference.

Some examples of the method, apparatuses, and non-transitory computer-readable medium described herein may further include operations, features, means, or instructions for outputting, prior to communicating the sidelink message, an uplink message to a network entity on the second active BWP, where determining whether the switch occurs may be based on outputting the uplink message.

Some examples of the method, apparatuses, and non-transitory computer-readable medium described herein may further include operations, features, means, or instructions for outputting an indication of a capability to maintain coherency between uplink transmissions when switching between active BWPs associated with uplink transmissions to a network entity, where communicating the sidelink message may be based on outputting the indication of the capability.

Some examples of the method, apparatuses, and non-transitory computer-readable medium described herein may further include operations, features, means, or instructions for switching to the second active BWP to output a second sidelink message prior to communicating the sidelink message. Some examples of the method, apparatuses, and non-transitory computer-readable medium described herein may further include operations, features, means, or instructions for outputting, to the second wireless device, the sidelink reference signal having first transmission characteristics and outputting, to the second wireless device, the sidelink message having second transmission characteristics such that a relative difference between the first transmission characteristics and the second transmission characteristics satisfies a threshold relative difference based on the capability.

In some examples of the method, apparatuses, and non-transitory computer-readable medium described herein, the capability may be associated with a particular frequency band or a combination of two or more frequency bands.

In some examples of the method, apparatuses, and non-transitory computer-readable medium described herein, determining whether the switch occurs may include operations, features, means, or instructions for determining whether a switch from a third active BWP to the second active BWP occurs prior to communicating the sidelink message, the first active BWP associated with a first component carrier (CC), the second active BWP and the third active BWP associated with a second CC that may be switched together with the first CC.

In some examples of the method, apparatuses, and non-transitory computer-readable medium described herein, the second CC may be communicated using a same radio frequency chain that may be used to communicate the first CC.

In some examples of the method, apparatuses, and non-transitory computer-readable medium described herein, determining whether the switch occurs may include operations, features, means, or instructions for determining that the second wireless device switches to the second active BWP prior to communicating the sidelink message. Some examples of the method, apparatuses, and non-transitory computer-readable medium described herein may further include operations, features, means, or instructions for outputting, to the second wireless device and prior to communicating the sidelink message, an indication of a precoding matrix, a spatial transmission beam, an antenna group, or a combination thereof, to use to output the sidelink message based on determining that the second wireless device switches to the second active BWP, and obtaining, from the second wireless device, the sidelink message based on outputting the indication of the precoding matrix, the spatial transmission beam, the antenna group, or the combination thereof.

In some examples of the method, apparatuses, and non-transitory computer-readable medium described herein, determining whether the switch occurs may include operations, features, means, or instructions for determining that the second wireless device fails to switch to the second active BWP prior to communicating the sidelink message. Some examples of the method, apparatuses, and non-transitory computer-readable medium described herein may further include operations, features, means, or instructions for obtaining, from the second wireless device, the sidelink message according to the first set of coherency transmission characteristics based on determining that the second wireless device fails to switch to the second active BWP.

In some examples of the method, apparatuses, and non-transitory computer-readable medium described herein, the first active BWP may be an active BWP associated with communicating sidelink messages and the second active BWP may be an active BWP associated with outputting uplink messages to a network entity.

In some examples of the method, apparatuses, and non-transitory computer-readable medium described herein, the first active BWP and the second active BWP may be active BWPs associated with communicating sidelink messages.

A method for wireless communications at a first wireless device is described. The method may include communicating, with a second wireless device, a sidelink reference signal on a first active BWP, the sidelink reference signal associated with a subsequent communication of a sidelink message on the first active BWP. The method may further include determining whether a switch between a first duplex mode and a second duplex mode occurs prior to or concurrent with communicating the sidelink message and after communicating the sidelink reference signal. The method may further include communicating the sidelink message on the first active BWP according to a first set of coherency transmission characteristics based on the determining.

An apparatus for wireless communications at a first wireless device is described. The apparatus may include a processor; and memory coupled with the processor, the processor configured to communicate, with a second wireless device, a sidelink reference signal on a first active BWP, the sidelink reference signal associated with a subsequent communication of a sidelink message on the first active BWP. The processor may further be configured to determine whether a switch between a first duplex mode and a second duplex mode occurs prior to or concurrent with communicating the sidelink message and after communicating the sidelink reference signal. The processor may further be configured to communicate the sidelink message on the first active BWP according to a first set of coherency transmission characteristics based on the determining.

Another apparatus for wireless communications at a first wireless device is described. The apparatus may include means for communicating, with a second wireless device, a sidelink reference signal on a first active BWP, the sidelink reference signal associated with a subsequent communication of a sidelink message on the first active BWP. The apparatus may further include means for determining whether a switch between a first duplex mode and a second duplex mode occurs prior to or concurrent with communicating the sidelink message and after communicating the sidelink reference signal. The apparatus may further include means for communicating the sidelink message on the first active BWP according to a first set of coherency transmission characteristics based on the determining.

A non-transitory computer-readable medium storing code for wireless communications at a first wireless device is described. The code may include instructions executable by a processor to communicate, with a second wireless device, a sidelink reference signal on a first active BWP, the sidelink reference signal associated with a subsequent communication of a sidelink message on the first active BWP. The code may further include instructions executable by the processor to determine whether a switch between a first duplex mode and a second duplex mode occurs prior to or concurrent with communicating the sidelink message and after communicating the sidelink reference signal. The code may further include instructions executable by the processor to communicate the sidelink message on the first active BWP according to a first set of coherency transmission characteristics based on the determining.

In some examples of the method, apparatuses, and non-transitory computer-readable medium described herein, communicating the sidelink message may include operations, features, means, or instructions for communicating, based on determining that the switch fails to occur, the sidelink message according to the first set of coherency transmission characteristics such that a relative difference between first communication characteristics associated with communicating the sidelink reference signal and second communication characteristics associated with communicating the sidelink message satisfies a threshold relative difference.

In some examples of the method, apparatuses, and non-transitory computer-readable medium described herein, communicating the sidelink message may include operations, features, means, or instructions for communicating, based on determining that the switch occurs, the sidelink message according to the first set of coherency transmission characteristics such that a relative difference between first communication characteristics associated with communicating the sidelink reference signal and second communication characteristics associated with communicating the sidelink message fails to satisfy a threshold relative difference.

In some examples of the method, apparatuses, and non-transitory computer-readable medium described herein, the first duplex mode may be a full-duplex mode and the second duplex mode may be a half-duplex mode.

In some examples of the method, apparatuses, and non-transitory computer-readable medium described herein, the first duplex mode may be a first full-duplex mode and the second duplex mode may be a second full-duplex mode, the first full-duplex mode associated with a first uplink bandwidth, a first downlink bandwidth, or a combination thereof, the second full-duplex mode associated with a second uplink bandwidth different from the first uplink bandwidth, a second downlink bandwidth different from the second downlink bandwidth, or a combination thereof.

Some examples of the method, apparatuses, and non-transitory computer-readable medium described herein may further include operations, features, means, or instructions for outputting the sidelink reference signal while operating in the first duplex mode and outputting, prior to communicating the sidelink message and after outputting the sidelink reference signal, a second sidelink message while operating in the second duplex mode, where determining whether the switch occurs may be based on outputting the sidelink reference signal while operating in the first duplex mode and outputting the second sidelink message while operating in the second duplex mode.

Some examples of the method, apparatuses, and non-transitory computer-readable medium described herein may further include operations, features, means, or instructions for outputting the sidelink reference signal while operating in the first duplex mode and outputting the sidelink message while operating in the second duplex mode, where determining whether the switch occurs may be based on outputting the sidelink reference signal while operating in the first duplex mode and outputting the sidelink message while operating in the second duplex mode.

In some examples of the method, apparatuses, and non-transitory computer-readable medium described herein, determining whether the switch occurs may include operations, features, means, or instructions for determining that the second wireless device switches between the first duplex mode and the second duplex mode prior to communicating the sidelink message and after communicating the sidelink reference signal. Some examples of the method, apparatuses, and non-transitory computer-readable medium described herein may further include operations, features, means, or instructions for outputting, to the second wireless device and prior to communicating the sidelink message, an indication of a precoding matrix, a spatial transmission beam, an antenna group, or a combination thereof, to use to output the sidelink message based on determining that the second wireless device switches between the first duplex mode and the second duplex mode, and obtaining, from the second wireless device, the sidelink message based on outputting the indication of the precoding matrix, the spatial transmission beam, the antenna group, or the combination thereof.

A method for wireless communications at a first wireless device is described. The method may include outputting, to a second wireless device, a sidelink reference signal on a first CC, the sidelink reference signal associated with a subsequent output of a first sidelink message on the first CC. The method may further include determining whether to output, to a third wireless device, a second sidelink message on a second CC prior to outputting the first sidelink message and after outputting the sidelink reference signal, where the first sidelink message is output on the first CC using a radio frequency chain according to a first set of parameters and the second sidelink message is output on the second CC using the radio frequency chain according to a second set of parameters that is different from the first set of parameters. The method may further include outputting, to the second wireless device, the first sidelink message according to a first set of coherency transmission characteristics based on the determining.

An apparatus for wireless communications at a first wireless device is described. The apparatus may include a processor; and memory coupled with the processor, the processor configured to output, to a second wireless device, a sidelink reference signal on a first CC, the sidelink reference signal associated with a subsequent output of a first sidelink message on the first CC. The processor may further be configured to determine whether to output, to a third wireless device, a second sidelink message on a second CC prior to outputting the first sidelink message and after outputting the sidelink reference signal, where the first sidelink message is output on the first CC using a radio frequency chain according to a first set of parameters and the second sidelink message is output on the second CC using the radio frequency chain according to a second set of parameters that is different from the first set of parameters. The processor may further be configured to output, to the second wireless device, the first sidelink message according to a first set of coherency transmission characteristics based on the determining.

Another apparatus for wireless communications at a first wireless device is described. The apparatus may include means for outputting, to a second wireless device, a sidelink reference signal on a first CC, the sidelink reference signal associated with a subsequent output of a first sidelink message on the first CC. The apparatus may further include means for determining whether to output, to a third wireless device, a second sidelink message on a second CC prior to outputting the first sidelink message and after outputting the sidelink reference signal, where the first sidelink message is output on the first CC using a radio frequency chain according to a first set of parameters and the second sidelink message is output on the second CC using the radio frequency chain according to a second set of parameters that is different from the first set of parameters. The apparatus may further include means for outputting, to the second wireless device, the first sidelink message according to a first set of coherency transmission characteristics based on the determining.

A non-transitory computer-readable medium storing code for wireless communications at a first wireless device is described. The code may include instructions executable by a processor to output, to a second wireless device, a sidelink reference signal on a first CC, the sidelink reference signal associated with a subsequent output of a first sidelink message on the first CC. The code may further include instructions executable by the processor to determine whether to output, to a third wireless device, a second sidelink message on a second CC prior to outputting the first sidelink message and after outputting the sidelink reference signal, where the first sidelink message is output on the first CC using a radio frequency chain according to a first set of parameters and the second sidelink message is output on the second CC using the radio frequency chain according to a second set of parameters that is different from the first set of parameters. The code may further include instructions executable by the processor to output, to the second wireless device, the first sidelink message according to a first set of coherency transmission characteristics based on the determining.

In some examples of the method, apparatuses, and non-transitory computer-readable medium described herein, outputting the first sidelink message may include operations, features, means, or instructions for outputting, based on failing to output the second sidelink message, the first sidelink message according to the first set of coherency transmission characteristics such that a relative difference between first transmission characteristics associated with outputting the sidelink reference signal and second transmission characteristics associated with outputting the first sidelink message satisfies a threshold relative difference.

Some examples of the method, apparatuses, and non-transitory computer-readable medium described herein may further include operations, features, means, or instructions for outputting the second sidelink message on the second CC, the outputting the first sidelink message including and outputting, based on outputting the second sidelink message, the first sidelink message according to the first set of coherency transmission characteristics such that a relative difference between first transmission characteristics associated with outputting the sidelink reference signal and second transmission characteristics associated with outputting the first sidelink message fails to satisfy a threshold relative difference.

Some examples of the method, apparatuses, and non-transitory computer-readable medium described herein may further include operations, features, means, or instructions for obtaining an indication of a precoding matrix, a spatial transmission beam, an antenna group, or a combination thereof, to use to output the first sidelink message based on the determining, where outputting the first sidelink message includes outputting the first sidelink message according to the indicated precoding matrix, spatial transmission beam, antenna group, or combination thereof.

A method for wireless communication at a first wireless device is described. The method may include obtaining, from a second wireless device, a sidelink reference signal on a first CC, the sidelink reference signal associated with a subsequent output of a first sidelink message on the first CC. The method may further include outputting, to the second wireless device, an indication of a precoding matrix to use to output the first sidelink message, the precoding matrix based at least in part determining whether coherent reception of the sidelink reference signal and the first sidelink message is expected at the first wireless device. The method may further include obtaining the first sidelink message based on outputting the indication of the precoding matrix.

An apparatus for wireless communication at a first wireless device is described. The apparatus may include a processor; memory coupled with the processor, the processor configured to obtain, from a second wireless device, a sidelink reference signal on a first CC, the sidelink reference signal associated with a subsequent output of a first sidelink message on the first CC. The processor may be further configured to output, to the second wireless device, an indication of a precoding matrix to use to output the first sidelink message, the precoding matrix based at least in part determining whether coherent reception of the sidelink reference signal and the first sidelink message is expected at the first wireless device. The processor may be further configured to obtain the first sidelink message based on outputting the indication of the precoding matrix.

Another apparatus for wireless communication at a first wireless device is described. The apparatus may include means for obtaining, from a second wireless device, a sidelink reference signal on a first CC, the sidelink reference signal associated with a subsequent output of a first sidelink message on the first CC. The apparatus may further include means for outputting, to the second wireless device, an indication of a precoding matrix to use to output the first sidelink message, the precoding matrix based at least in part determining whether coherent reception of the sidelink reference signal and the first sidelink message is expected at the first wireless device. The apparatus may further include means for obtaining the first sidelink message based on outputting the indication of the precoding matrix.

A non-transitory computer-readable medium storing code for wireless communication at a first wireless device is described. The code may include instructions executable by a processor to obtain, from a second wireless device, a sidelink reference signal on a first CC, the sidelink reference signal associated with a subsequent output of a first sidelink message on the first CC. The code may further include instructions executable by the processor to output, to the second wireless device, an indication of a precoding matrix to use to output the first sidelink message, the precoding matrix based at least in part determining whether coherent reception of the sidelink reference signal and the first sidelink message is expected at the first wireless device. The code may further include instructions executable by the processor to obtain the first sidelink message based on outputting the indication of the precoding matrix.

Some examples of the method, apparatuses, and non-transitory computer-readable medium described herein may further include operations, features, means, or instructions for determining whether coherent reception of the sidelink reference signal and the first sidelink message may be expected at the first wireless device based on obtaining an indication from the second wireless device that the second wireless device will coherently output the first sidelink message.

Some examples of the method, apparatuses, and non-transitory computer-readable medium described herein may further include operations, features, means, or instructions for determining whether coherent reception of the sidelink reference signal and the first sidelink message may be expected at the first wireless device based on decoding sidelink control information output by the first wireless device to determine whether the first wireless device outputs a second sidelink message on a second CC prior to outputting the first sidelink message and after outputting the sidelink reference signal.

A method for wireless communications at a first wireless device is described. The method may include communicating, with a second wireless device, a sidelink reference signal on a first CC, the sidelink reference signal associated with a subsequent communication of a sidelink message on the first CC, determining whether a switch to a second CC occurs prior to communicating the sidelink message and after communicating the sidelink reference signal, and communicating the sidelink message on the first CC according to a first set of coherency transmission characteristics based on the determining.

An apparatus for wireless communications at a first wireless device is described. The apparatus may include a processor; and memory coupled to the processor, the processor and memory configured to communicate, with a second wireless device, a sidelink reference signal on a first CC, the sidelink reference signal associated with a subsequent communication of a sidelink message on the first CC, determine whether a switch to a second CC occurs prior to communicating the sidelink message and after communicating the sidelink reference signal, and communicate the sidelink message on the first CC according to a first set of coherency transmission characteristics based on the determining.

Another apparatus for wireless communications at a first wireless device is described. The apparatus may include means for communicating, with a second wireless device, a sidelink reference signal on a first CC, the sidelink reference signal associated with a subsequent communication of a sidelink message on the first CC, means for determining whether a switch to a second CC occurs prior to communicating the sidelink message and after communicating the sidelink reference signal, and means for communicating the sidelink message on the first CC according to a first set of coherency transmission characteristics based on the determining.

A non-transitory computer-readable medium storing code for wireless communications at a first wireless device is described. The code may include instructions executable by a processor to communicate, with a second wireless device, a sidelink reference signal on a first CC, the sidelink reference signal associated with a subsequent communication of a sidelink message on the first CC, determine whether a switch to a second CC occurs prior to communicating the sidelink message and after communicating the sidelink reference signal, and communicate the sidelink message on the first CC according to a first set of coherency transmission characteristics based on the determining.

In some examples of the method, apparatuses, and non-transitory computer-readable medium described herein, communicating the sidelink message may include operations, features, means, or instructions for communicating, based on determining that the switch fails to occur, the sidelink message according to the first set of coherency transmission characteristics such that a relative difference between first communication characteristics associated with communicating the sidelink reference signal and second communication characteristics associated with communicating the sidelink message satisfies a threshold relative difference.

In some examples of the method, apparatuses, and non-transitory computer-readable medium described herein, communicating the sidelink message may include operations, features, means, or instructions for communicating, based on determining that the switch occurs, the sidelink message according to the first set of coherency transmission characteristics such that a relative difference between first communication characteristics associated with communicating the sidelink reference signal and second communication characteristics associated with communicating the sidelink message fails to satisfy a threshold relative difference.

In some examples of the method, apparatuses, and non-transitory computer-readable medium described herein, first communication characteristics associated with communicating the sidelink reference signal include a phase associated with communicating the sidelink reference signal, a transmission power associated with communicating the sidelink reference signal, a time at which the sidelink reference signal may be communicated, or a combination thereof; and second communication characteristics associated with communicating the sidelink message include a phase associated with communicating the sidelink message, a transmission power associated with communicating the sidelink message, a time at which the sidelink message may be communicated, or a combination thereof.

Some examples of the method, apparatuses, and non-transitory computer-readable medium described herein may further include operations, features, means, or instructions for communicating, based on determining whether the switch occurs, an indication of whether a relative difference between first communication characteristics associated with communicating the sidelink reference signal and second communication characteristics associated with communicating the sidelink message satisfies a threshold relative difference.

Some examples of the method, apparatuses, and non-transitory computer-readable medium described herein may further include operations, features, means, or instructions for outputting, prior to communicating the sidelink message, an uplink message to a network entity on the second CC, where determining whether the switch occurs may be based on outputting the uplink message.

Some examples of the method, apparatuses, and non-transitory computer-readable medium described herein may further include operations, features, means, or instructions for outputting an indication of a capability to maintain coherency between uplink transmissions when switching between CCs associated with uplink transmissions to a network entity, where communicating the sidelink message may be based on outputting the indication of the capability.

Some examples of the method, apparatuses, and non-transitory computer-readable medium described herein may further include operations, features, means, or instructions for switching to the second CC to output a second sidelink message prior to communicating the sidelink message; outputting, to the second wireless device, the sidelink reference signal having first transmission characteristics and outputting, to the second wireless device, the sidelink message having second transmission characteristics such that a relative difference between the first transmission characteristics and the second transmission characteristics satisfies a threshold relative difference based on the capability.

In some examples of the method, apparatuses, and non-transitory computer-readable medium described herein, the capability may be associated with a particular frequency band or a combination of two or more frequency bands.

In some examples of the method, apparatuses, and non-transitory computer-readable medium described herein, the second CC may be communicated using a same radio frequency chain that may be used to communicate the first CC.

In some examples of the method, apparatuses, and non-transitory computer-readable medium described herein, determining whether the switch occurs may include operations, features, means, or instructions for determining that the second wireless device switches to the CC prior to communicating the sidelink message. Some examples of the method, apparatuses, and non-transitory computer-readable medium described herein may further include operations, features, means, or instructions for outputting, to the second wireless device and prior to communicating the sidelink message, an indication of a precoding matrix, a spatial transmission beam, an antenna group, or a combination thereof, to use to output the sidelink message based on determining that the second wireless device switches to the second CC and obtaining, from the second wireless device, the sidelink message based on outputting the indication of the precoding matrix, the spatial transmission beam, the antenna group, or the combination thereof.

In some examples of the method, apparatuses, and non-transitory computer-readable medium described herein, determining whether the switch occurs may include operations, features, means, or instructions for determining that the second wireless device fails to switch to the second CC prior to communicating the sidelink message. Some examples of the method, apparatuses, and non-transitory computer-readable medium described herein may further include operations, features, means, or instructions for obtaining, from the second wireless device, the sidelink message according to the first set of coherency transmission characteristics based on determining that the second wireless device fails to switch to the second CC.

A method for wireless communications at a first wireless device is described. The method may include communicating, with a second wireless device, a sidelink reference signal on a first CC, the sidelink reference signal associated with a subsequent communication of a sidelink message on the first CC, determining whether a switch between a first duplex mode and a second duplex mode occurs prior to or concurrent with communicating the sidelink message and after communicating the sidelink reference signal, and communicating the sidelink message on the first CC according to a first set of coherency transmission characteristics based on the determining.

An apparatus for wireless communications at a first wireless device is described. The apparatus may include a processor; and memory coupled to the processor, the processor and memory configured to communicate, with a second wireless device, a sidelink reference signal on a first CC, the sidelink reference signal associated with a subsequent communication of a sidelink message on the first CC, determine whether a switch between a first duplex mode and a second duplex mode occurs prior to or concurrent with communicating the sidelink message and after communicating the sidelink reference signal, and communicate the sidelink message on the first CC according to a first set of coherency transmission characteristics based on the determining.

Another apparatus for wireless communications at a first wireless device is described. The apparatus may include means for communicating, with a second wireless device, a sidelink reference signal on a first CC, the sidelink reference signal associated with a subsequent communication of a sidelink message on the first CC, means for determining whether a switch between a first duplex mode and a second duplex mode occurs prior to or concurrent with communicating the sidelink message and after communicating the sidelink reference signal, and means for communicating the sidelink message on the first CC according to a first set of coherency transmission characteristics based on the determining.

A non-transitory computer-readable medium storing code for wireless communications at a first wireless device is described. The code may include instructions executable by a processor to communicate, with a second wireless device, a sidelink reference signal on a first CC, the sidelink reference signal associated with a subsequent communication of a sidelink message on the first CC, determine whether a switch between a first duplex mode and a second duplex mode occurs prior to or concurrent with communicating the sidelink message and after communicating the sidelink reference signal, and communicate the sidelink message on the first CC according to a first set of coherency transmission characteristics based on the determining.

In some examples of the method, apparatuses, and non-transitory computer-readable medium described herein, communicating the sidelink message may include operations, features, means, or instructions for communicating, based on determining that the switch fails to occur, the sidelink message according to the first set of coherency transmission characteristics such that a relative difference between first communication characteristics associated with communicating the sidelink reference signal and second communication characteristics associated with communicating the sidelink message satisfies a threshold relative difference.

In some examples of the method, apparatuses, and non-transitory computer-readable medium described herein, communicating the sidelink message may include operations, features, means, or instructions for communicating, based on determining that the switch occurs, the sidelink message according to the first set of coherency transmission characteristics such that a relative difference between first communication characteristics associated with communicating the sidelink reference signal and second communication characteristics associated with communicating the sidelink message fails to satisfy a threshold relative difference.

In some examples of the method, apparatuses, and non-transitory computer-readable medium described herein, first communication characteristics associated with communicating the sidelink reference signal include a phase associated with communicating the sidelink reference signal, a transmission power associated with communicating the sidelink reference signal, a time at which the sidelink reference signal may be communicated, or a combination thereof; and second communication characteristics associated with communicating the sidelink message include a phase associated with communicating the sidelink message, a transmission power associated with communicating the sidelink message, a time at which the sidelink message may be communicated, or a combination thereof.

In some examples of the method, apparatuses, and non-transitory computer-readable medium described herein, the first duplex mode may be a full-duplex mode and the second duplex mode may be a half-duplex mode.

In some examples of the method, apparatuses, and non-transitory computer-readable medium described herein, the first duplex mode may be a first full-duplex mode and the second duplex mode may be a second full-duplex mode, the first full-duplex mode associated with a first uplink bandwidth, a first downlink bandwidth, or a combination thereof, the second full-duplex mode associated with a second uplink bandwidth different from the first uplink bandwidth, a second downlink bandwidth different from the second downlink bandwidth, or a combination thereof.

Some examples of the method, apparatuses, and non-transitory computer-readable medium described herein may further include operations, features, means, or instructions for outputting the sidelink reference signal while operating in the first duplex mode; and outputting, prior to communicating the sidelink message and after outputting the sidelink reference signal, a second sidelink message while operating in the second duplex mode, where determining whether the switch occurs may be based on outputting the sidelink reference signal while operating in the first duplex mode and outputting the second sidelink message while operating in the second duplex mode.

Some examples of the method, apparatuses, and non-transitory computer-readable medium described herein may further include operations, features, means, or instructions for outputting the sidelink reference signal while operating in the first duplex mode and outputting the sidelink message while operating in the second duplex mode, where determining whether the switch occurs may be based on outputting the sidelink reference signal while operating in the first duplex mode and outputting the sidelink message while operating in the second duplex mode.

In some examples of the method, apparatuses, and non-transitory computer-readable medium described herein, determining whether the switch occurs may include operations, features, means, or instructions for determining that the second wireless device switches between the first duplex mode and the second duplex mode prior to communicating the sidelink message and after communicating the sidelink reference signal. Some examples of the method, apparatuses, and non-transitory computer-readable medium described herein may further include operations, features, means, or instructions for outputting, to the second wireless device and prior to communicating the sidelink message, an indication of a precoding matrix, a spatial transmission beam, an antenna group, or a combination thereof, to use to output the sidelink message based on determining that the second wireless device switches between the first duplex mode and the second duplex mode and obtaining, from the second wireless device, the sidelink message based on outputting the indication of the precoding matrix, the spatial transmission beam, the antenna group, or the combination thereof.

A method for wireless communications at a first wireless device is described. The method may include communicating, with a second wireless device, a sidelink reference signal on a first active BWP, the sidelink reference signal associated with a subsequent communication of a sidelink message on the first active BWP. The method may further include determining whether a switch to a second active BWP occurs prior to communicating the sidelink message and after communicating the sidelink reference signal. The method may further include communicating the sidelink message on the first active BWP according to a first set of coherency transmission characteristics based on the determining.

An apparatus for wireless communications at a first wireless device is described. The apparatus may include a processor; and memory coupled to the processor, the processor and memory configured to communicate, with a second wireless device, a sidelink reference signal on a first active BWP, the sidelink reference signal associated with a subsequent communication of a sidelink message on the first active BWP. The processor and memory may be further configured to determine whether a switch to a second active BWP occurs prior to communicating the sidelink message and after communicating the sidelink reference signal. The processor and memory may be further configured to communicate the sidelink message on the first active BWP according to a first set of coherency transmission characteristics based on the determining.

Another apparatus for wireless communications at a first wireless device is described. The apparatus may include means for communicating, with a second wireless device, a sidelink reference signal on a first active BWP, the sidelink reference signal associated with a subsequent communication of a sidelink message on the first active BWP. The apparatus may further include means for determining whether a switch to a second active BWP occurs prior to communicating the sidelink message and after communicating the sidelink reference signal. The apparatus may further include means for communicating the sidelink message on the first active BWP according to a first set of coherency transmission characteristics based on the determining.

A non-transitory computer-readable medium storing code for wireless communications at a first wireless device is described. The code may include instructions executable by a processor to communicate, with a second wireless device, a sidelink reference signal on a first active BWP, the sidelink reference signal associated with a subsequent communication of a sidelink message on the first active BWP. The code may further include instructions executable by the processor to determine whether a switch to a second active BWP occurs prior to communicating the sidelink message and after communicating the sidelink reference signal. The code may further include instructions executable by the processor to communicate the sidelink message on the first active BWP according to a first set of coherency transmission characteristics based on the determining.

Some examples of the method, apparatuses, and non-transitory computer-readable medium described herein may further include operations, features, means, or instructions for communicating, based on determining that the switch fails to occur, the sidelink message according to the first set of coherency transmission characteristics such that a relative difference between first communication characteristics associated with communicating the sidelink reference signal and second communication characteristics associated with communicating the sidelink message satisfies a threshold relative difference.

Some examples of the method, apparatuses, and non-transitory computer-readable medium described herein may further include operations, features, means, or instructions for communicating, based on determining that the switch occurs, the sidelink message according to the first set of coherency transmission characteristics such that a relative difference between first communication characteristics associated with communicating the sidelink reference signal and second communication characteristics associated with communicating the sidelink message fails to satisfy a threshold relative difference.

In some examples of the method, apparatuses, and non-transitory computer-readable medium described herein, first communication characteristics associated with communicating the sidelink reference signal include a phase associated with communicating the sidelink reference signal, a transmission power associated with communicating the sidelink reference signal, a time at which the sidelink reference signal may be communicated, or a combination thereof. In some examples of the method, apparatuses, and non-transitory computer-readable medium described herein, second communication characteristics associated with communicating the sidelink message include a phase associated with communicating the sidelink message, a transmission power associated with communicating the sidelink message, a time at which the sidelink message may be communicated, or a combination thereof.

Some examples of the method, apparatuses, and non-transitory computer-readable medium described herein may further include operations, features, means, or instructions for communicating, based on determining whether the switch occurs, an indication of whether a relative difference between first communication characteristics associated with communicating the sidelink reference signal and second communication characteristics associated with communicating the sidelink message satisfies a threshold relative difference.

Some examples of the method, apparatuses, and non-transitory computer-readable medium described herein may further include operations, features, means, or instructions for transmitting, prior to communicating the sidelink message, an uplink message to a base station on the second active BWP, where determining whether the switch occurs may be based on transmitting the uplink message.

Some examples of the method, apparatuses, and non-transitory computer-readable medium described herein may further include operations, features, means, or instructions for transmitting an indication of a capability to maintain coherency between uplink transmissions when switching between active BWPs associated with uplink transmissions to a base station, where communicating the sidelink message may be based on transmitting the indication of the capability.

Some examples of the method, apparatuses, and non-transitory computer-readable medium described herein may further include operations, features, means, or instructions for switching to the second active BWP to transmit a second sidelink message prior to communicating the sidelink message. Some examples of the method, apparatuses, and non-transitory computer-readable medium described herein may further include operations, features, means, or instructions for transmitting, to the second wireless device, the sidelink reference signal having first transmission characteristics and transmitting, to the second wireless device, the sidelink message having second transmission characteristics such that a relative difference between the first transmission characteristics and the second transmission characteristics satisfies a threshold relative difference based on the capability.

In some examples of the method, apparatuses, and non-transitory computer-readable medium described herein, the capability may be associated with a particular frequency band or a combination of two or more frequency bands.

Some examples of the method, apparatuses, and non-transitory computer-readable medium described herein may further include operations, features, means, or instructions for determining whether a switch from a third active BWP to the second active BWP occurs prior to communicating the sidelink message, the first active BWP associated with a first CC, the second active BWP and the third active BWP associated with a second CC that may be switched together with the first CC.

In some examples of the method, apparatuses, and non-transitory computer-readable medium described herein, the second CC may be communicated using a same radio frequency chain that may be used to communicate the first CC.

Some examples of the method, apparatuses, and non-transitory computer-readable medium described herein may further include operations, features, means, or instructions for determining that the second wireless device switches to the second active BWP prior to communicating the sidelink message. Some examples of the method, apparatuses, and non-transitory computer-readable medium described herein may further include operations, features, means, or instructions for transmitting, to the second wireless device and prior to communicating the sidelink message, an indication of a precoding matrix, a spatial transmission beam, an antenna group, or a combination thereof, to use to transmit the sidelink message based on determining that the second wireless device switches to the second active BWP and receiving, from the second wireless device, the sidelink message based on transmitting the indication of the precoding matrix, the spatial transmission beam, the antenna group, or the combination thereof.

Some examples of the method, apparatuses, and non-transitory computer-readable medium described herein may further include operations, features, means, or instructions for determining that the second wireless device fails to switch to the second active BWP prior to communicating the sidelink message. Some examples of the method, apparatuses, and non-transitory computer-readable medium described herein may further include operations, features, means, or instructions for receiving, from the second wireless device, the sidelink message according to the first set of coherency transmission characteristics based on determining that the second wireless device fails to switch to the second active BWP.

In some examples of the method, apparatuses, and non-transitory computer-readable medium described herein, the first active BWP may be an active BWP associated with communicating sidelink messages and the second active BWP may be an active BWP associated with transmitting uplink messages to a base station.

In some examples of the method, apparatuses, and non-transitory computer-readable medium described herein, the first active BWP and the second active BWP may be active BWPs associated with communicating sidelink messages.

A method for wireless communications at a first wireless device is described. The method may include communicating, with a second wireless device, a sidelink reference signal on a first active BWP, the sidelink reference signal associated with a subsequent communication of a sidelink message on the first active BWP. The method may further include determining whether a switch between a first duplex mode and a second duplex mode occurs prior to or concurrent with communicating the sidelink message and after communicating the sidelink reference signal. The method may further include communicating the sidelink message on the first active BWP according to a first set of coherency transmission characteristics based on the determining.

An apparatus for wireless communications at a first wireless device is described. The apparatus may include a processor; and memory coupled to the processor, the processor and memory configured to communicate, with a second wireless device, a sidelink reference signal on a first active BWP, the sidelink reference signal associated with a subsequent communication of a sidelink message on the first active BWP. The processor and memory may be further configured to determine whether a switch between a first duplex mode and a second duplex mode occurs prior to or concurrent with communicating the sidelink message and after communicating the sidelink reference signal. The processor and memory may be further configured to communicate the sidelink message on the first active BWP according to a first set of coherency transmission characteristics based on the determining.

Another apparatus for wireless communications at a first wireless device is described. The apparatus may include means for communicating, with a second wireless device, a sidelink reference signal on a first active BWP, the sidelink reference signal associated with a subsequent communication of a sidelink message on the first active BWP. The apparatus may further include means for determining whether a switch between a first duplex mode and a second duplex mode occurs prior to or concurrent with communicating the sidelink message and after communicating the sidelink reference signal The apparatus may further include means for communicating the sidelink message on the first active BWP according to a first set of coherency transmission characteristics based on the determining.

A non-transitory computer-readable medium storing code for wireless communications at a first wireless device is described. The code may include instructions executable by a processor to communicate, with a second wireless device, a sidelink reference signal on a first active BWP, the sidelink reference signal associated with a subsequent communication of a sidelink message on the first active BWP. The code may further include instructions executable by the processor to determine whether a switch between a first duplex mode and a second duplex mode occurs prior to or concurrent with communicating the sidelink message and after communicating the sidelink reference signal. The code may further include instructions executable by the processor to communicate the sidelink message on the first active BWP according to a first set of coherency transmission characteristics based on the determining.

Some examples of the method, apparatuses, and non-transitory computer-readable medium described herein may further include operations, features, means, or instructions for communicating, based on determining that the switch fails to occur, the sidelink message according to the first set of coherency transmission characteristics such that a relative difference between first communication characteristics associated with communicating the sidelink reference signal and second communication characteristics associated with communicating the sidelink message satisfies a threshold relative difference.

Some examples of the method, apparatuses, and non-transitory computer-readable medium described herein may further include operations, features, means, or instructions for communicating, based on determining that the switch occurs, the sidelink message according to the first set of coherency transmission characteristics such that a relative difference between first communication characteristics associated with communicating the sidelink reference signal and second communication characteristics associated with communicating the sidelink message fails to satisfy a threshold relative difference.

In some examples of the method, apparatuses, and non-transitory computer-readable medium described herein, first communication characteristics associated with communicating the sidelink reference signal include a phase associated with communicating the sidelink reference signal, a transmission power associated with communicating the sidelink reference signal, a time at which the sidelink reference signal may be communicated, or a combination thereof. In some examples of the method, apparatuses, and non-transitory computer-readable medium described herein, second communication characteristics associated with communicating the sidelink message include a phase associated with communicating the sidelink message, a transmission power associated with communicating the sidelink message, a time at which the sidelink message may be communicated, or a combination thereof.

In some examples of the method, apparatuses, and non-transitory computer-readable medium described herein, the first duplex mode may be a full-duplex mode and the second duplex mode may be a half-duplex mode.

In some examples of the method, apparatuses, and non-transitory computer-readable medium described herein, the first duplex mode may be a first full-duplex mode and the second duplex mode may be a second full-duplex mode, the first full-duplex mode associated with a first uplink bandwidth, a first downlink bandwidth, or a combination thereof, the second full-duplex mode associated with a second uplink bandwidth different from the first uplink bandwidth, a second downlink bandwidth different from the second downlink bandwidth, or a combination thereof.

Some examples of the method, apparatuses, and non-transitory computer-readable medium described herein may further include operations, features, means, or instructions for transmitting the sidelink reference signal while operating in the first duplex mode and transmitting, prior to communicating the sidelink message and after transmitting the sidelink reference signal, a second sidelink message while operating in the second duplex mode, where determining whether the switch occurs may be based on transmitting the sidelink reference signal while operating in the first duplex mode and transmitting the second sidelink message while operating in the second duplex mode.

Some examples of the method, apparatuses, and non-transitory computer-readable medium described herein may further include operations, features, means, or instructions for transmitting the sidelink reference signal while operating in the first duplex mode and transmitting the sidelink message while operating in the second duplex mode, where determining whether the switch occurs may be based on transmitting the sidelink reference signal while operating in the first duplex mode and transmitting the sidelink message while operating in the second duplex mode.

Some examples of the method, apparatuses, and non-transitory computer-readable medium described herein may further include operations, features, means, or instructions for determining that the second wireless device switches between the first duplex mode and the second duplex mode prior to communicating the sidelink message and after communicating the sidelink reference signal. Some examples of the method, apparatuses, and non-transitory computer-readable medium described herein may further include operations, features, means, or instructions for transmitting, to the second wireless device and prior to communicating the sidelink message, an indication of a precoding matrix, a spatial transmission beam, an antenna group, or a combination thereof, to use to transmit the sidelink message based on determining that the second wireless device switches between the first duplex mode and the second duplex mode and receiving, from the second wireless device, the sidelink message based on transmitting the indication of the precoding matrix, the spatial transmission beam, the antenna group, or the combination thereof.

A method for wireless communications at a first wireless device is described. The method may include transmitting, to a second wireless device, a sidelink reference signal on a first CC, the sidelink reference signal associated with a subsequent transmission of a first sidelink message on the first CC. The method may further include determining whether to transmit, to a third wireless device, a second sidelink message on a second CC prior to transmitting the first sidelink message and after transmitting the sidelink reference signal, where the first sidelink message is transmitted on the first CC using a radio frequency chain according to a first set of parameters and the second sidelink message is transmitted on the second CC using the radio frequency chain according to a second set of parameters that is different from the first set of parameters. The method may further include transmitting, to the second wireless device, the first sidelink message according to a first set of coherency transmission characteristics based on the determining.

An apparatus for wireless communications at a first wireless device is described. The apparatus may include a processor; and memory coupled to the processor, the processor and memory configured to transmit, to a second wireless device, a sidelink reference signal on a first CC, the sidelink reference signal associated with a subsequent transmission of a first sidelink message on the first CC. The processor and memory may be further configured to determine whether to transmit, to a third wireless device, a second sidelink message on a second CC prior to transmitting the first sidelink message and after transmitting the sidelink reference signal, where the first sidelink message is transmitted on the first CC using a radio frequency chain according to a first set of parameters and the second sidelink message is transmitted on the second CC using the radio frequency chain according to a second set of parameters that is different from the first set of parameters. The processor and memory may be further configured to transmit, to the second wireless device, the first sidelink message according to a first set of coherency transmission characteristics based on the determining.

Another apparatus for wireless communications at a first wireless device is described. The apparatus may include means for transmitting, to a second wireless device, a sidelink reference signal on a first CC, the sidelink reference signal associated with a subsequent transmission of a first sidelink message on the first CC. The apparatus may further include means for determining whether to transmit, to a third wireless device, a second sidelink message on a second CC prior to transmitting the first sidelink message and after transmitting the sidelink reference signal, where the first sidelink message is transmitted on the first CC using a radio frequency chain according to a first set of parameters and the second sidelink message is transmitted on the second CC using the radio frequency chain according to a second set of parameters that is different from the first set of parameters. The apparatus may further include means for transmitting, to the second wireless device, the first sidelink message according to a first set of coherency transmission characteristics based on the determining.

A non-transitory computer-readable medium storing code for wireless communications at a first wireless device is described. The code may include instructions executable by a processor to transmit, to a second wireless device, a sidelink reference signal on a first CC, the sidelink reference signal associated with a subsequent transmission of a first sidelink message on the first CC. The code may further include instructions executable by the processor to determine whether to transmit, to a third wireless device, a second sidelink message on a second CC prior to transmitting the first sidelink message and after transmitting the sidelink reference signal, where the first sidelink message is transmitted on the first CC using a radio frequency chain according to a first set of parameters and the second sidelink message is transmitted on the second CC using the radio frequency chain according to a second set of parameters that is different from the first set of parameters. The code may further include instructions executable by the processor to transmit, to the second wireless device, the first sidelink message according to a first set of coherency transmission characteristics based on the determining.

Some examples of the method, apparatuses, and non-transitory computer-readable medium described herein may further include operations, features, means, or instructions for transmitting, based on failing to transmit the second sidelink message, the first sidelink message according to the first set of coherency transmission characteristics such that a relative difference between first transmission characteristics associated with transmitting the sidelink reference signal and second transmission characteristics associated with transmitting the first sidelink message satisfies a threshold relative difference.

Some examples of the method, apparatuses, and non-transitory computer-readable medium described herein may further include operations, features, means, or instructions for transmitting the second sidelink message on the second CC, the transmitting the first sidelink message including and transmitting, based on transmitting the second sidelink message, the first sidelink message according to the first set of coherency transmission characteristics such that a relative difference between first transmission characteristics associated with transmitting the sidelink reference signal and second transmission characteristics associated with transmitting the first sidelink message fails to satisfy a threshold relative difference.

In some examples of the method, apparatuses, and non-transitory computer-readable medium described herein, first transmission characteristics associated with transmitting the sidelink reference signal include a phase associated with transmitting the sidelink reference signal, a transmission power for transmitting the sidelink reference signal, a time at which the sidelink reference signal may be transmitted, or a combination thereof. In some examples of the method, apparatuses, and non-transitory computer-readable medium described herein, second transmission characteristics associated with transmitting the first sidelink message include a phase associated with transmitting the first sidelink message, a transmission power for transmitting the first sidelink message, a time at which the first sidelink message may be transmitted, or a combination thereof.

Some examples of the method, apparatuses, and non-transitory computer-readable medium described herein may further include operations, features, means, or instructions for receiving an indication of a precoding matrix, a spatial transmission beam, an antenna group, or a combination thereof, to use to transmit the first sidelink message based on the determining, where transmitting the first sidelink message includes transmitting the first sidelink message according to the indicated precoding matrix, spatial transmission beam, antenna group, or combination thereof.

A method for wireless communication at a first wireless device is described. The method may include receiving, from a second wireless device, a sidelink reference signal on a first CC, the sidelink reference signal associated with a subsequent transmission of a first sidelink message on the first CC. The method may further include transmitting, to the second wireless device, an indication of a precoding matrix to use to transmit the first sidelink message, the precoding matrix based on determining whether coherent reception of the sidelink reference signal and the first sidelink message is expected at the first wireless device. The method may further include receiving the first sidelink message based on transmitting the indication of the precoding matrix.

An apparatus for wireless communication at a first wireless device is described. The apparatus may include a processor; and memory coupled to the processor, the processor and memory configured to receive, from a second wireless device, a sidelink reference signal on a first CC, the sidelink reference signal associated with a subsequent transmission of a first sidelink message on the first CC. The processor and memory may be further configured to transmit, to the second wireless device, an indication of a precoding matrix to use to transmit the first sidelink message, the precoding matrix based on determining whether coherent reception of the sidelink reference signal and the first sidelink message is expected at the first wireless device. The processor and memory may be further configured to receive the first sidelink message based on transmitting the indication of the precoding matrix.

Another apparatus for wireless communication at a first wireless device is described. The apparatus may include means for receiving, from a second wireless device, a sidelink reference signal on a first CC, the sidelink reference signal associated with a subsequent transmission of a first sidelink message on the first CC. The apparatus may further include means for transmitting, to the second wireless device, an indication of a precoding matrix to use to transmit the first sidelink message, the precoding matrix based on determining whether coherent reception of the sidelink reference signal and the first sidelink message is expected at the first wireless device. The apparatus may further include means for receiving the first sidelink message based on transmitting the indication of the precoding matrix.

A non-transitory computer-readable medium storing code for wireless communication at a first wireless device is described. The code may include instructions executable by a processor to receive, from a second wireless device, a sidelink reference signal on a first CC, the sidelink reference signal associated with a subsequent transmission of a first sidelink message on the first CC. The code may further include instructions executable by the processor to transmit, to the second wireless device, an indication of a precoding matrix to use to transmit the first sidelink message, the precoding matrix based on determining whether coherent reception of the sidelink reference signal and the first sidelink message is expected at the first wireless device. The code may further include instructions executable by the processor to receive the first sidelink message based on transmitting the indication of the precoding matrix.

Some examples of the method, apparatuses, and non-transitory computer-readable medium described herein may further include operations, features, means, or instructions for determining whether coherent reception of the sidelink reference signal and the first sidelink message is expected at the first wireless device based on receiving an indication from the second wireless device that the second wireless device will coherently transmit the first sidelink message.

Some examples of the method, apparatuses, and non-transitory computer-readable medium described herein may further include operations, features, means, or instructions for determining whether coherent reception of the sidelink reference signal and the first sidelink message is expected at the first wireless device based on decoding sidelink control information transmitted by the first wireless device to determine whether the first wireless device transmits a second sidelink message on a second component carrier prior to transmitting the first sidelink message and after transmitting the sidelink reference signal.

Some examples of the method, apparatuses, and non-transitory computer-readable medium described herein may further include operations, features, means, or instructions for selecting the precoding matrix based on determining that coherent reception of the sidelink reference signal and the first sidelink message is not expected, where the selected precoding matrix may be associated with non-coherent transmission of the sidelink reference signal and the first sidelink message.

Some examples of the method, apparatuses, and non-transitory computer-readable medium described herein may further include operations, features, means, or instructions for selecting the precoding matrix based on determining that coherent reception of the sidelink reference signal and the first sidelink message is expected, where the selected precoding matrix may be associated with coherent transmission of the sidelink reference signal and the first sidelink message.

### BRIEF DESCRIPTION OF THE DRAWINGS

FIGS. 1 and 2 illustrate examples of wireless communications systems that support sidelink coherency management in accordance with one or more aspects of the present disclosure.

FIGS. 3A, 3B, 3C, 4A, and 4B illustrate examples of coherency schemes that supports sidelink coherency management in accordance with one or more aspects of the present disclosure.

FIGS. 5 through 7 illustrate examples of process flows that support sidelink coherency management in accordance with one or more aspects of the present disclosure.

FIGS. 8 and 9 show block diagrams of devices that support sidelink coherency management in accordance with one or more aspects of the present disclosure.

FIG. 10 shows a block diagram of a communications manager that supports sidelink coherency management in accordance with one or more aspects of the present disclosure.

FIG. 11 shows a diagram of a system including a device that supports sidelink coherency management in accordance with one or more aspects of the present disclosure.

FIGS. 12 through 19 show flowcharts illustrating methods that support sidelink coherency management in accordance with one or more aspects of the present disclosure.

### DETAILED DESCRIPTION

Some wireless communications systems may support access links (e.g., a Uu link) and sidelinks (e.g., a PC5 link) for communications between communication devices. Access links may refer to communication links through which a communication device (e.g., a UE) accesses a wireless communications system, such as a communication link between a UE and a network entity (e.g., a base station). For example, an access link may support uplink signaling, downlink signaling, connection procedures, etc. Sidelinks may refer to any communication link between similar communication devices (e.g., a communication link between UEs, or a backhaul communication link between network entities). It is noted that while various examples provided herein are discussed for UE sidelink devices, such sidelink techniques may be used for any type of wireless devices that use sidelink communications. For example, a sidelink may support one or more of device-to-device (D2D) communications, vehicle-to-everything (V2X) or vehicle-to-vehicle (V2V) communications, message relaying, discovery signaling, beacon signaling, or other signals transmitted over-the-air from one UE to one or more other UEs.

In some examples, a UE may transmit messages (e.g., over access links, over sidelinks) coherently or non-coherently. Coherency may be defined as a maximum allowable difference between the measured relative power and phase errors of transmissions within a specified time window. For example, the UE may transmit a first message having a first phase error and a first power. If the UE transmits a second message within a specified time window (e.g., 20 milliseconds) that has a second phase error and a second power such that a difference between the phase errors and a difference between the powers satisfy (e.g., are less than, are less than or equal to) associated threshold differences, the UE may transmit the first message and the second message coherently.

In some cases, however, transmitting sidelink messages may introduce additional challenges for maintaining coherency which may cause unexpected loss of coherency between sidelink messages. For example, a UE may be configured to switch between active BWPs to communicate with various devices, such as an active sidelink BWP for communicating with another UE, or a Uu active BWP for communicating with a network entity. Additionally, or alternatively, a UE may be configured to switch between CCs or duplex modes when communicating messages over time. In some cases, radio frequency circuitry of the UE may be tuned such that switching (e.g., tuning the radio frequency circuitry) between active BWPs (e.g., between a sidelink active BWP and a Uu active BWP, between sidelink BWPs on different CCs), switching between CCs, or switching between duplex modes between transmitting a sidelink reference signal and a corresponding sidelink message may cause phase or amplitude discontinuities such that coherency is lost between the sidelink reference signal and the sidelink message. For example, the tuning of the radio frequency circuitry to accommodate the switch in BWP, CC, or duplex mode between the sidelink reference signal and sidelink message transmission may cause coherency to be lost. Loss of coherency (e.g., particularly unexpected loss of coherency) may affect data rates, spectral efficiency, reliability, and performance.

Techniques, systems, and devices are described herein for determining whether coherency is maintained for sidelink communications. For example, a first UE may transmit a sidelink reference signal to a second UE on an active sidelink BWP or on a first CC of a sidelink channel. The sidelink reference signal may correspond to a subsequent transmission of a sidelink message from the first UE to the second UE on the active sidelink BWP or on the first CC. For example, the second UE may perform channel estimation of the sidelink channel using the sidelink reference signal and may transmit a scheduling message to the first UE that schedules the transmission of the sidelink message. In some examples, the first UE or the second UE (or both) may determine whether the first UE switches to a second active BWP (e.g., a second active sidelink BWP, a Uu active BWP) between transmitting the sidelink message and the sidelink reference signal. In some other examples, the first UE or the second UE (or both) may determine whether the first UE switches between duplex modes (e.g., between a full-duplex mode and a half-duplex mode, between different full-duplex modes) between or transmitting the sidelink message and the sidelink reference signal or upon transmitting the sidelink message. In still some other examples, the first UE or the second UE (or both) may determine whether the first UE transmits a second sidelink message to a third UE on a second CC different from the first CC between transmitting the sidelink reference signal and the sidelink message.

Based on the determination (e.g., of the active BWP switch, of the duplex mode switch, of the transmission of the second sidelink message), the first UE or the second UE (or both) may determine whether coherency will be maintained between the sidelink reference signal and the sidelink message. If the first UE does not switch to the second active BWP, switch between duplex modes, or transmit the second sidelink message on the second CC, coherency may be maintained. In some cases, the first UE may transmit an indication of whether coherency will be maintained to the second UE. In some examples, based on whether coherency is maintained, the second UE may select a precoding matrix (e.g., associated with coherent transmission of the sidelink message, associated with non-coherent transmission of the sidelink message) for transmitting the sidelink message and may transmit a precoding matrix indicator (PMI) to the first UE indicating the selected precoding matrix (e.g., in the scheduling message). Based on whether coherency is maintained, the first UE may coherently or non-coherently transmit the sidelink message on the active sidelink BWP or on the first CC.

In some examples, determining whether coherency is maintained between sidelink communications and/or indicating whether coherency is maintained may increase data rates, spectral efficiency, and reliability of sidelink communications. For example, a UE may adjust phase error and power expectations in receiving and decoding sidelink messages based on whether coherency is maintained, which may increase a likelihood that the sidelink messages are successfully received and decoded, thereby reducing sidelink message failure. Such reduction in sidelink message failure may increase data rates, spectral efficiency, and reliability, for example, due to reducing sidelink message retransmissions that result from the sidelink message failures. In some other examples, determining whether coherency is maintained between sidelink communications and/or indicating whether coherency is maintained may reduce latency and power consumption and increase resource usage utilization, coordination between devices, battery life, and processing capability, among other benefits, for example, by increasing the likelihood of sidelink message reception success due to increased coordination and reducing delay, power consumption, resource usage utilization, and processing that is associated with sidelink message retransmission.

Aspects of the disclosure are initially described in the context of wireless communications systems. Aspects of the disclosure are additionally described in the context of coherency schemes and process flows. Aspects of the disclosure are further illustrated by and described with reference to apparatus diagrams, system diagrams, and flowcharts that relate to sidelink coherency management.

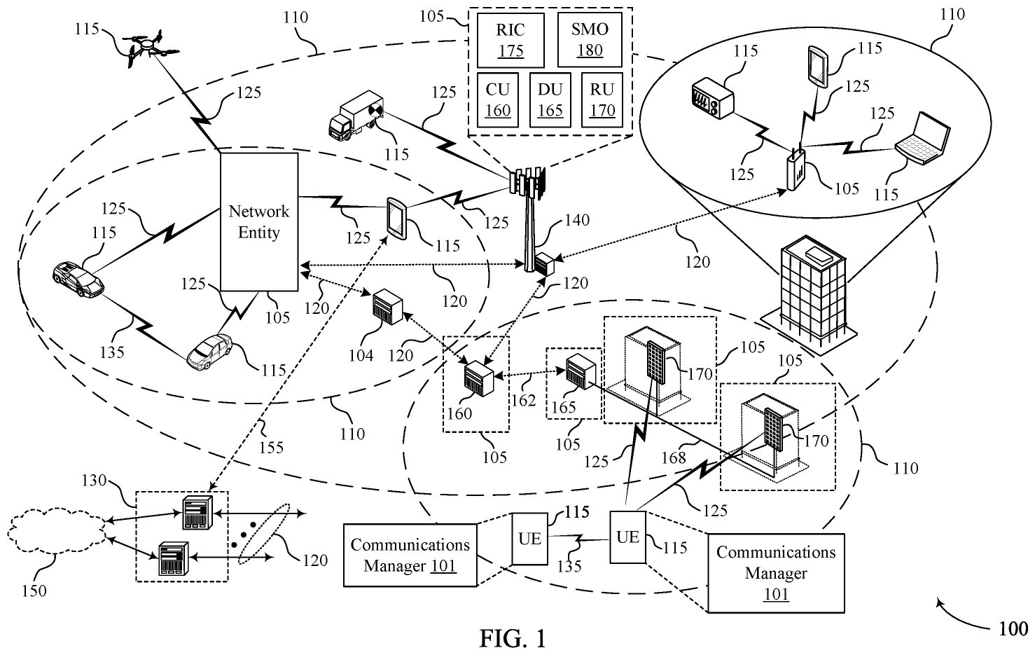

FIG. 1 illustrates an example of a wireless communications system 100 that supports sidelink coherency management in accordance with aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The network entities 105 may be dispersed throughout a geographic area to form the wireless communications system 100 and may be devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

Consistent with this disclosure, once a specific example is broadened in accordance with this disclosure (e.g., a UE 115 is configured to receive information from a network entity 105 also discloses that a first network node is configured to receive information from a second network node), the broader example of the narrower example may be interpreted in the reverse, but in a broad open-ended way. In the example above where a UE 115 being configured to receive information from a network entity 105 also discloses that a first network node being configured to receive information from a second network node, the first network node may refer to a first UE 115, a first network entity 105, a first apparatus, a first device, a first computing system, a first one or more components, a first processing entity, or the like configured to receive the information; and the second network node may refer to a second UE 115, a second network entity 105, a second apparatus, a second device, a second computing system, a first one or more components, a first processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, the network entities 105 may communicate with the core network 130, or with one another, or both. For example, the network entities 105 may interface with the core network 130 through one or more backhaul links 120 (e.g., via an S1, N2, N3, or other interface). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (MC) 175 (e.g., a Near-Real Time RIC (Near-RT MC), a Non-Real Time MC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support sidelink coherency management as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink CCs and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a network entity 105, or downlink transmissions from a network entity 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T, =1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving geographic coverage area 110. In some examples, different geographic coverage areas 110 associated with different technologies may overlap, but the different geographic coverage areas 110 may be supported by the same network entity 105. In other examples, the overlapping geographic coverage areas 110 associated with different technologies may be supported by different network entities 105. The wireless communications system 100 may include, for example, a heterogeneous network in which different types of the network entities 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a D2D communication link 135 (e.g., using a peer-to-peer (P2P) or D2D protocol). One or more UEs 115 utilizing D2D communications may be within the geographic coverage area 110 of a network entity 105 (e.g., a base station 140, an RU 170), which may support aspects of such D2D communications being configured by or scheduled by the network entity 105. Other UEs 115 in such a group may be outside the geographic coverage area 110 of a network entity 105 or be otherwise unable to receive transmissions from a network entity 105. In some examples, groups of the UEs 115 communicating via D2D communications may utilize a one-to-many (1:M) system in which each UE 115 transmits to every other UE 115 in the group. In some examples, a network entity 105 facilitates the scheduling of resources for D2D communications. In other cases, D2D communications are carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with CCs operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a number of rows and columns of antenna ports that the network entity 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, transmissions by a device (e.g., by a network entity 105 or a UE 115) may be performed using multiple beam directions, and the device may use a combination of digital precoding or radio frequency beamforming to generate a combined beam for transmission (e.g., from a network entity 105 to a UE 115). The UE 115 may report feedback that indicates precoding weights for one or more beam directions, and the feedback may correspond to a configured number of beams across a system bandwidth or one or more sub-bands. The network entity 105 may transmit a reference signal (e.g., a cell-specific reference signal (CRS), a channel state information (CSI) reference signal (CSI-RS)), which may be precoded or unprecoded. The UE 115 may provide feedback for beam selection, which may be a PMI or codebook-based feedback (e.g., a multi-panel type codebook, a linear combination type codebook, a port selection type codebook). Although these techniques are described with reference to signals transmitted in one or more directions by a network entity 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

The UEs 115 and the network entities 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at a medium access control (MAC) layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a UE 115 may be an example of a limited transmission capability UE. In some cases, a limited transmission capability UE may be a UE 115 that includes a single radio frequency chain (e.g., an antenna array and associated radio frequency circuitry, such as analog to digital converters, digital to analog converters, mixers, or downconverters, among other radio frequency circuitry). Here, if the UE 115 is configured to communicate on multiple CCs, the UE 115 may adjust parameters of the radio frequency chain to transmit on each CC. For example, if the UE 115 is configured with a first CC and a second CC, the UE 115 may transmit messages on the first CC according to a first set of parameters and may adjust the parameters of the radio frequency chain to transmit messages on the second CC according to a second set of parameters. Examples of parameters may include beam weights, a frequency of the CC, filter parameters, mixer parameters, converter parameters, or other parameters related to the radio frequency chain.

The wireless communications system 100 may support access links (e.g., a Uu link, a communication link 125) and sidelinks (e.g., a PC5 link, a D2D communications link 135). To support sidelink communications (e.g., sidelink data, sidelink reference signals, sidelink control information (SCI), or other sidelink information), a UE 115 may be configured to communicate on one or more sidelink BWPs. In some examples, the UE 115 may be restricted to communicate on one or more active sidelink BWPs, for example, to reduce power consumption at the UE 115. A bandwidth over which the UE 115 communicate may be dynamically configured based on current traffic conditions by activating/deactivating sidelink BWPs. For example, to transmit a relatively large amount of sidelink data, one or more sidelink BWPs having a relatively large bandwidth may be activated. Alternatively, to transmit a relatively small amount of sidelink data, one or more sidelink BWPs having a relatively small bandwidth may be activated (e.g., and one or more other sidelink BWPs may be deactivated).

In some examples, the active sidelink BWPs on which a UE 115 communicates may be configured according to a SL-FreqConfig configuration (e.g., received from a network entity 105, determined at the UE 115, received from a different UE 115). The SL-FreqConfig configuration may include a SL-BWP-config that configures the bandwidth, frequency, subcarrier spacing, cyclic prefix, time resources, or a combination thereof, of the active sidelink BWPs. Additionally, the SL-BWP-config may configure one or more sidelink resource pools (e.g., sets of sidelink resources) for a sidelink BWP that are available to the UE 115 to select and reserve sidelink resources and schedule and communicate sidelink messages. The one or more sidelink resource pools may include transmit sidelink resource pools (e.g., sets of sidelink resources over which the UE 115 may transmit sidelink messages) and receive sidelink resource pools (e.g., sets of sidelink resources over which the UE 115 may receive sidelink messages). In some examples, the transmit sidelink resource pools may be configured for mode 1 communications in which a network entity 105 coordinates the transmission of sidelink messages between UEs 115, or may be configured for mode 2 communications in which UEs 115 may monitor a sidelink channel for available sidelink resources and reserve sidelink resources by transmitting reservation messages (e.g., SCI-1 messages, SCI-2 messages, request-to-send-messages, or other sidelink control messages). In some examples, a sidelink resource pool configuration may include a physical sidelink shared channel (PSSCH) configuration, a physical sidelink control channel (PSCCH) configuration, physical sidelink feedback channel (PSFCH) configuration, a number of subchannels in the sidelink resource pool, a subchannel size, a starting resource block of the sidelink resource pool, a modulation and coding scheme (MCS) associated with the sidelink resource pool, a sensing configuration, a power control configuration, a constant bit rate (CBR), or a combination thereof.

A UE 115 may transmit messages (e.g., over access links, over sidelinks) coherently or non-coherently, where coherency may be defined as a maximum allowable difference between the measured relative power and phase errors of transmissions within a specified time window. Some conditions for transmitting messages coherently within a specified time window may include that the UE 115 is not signaled with a change in a number of sounding reference signal (SRS) ports in an SRS configuration message (e.g., an SRS-config), the UE 115 does not enter a discontinuous reception (DRX) off period, a measurement gap does not occur, antenna switching for SRS transmission does not occur, an active BWP remains the same, a carrier aggregation configuration is unchanged, an Evolved Universal Terrestrial Radio Access Network (E-UTRAN) New Radio-Dual Connectivity (EN-DC) configuration is unchanged, or a combination thereof. In some cases, transmitting sidelink messages may introduce additional challenges for maintaining coherency which may cause unexpected loss of coherency between sidelink messages. Loss of coherency may reduce data rates, spectral efficiency, reliability, and performance, for example, due to retransmissions resulting from transmissions failures caused by the loss of coherency.

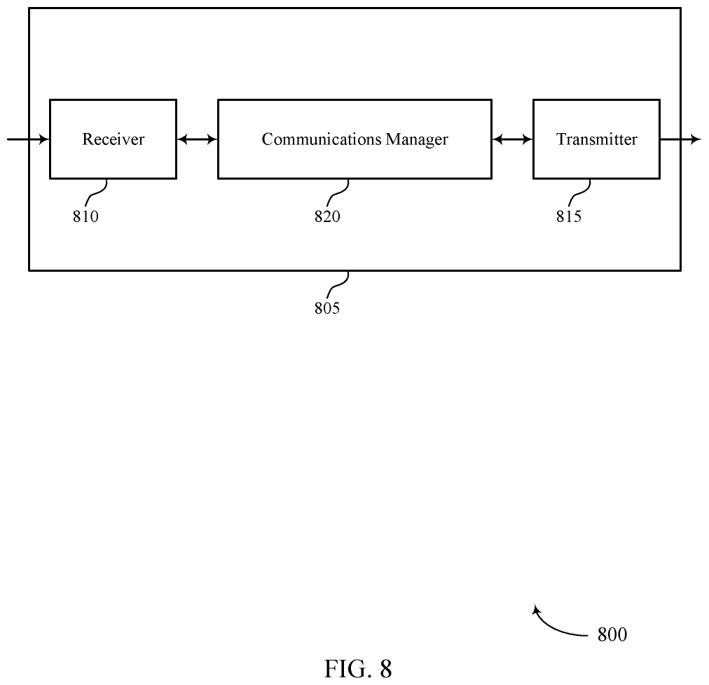

The wireless communications system 100 may be configured to support determining whether coherency is maintained for sidelink communications. For example, UEs 115 may include a communications manager 101 that may support coherency determination for sidelink communications. The communications manager 101 may be an example of aspects of a communications manager as described in FIGS. 8 through 11.

By way of example, a first UE 115 (e.g., using a communications manager 101) may transmit a sidelink reference signal to a second UE 115 on an active sidelink BWP or on a first CC of a sidelink channel. The sidelink reference signal may be associated with a subsequent transmission of a sidelink message on the active sidelink BWP or on the first CC. In some examples, the first UE 115 or the second UE 115 (or both) (e.g., using respective communications managers 101) may determine whether the first UE 115 switches to a second active BWP (e.g., a second active sidelink BWP, a Uu active BWP) prior to transmitting the sidelink message and after transmitting the sidelink reference signal. In some other examples, the first UE 115 or the second UE 115 (or both) may determine whether the first UE 115 switches between duplex modes (e.g., between a full-duplex mode and a half-duplex mode, between different full-duplex modes) prior to or concurrent with transmitting the sidelink message and after transmitting the sidelink reference signal. In still some other examples, the first UE 115 or the second UE 115 (or both) may determine whether the first UE 115 transmits a second sidelink message to a third UE 115 on a second CC different from the first CC between transmitting the sidelink reference signal and the sidelink message.

Based on the determination (e.g., of the active BWP switch, of the duplex mode switch, of the transmission of the second sidelink message), the first UE 115 or the second UE 115 (or both) may determine whether coherency will be maintained between the sidelink reference signal and the sidelink message. Based on determining whether coherency is maintained between the sidelink reference signal and the sidelink message, the first UE 115 may transmit the sidelink message on the active sidelink BWP or on the first CC according to a set of coherency transmission characteristics (e.g., such that the sidelink message is transmitted coherently, such that the sidelink message is transmitted non-coherently).

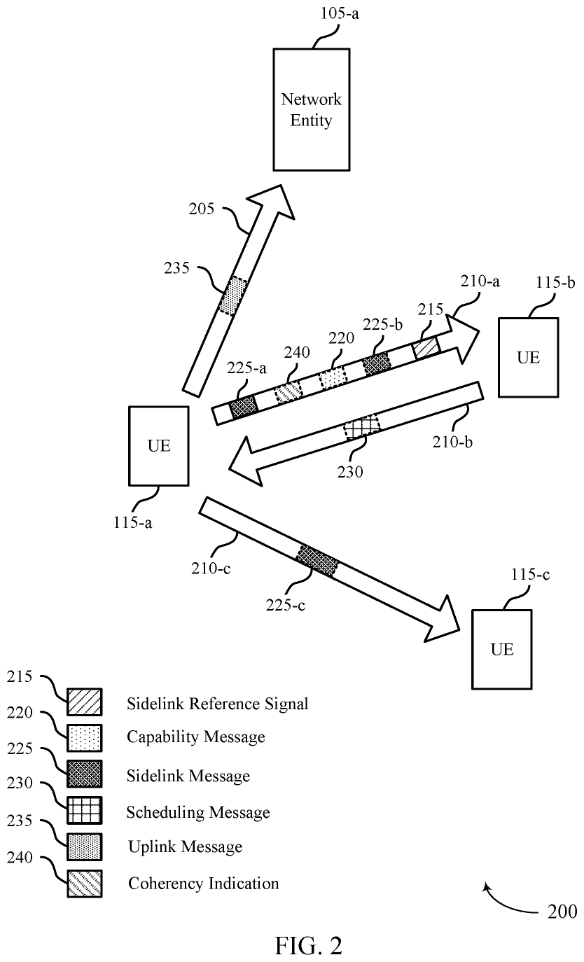

FIG. 2 illustrates an example of a wireless communications system 200 that supports sidelink coherency management in accordance with aspects of the present disclosure. The wireless communications system 200 may implement aspects of the wireless communications system 100 or may be implemented by aspects of the wireless communications system 100. For example, the wireless communications system 200 may include a network entity 105-a, a UE 115-a, a UE 115-b, and a UE 115-c which may be examples of the corresponding devices described with reference to FIG. 1. In some examples, the wireless communications system 200 may support multiple radio access technologies including 4G systems such as LTE systems, LTE-A systems, or LTE-A Pro systems, and 5G systems which may be referred to as NR systems. The wireless communications system 200 may support coherency management of sidelink communications to support improvements to data rates, spectral efficiency, reliability, latency, coordination between devices, power consumption, resource usage, battery life, and processing capability among other benefits.

The wireless communications system 200 may support communications between the network entity 105-a and the UE 115-a and may support sidelink communications between the UE 115-a, the UE 115-b, and the UE 115-c. For example, the UE 115-a may transmit uplink messages to the network entity 105-a on a communication link 205 (e.g., which may be an example of a communication link 125) and may receive downlink messages on the communication link 205. Additionally, the UE 115-a may communicate sidelink messages with the UE 115-b and the UE 115-c on communication links 210-a and 210-b (e.g., which may be examples of D2D communication links 135), respectively.

The UEs 115 may determine whether sidelink messages transmitted on the communication links 210 are transmitted coherently. For example, the UE 115-a may transmit a sidelink reference signal 215 to the UE 115-b on an active sidelink BWP. The sidelink reference signal 215 may be associated with a subsequent transmission of a sidelink message 225-a to the UE 115-b on the active sidelink BWP. For example, based on the sidelink reference signal 215, the UE 115-b may transmit a scheduling message 230 that schedules (e.g., allocates resources of a sidelink resource pool for) or indicates parameters associated with transmitting the sidelink message 225-a on the active sidelink BWP. For instance, the scheduling message 230 may indicate a precoding matrix, a spatial transmission beam, an antenna group, or a combination thereof, that the UE 115-a is to use to transmit the sidelink message 225-a. In some examples, a sidelink message 225 may include SCI, sidelink data, sidelink feedback, or a combination thereof.

To determine whether the UE 115-a may transmit the sidelink message 225-a coherently with the sidelink reference signal 215, the UE 115-a or the UE 115-b (or both) may determine whether one or more conditions are satisfied. In a first example, the UE 115-a or the UE 115-b (or both) may determine whether the UE 115-a switches to a second active BWP (e.g., a second active sidelink BWP, an active Uu BWP) prior to transmitting the sidelink message 225-a and after transmitting the sidelink reference signal 215). For example, in some cases, between transmitting the sidelink reference signal 215 and the sidelink message 225-a, the UE 115-a may optionally switch to an active Uu BWP to transmit an uplink message 235. In some other cases, between transmitting the sidelink reference signal 215 and the sidelink message 225-a, the UE 115-a may optionally switch to a second active sidelink BWP to transmit a sidelink message 225-b to the UE 115-b or a sidelink message 225-c to the UE 115-c. In some examples, if the UE 115-a switches to the second active BWP prior to transmitting the sidelink message 225-a and after transmitting the sidelink reference signal 215, the UE 115-a may lose coherency. Accordingly, if the UE 115-a or the UE 115-b (or both) determine that the UE 115-a switches to the second active BWP prior to transmitting the sidelink message 225-a and after transmitting the sidelink reference signal 215, the UE 115-a or the UE 115-b (or both) may determine that the UE 115-a loses coherency. Alternatively, if the UE 115-a or the UE 115-b (or both) determine that the UE 115-a does not switch to the second active BWP, the UE 115-a or the UE 115-b (or both) may determine that the UE 115-a maintains coherency.

In some examples, if the UE 115-a switches to the second active sidelink BWP prior to transmitting the sidelink message 225-a and after transmitting the sidelink reference signal 215, the UE 115-a may not lose coherency. For example, in some cases, the UE 115-a may have the capability to coherently transmit a first uplink message and a second uplink message on a same active Uu BWP even if switching to a different active Uu BWP between transmitting the first uplink message and the second uplink message. Here, the UE 115-a may optionally transmit a capability message 220 to the UE 115-b that indicates whether the UE 115-a may coherently transmit uplink messages when switching active Uu BWPs. If the UE 115-a may coherently transmit the uplink messages when switching active Uu BWPs, the UE 115-a may coherently transmit the sidelink reference signal 215 and the sidelink message 225-a when switching active sidelink BWPs. Accordingly, if the UE 115-a transmits the capability message 220 indicating that the UE 115-a may coherently transmit uplink messages when switching active Uu BWPs, the UE 115-a or the UE 115-b (or both) may determine that the UE 115-a maintains coherency even if the UE 115-a switches to the second active sidelink BWP prior to transmitting the sidelink message 225-a after transmitting the sidelink reference signal 215. In some examples, the capability of the UE 115-a to coherently transmit uplink messages when switching active Uu BWPs may be associated with a particular frequency band or a combination of two or more frequency bands.

In a second example, the UE 115-a or the UE 115-b (or both) may determine whether the UE 115-a switches between a first duplex mode and a second duplex mode prior to or concurrent with transmitting the sidelink message 225-a and after transmitting the sidelink reference signal 215). In some examples, the first duplex mode may be a first full-duplex mode or a half-duplex mode. In some examples, the second duplex mode may be a second full-duplex mode or the half-duplex mode. In some examples, the first full-duplex mode may be associated with a first uplink bandwidth, a first downlink bandwidth, or a combination thereof, and the second full-duplex mode may be associated with a second uplink bandwidth different from the first uplink bandwidth, a second downlink bandwidth different from the second downlink bandwidth, or a combination thereof.

The UE 115-a may operate according to the first duplex mode or the second duplex mode to transmit the sidelink reference signal 215. In some examples, between transmitting the sidelink reference signal 215 and the sidelink message 225-a, or to transmit the sidelink message 225-a, the UE 115-a may switch between the first duplex mode to the second duplex mode such that the UE 115-a loses coherency. For example, the UE 115-a may switch from the first full-duplex mode to the half-duplex mode, from the first full-duplex mode to the second full-duplex mode, from the second full-duplex mode to the first full-duplex mode, from the second full-duplex mode to the half-duplex mode, from the half-duplex mode to the first full-duplex mode, or from the half-duplex mode to the second full-duplex mode. Here, the UE 115-a or the UE 115-b (or both) may determine that the UE 115-a loses coherency. Alternatively, if the UE 115-a does not switch between the first duplex mode and the second duplex mode prior to or concurrent with transmitting the sidelink message 225-a, the UE 115-a or the UE 115-b (or both) may determine that the UE 115-a maintains coherency.

In a third example, the UE 115-a or the UE 115-b (or both) may determine whether the UE 115-a transmits the sidelink message 225-c to the UE 115-b prior to transmitting the sidelink message 225-a and on a different CC than a CC on which the sidelink reference signal 215 was transmitted. For example, the UE 115-a may be an example of a limited transmission capability UE that includes a single radio frequency chain. Here, the UE 115-a may transmit the sidelink reference signal 215 to the UE 115-b on a first CC according to a first set of parameters. In some cases, between transmitting the sidelink reference signal 215 and the sidelink message 225-a (e.g., on the first CC) the UE 115-a may transmit the sidelink message 225-c to the UE 115-c on a second CC different from the first CC. However, because the UE 115-a is a limited transmission capability UE, the UE 115-a may tune the radio frequency chain (e.g., adjust the parameters of the radio frequency chain) to transmit the sidelink message 225-c according to a second set of parameters. Here, the UE 115-a may retune the radio frequency chain back to the first set of parameters to transmit the sidelink message 225-a, which may cause the UE 115-a to lose coherency. Accordingly, if the UE 115-a or the UE 115-b (or both) determine that the UE 115-a transmits the sidelink message 225-c on the second CC between transmitting the sidelink reference signal 215 and the sidelink message 225-a, the UE 115-a or the UE 115-b (or both) may determine that the UE 115-a loses coherency. Alternatively, if UE 115-a or the UE 115-b (or both) determine that the UE 115-a does not the sidelink message 225-c, the UE 115-a or the UE 115-b (or both) may determine that the UE 115-a maintains coherency.

In any example, based on determining whether the UE 115-a maintains coherency, the UE 115-a may optionally transmit a coherency indication 240 to the UE 115-b. The coherency indication 240 may indicate to the UE 115-b whether the UE 115-a will coherently transmit the sidelink message 225-a with respect to the sidelink reference signal 215. In some examples, if the UE 115-a does not transmit the coherency indication 240, the UE 115-b may assume that the UE 115-a maintains coherency (e.g., if the UE 115-b does not determine whether the UE 115-a maintains coherency). In some examples, the UE 115-b may determine whether the UE 115-a maintains coherency based on the coherency indication 240.

Additionally, in any example, the UE 115-a may transmit the sidelink message 225-a based on the determination of whether the UE 115-a maintains coherency. For example, the UE 115-b may transmit the scheduling message 230 based on the determination of whether the UE 115-a maintains coherency. For example, the UE 115-b may select a precoding matrix, a spatial transmission beam, an antenna group, or a combination thereof, for the UE 115-b to use to transmit the sidelink message 225-a based on whether the UE 115-a maintains coherency, and the scheduling message 230 may indicate the selected precoding matrix (e.g., via a PMI), spatial transmission beam, antenna group, or combination thereof. If the UE 115-a maintains coherency, the UE 115-b may select a precoding matrix associated with coherent transmission of the sidelink message 225-a with respect to the sidelink reference signal 215. Alternatively, if the UE 115-a loses coherency, the UE 115-b may select a precoding matrix associated with non-coherent transmission of the sidelink message 225-a with respect to the sidelink reference signal 215.

In response to receiving the scheduling message 230, the UE 115-a may coherently or non-coherently transmit the sidelink message 225-a according to a set of coherency transmission characteristics. That is, to transmit the sidelink message 225-a coherently (e.g., based on determining that the UE 115-a maintains coherency), the UE 115-a may transmit sidelink message 225-a such that a relative difference between first communication characteristics associated with transmitting the sidelink reference signal and second communication characteristics associated with transmitting the sidelink message satisfies a threshold difference. For example, the UE 115-a may transmit the sidelink message 225-a: within a specified time window (e.g., within 20 milliseconds of transmitting the sidelink reference signal 215, or within some other time), such that a difference between a first phase error associated with transmitting the sidelink reference signal and a second phase error associated with transmitting the sidelink message 225-a satisfies (e.g., is less than, is less than or equal to) a threshold phase error difference, and such that a difference between a first transmission power (e.g., a first power error) associated with transmitting the sidelink reference signal 215 and a second transmission power (e.g., a second power error) associated with transmitting the sidelink message 225-a satisfies (e.g., is less than, is less than or equal to) a threshold power difference. Alternatively, to transmit the sidelink message 225-a non-coherently (e.g., based on determining that the UE 115-a loses coherency), the UE 115-a may transmit the sidelink message 225-a such that the relative difference fails to satisfy the threshold difference. For example, the UE 115-a may transmit the sidelink message 225-a: within or outside the specified time window, such that the difference between the first phase error and the second phase error fails to satisfy (e.g., is greater than, is greater than or equal to) the threshold phase error difference, and such that the difference between the first transmission power and the second transmission power fails to satisfy (e.g., is greater than, is greater than or equal to) the threshold power difference.

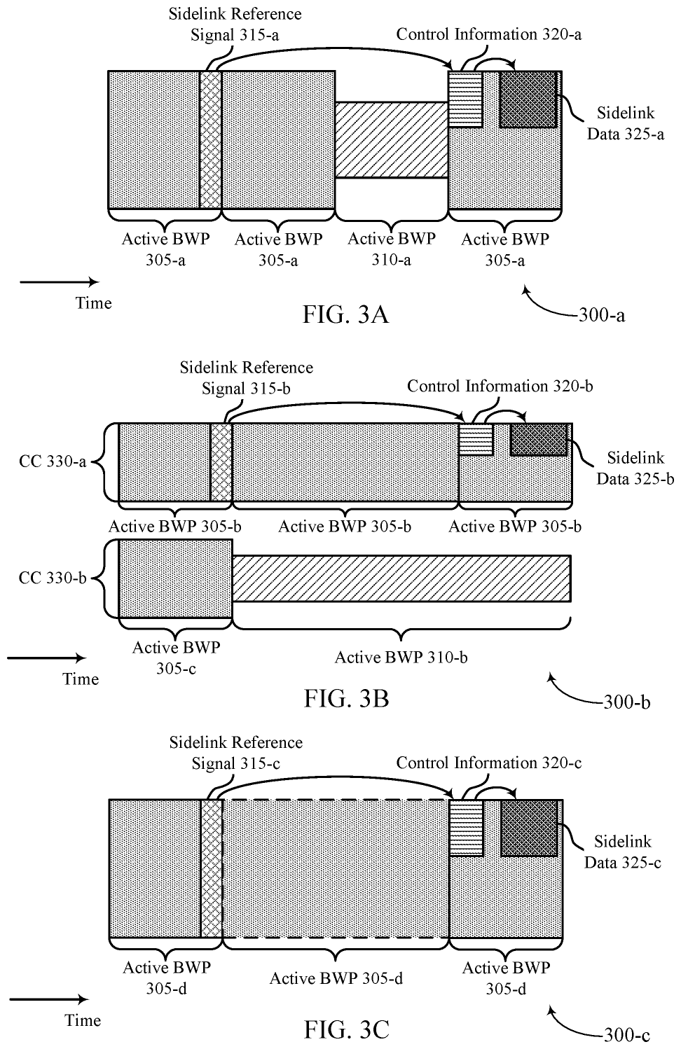

FIG. 3A illustrates an example of a coherency scheme 300-a that supports sidelink coherency management in accordance with aspects of the present disclosure. The coherency scheme 300-a may implement aspects of the wireless communications systems 100 and 200 or may be implemented by aspects of the wireless communications system 100 and 200 as described with reference to FIGS. 1 and 2, respectively. For example, the coherency scheme 300-a may be implemented by a UE 115 to determine whether coherency is maintained for sidelink communications.

In the example of FIG. 3A, the UE 115 may communicate messages on an active sidelink BWP 305-a. For example, the UE 115 may transmit a sidelink reference signal 315-a to a second UE 115 on the active sidelink BWP 305-a, the sidelink reference signal 315-a associated with a subsequent transmission of (e.g., at a later time) a sidelink message on the active sidelink BWP 305-a. The sidelink message may include control information 320-a, or sidelink data 325-a, or both. The control information 320-a may reserve sidelink resources of a sidelink resource pool associated with the active sidelink BWP 305-a for transmission of the sidelink data 325-a. Between transmitting the sidelink reference signal 315-a and the sidelink message, the UE 115 may communicate on one or more other BWPs. For example, the UE 115 may continue to communicate on the active sidelink BWP 305-a for a time. At some time prior to transmitting the sidelink message, the UE 115 may switch to communicating on an active BWP 310-a and then may switch back to the active sidelink BWP 305-a to transmit the sidelink message. In some examples, the active BWP 310-a may be a second active sidelink BWP different from the active sidelink BWP 305-a. In some other examples, the active BWP 310-a may be an active Uu BWP.

Based on the UE 115 switching to the active BWP 310-a, the UE 115 or the second UE 115 (or both) may determine whether the UE 115 may coherently transmit the sidelink message with respect to the sidelink reference signal 315-a. For example, if the active BWP 310-a is an active Uu BWP, the UE 115 or the second UE 115 (or both) may determine that the UE 115 may transmit the sidelink message non-coherently. Alternatively, if the active BWP 310-a is a second active sidelink BWP, the UE 115 or the second UE 115 (or both) may determine whether the UE 115 may coherently transmit the sidelink message based on a capability of the UE 115. For example, if the UE 115 may coherently transmit uplink messages when switching active Uu BWPs, the UE 115 or the second UE 115 (or both) may determine that the UE 115 may coherently transmit the sidelink message even if switching to the second active sidelink BWP.

Accordingly, based on the determination, the UE 115 may coherently or non-coherently transmit the sidelink message (e.g., the control information 320-a, the sidelink data 325-a, or both) on the active sidelink BWP 305-a.

FIG. 3B illustrates an example of a coherency scheme 300-b that supports sidelink coherency management in accordance with aspects of the present disclosure. The coherency scheme 300-b may implement aspects of the wireless communications systems 100 and 200 or may be implemented by aspects of the wireless communications system 100 and 200 as described with reference to FIGS. 1 and 2, respectively. For example, the coherency scheme 300-b may be implemented by a UE 115 to determine whether coherency is maintained for sidelink communications.

In the example of FIG. 3B, the UE 115 may be configured to communicate on multiple CCs. For example, the UE 115 may communicate on a CC 330-a and on a CC 330-b, where the CC 330-a and the CC 330-b are switched together. That is, the UE 115 may communicate on the CC 330-a and the CC 330-b using a same radio frequency chain.

The UE 115 may transmit a sidelink reference signal 315-b to a second UE 115 on an active sidelink BWP 305-b associated with (e.g., within) the CC 330-a, the sidelink reference signal 315-a associated with a subsequent transmission of (e.g., at a later time) a sidelink message on the active sidelink BWP 305-b. The sidelink message may include control information 320-b, or sidelink data 325-b, or both. The control information 320-b may reserve sidelink resources of a sidelink resource pool associated with the active sidelink BWP 305-b for transmission of the sidelink data 325-b. Between transmitting the sidelink reference signal 315-b and the sidelink message, the UE 115 may switch from communicating on an active sidelink BWP 305-c associated with the CC 330-b to communicating on an active BWP 310-b associated with the CC 330-b. In some examples, the active BWP 310-b may be an active sidelink BWP different from the active sidelink BWP 305-c. In some other examples, the active BWP 310-a may be an active Uu BWP. Here, the UE 115 may not switch from communicating on the active sidelink BWP 305-b prior to transmitting the sidelink message.

Based on the UE 115 switching to the active BWP 310-b, the UE 115 or the second UE 115 (or both) may determine whether the UE 115 may coherently transmit the sidelink message with respect to the sidelink reference signal 315-b. For example, even though the UE 115 does not switch from communicating on the active sidelink BWP 305-b prior to transmitting the sidelink message, if the active BWP 310-a is an active Uu BWP, the UE 115 or the second UE 115 (or both) may determine that the UE 115 may transmit the sidelink message non-coherently. Alternatively, if the active BWP 310-b is an active sidelink BWP, the UE 115 or the second UE 115 (or both) may determine whether the UE 115 may coherently transmit the sidelink message based on a capability of the UE 115. For example, if the UE 115 may coherently transmit uplink messages when switching active Uu BWPs, the UE 115 or the second UE 115 (or both) may determine that the UE 115 may coherently transmit the sidelink message even if switching to the active BWP 310-b.

Accordingly, based on the determination, the UE 115 may coherently or non-coherently transmit the sidelink message (e.g., the control information 320-b, the sidelink data 325-b, or both) on the active sidelink BWP 305-b.

FIG. 3C illustrates an example of a coherency scheme 300-c that supports sidelink coherency management in accordance with aspects of the present disclosure. The coherency scheme 300-c may implement aspects of the wireless communications systems 100 and 200 or may be implemented by aspects of the wireless communications system 100 and 200 as described with reference to FIGS. 1 and 2, respectively. For example, the coherency scheme 300-c may be implemented by a UE 115 to determine whether coherency is maintained for sidelink communications.

In the example of FIG. 3C, the coherency scheme 300-c, the UE 115 may communicate messages on an active sidelink BWP 305-d. For example, the UE 115 may transmit a sidelink reference signal 315-c to a second UE 115 on the active sidelink BWP 305-d, the sidelink reference signal 315-c associated with a subsequent transmission of (e.g., at a later time) a sidelink message on the active sidelink BWP 305-d. The sidelink message may include control information 320-c, or sidelink data 325-c, or both. The control information 320-c may reserve sidelink resources of a sidelink resource pool associated with the active sidelink BWP 305-d for transmission of the sidelink data 325-c. Between transmitting the sidelink reference signal 315-c and the sidelink message, the UE 115 may not switch from communicating on the active sidelink BWP 305-d. Alternatively, the UE 115 may not be scheduled to communicate between transmitting the sidelink reference signal 315-c and the sidelink message. In either case, the UE 115 or the second UE 115 (or both) may determine that the UE 115 may coherently transmit the sidelink message with respect to the sidelink reference signal 315-c, for example, based on determining that the UE 115 does not switch from the active sidelink BWP 305-d or is not scheduled to communicate between transmitting the sidelink reference signal 315-c and the sidelink message.

Accordingly, based on the determination, the UE 115 may coherently transmit the sidelink message (e.g., the control information 320-c, the sidelink data 325-c, or both) on the active sidelink BWP 305-d.

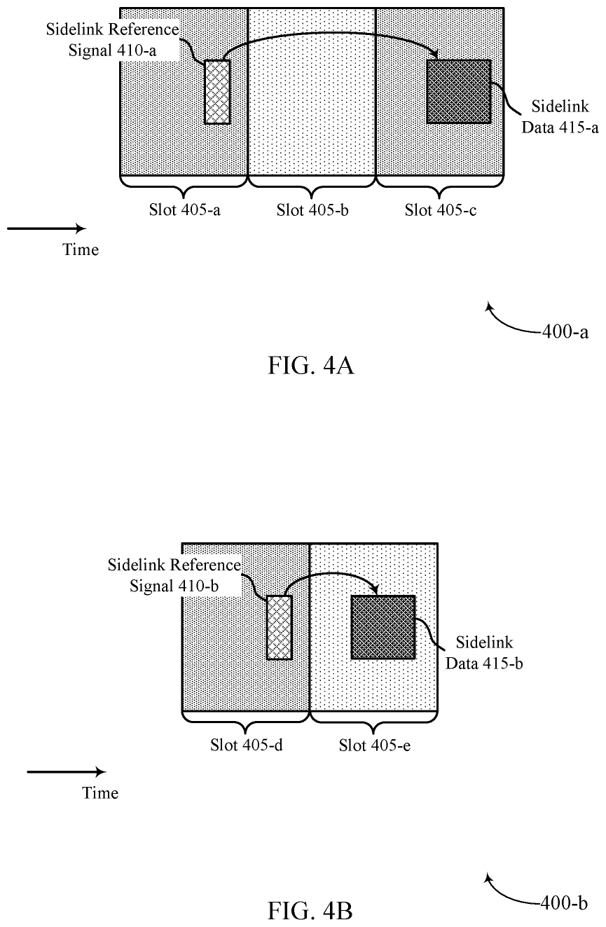

FIG. 4A illustrates an example of a coherency scheme 400-a that supports sidelink coherency management in accordance with aspects of the present disclosure. The coherency scheme 400-a may implement aspects of the wireless communications systems 100 and 200 or may be implemented by aspects of the wireless communications system 100 and 200 as described with reference to FIGS. 1 and 2, respectively. For example, the coherency scheme 400-a may be implemented by a UE 115 to determine whether coherency is maintained for sidelink communications.

In the example of FIG. 4A, the UE 115 may communicate over a number of slots 405 in a time domain. In some examples, the UE 115 may communicate on a same active BWP over the slots 405. In a slot 405-a, the UE 115 may transmit a sidelink reference signal 410-a to a second UE 115 on the active BWP and according to a first operating mode (e.g., a first full-duplex mode, a second full-duplex mode, a half-duplex mode), the sidelink reference signal 410-a associated with a subsequent transmission of (e.g., at a later time) a sidelink message (e.g., sidelink data 415-a, SCI (not shown), or both) on the active sidelink BWP. Between transmitting the sidelink reference signal 410-a and the sidelink message, the UE 115 may switch to communicating according to a second operating mode (e.g., the first full-duplex mode, the second full-duplex mode, the half-duplex mode). For example, in slot 405-b, the UE 115 may switch to communicating according to a second operating mode, and, in slot 405-c, may switch to communicating according to the first operating mode to transmit the sidelink message.

If the second operating mode is different from the first operating mode (e.g., the first operating mode is the half-duplex mode and the second operating mode is one of the full-duplex modes, or vice versa, the first operating mode is the first full-duplex mode and the second operating mode is the second full-duplex mode, or vice versa), the UE 115 or the second UE 115 (or both) may determine that the UE 115 may non-coherently transmit the sidelink message with respect to the sidelink reference signal 410-a. Alternatively, if the second operating mode is the same as the first operating mode (i.e., the UE 115 does not switch operating modes), the UE 115 or the second UE 115 (or both) may determine that the UE 115 may coherently transmit the sidelink message with respect to the sidelink reference signal 410-a. Accordingly, based on the determination, the UE 115 may coherently or non-coherently transmit the sidelink message on the active BWP.

FIG. 4B illustrates an example of a coherency scheme 400-b that supports sidelink coherency management in accordance with aspects of the present disclosure. The coherency scheme 400-b may implement aspects of the wireless communications systems 100 and 200 or may be implemented by aspects of the wireless communications system 100 and 200 as described with reference to FIGS. 1 and 2, respectively. For example, the coherency scheme 400-b may be implemented by a UE 115 to determine whether coherency is maintained for sidelink communications.

In the example of FIG. 4B, the UE 115 may communicate over a number of slots 405 in a time domain. In some examples, the UE 115 may communicate on a same active BWP over the slots 405. In a slot 405-d, the UE 115 may transmit a sidelink reference signal 410-b to a second UE 115 on the active BWP and according to a first operating mode (e.g., a first full-duplex mode, a second full-duplex mode, a half-duplex mode), the sidelink reference signal 410-b associated with a subsequent transmission of (e.g., at a later time) a sidelink message (e.g., sidelink data 415-b, SCI (not shown), or both) on the active sidelink BWP. To transmit the sidelink message (e.g., concurrent with transmitting the sidelink message), the UE 115 may switch to communicating according to a second operating mode (e.g., the first full-duplex mode, the second full-duplex mode, the half-duplex mode). For example, in slot 405-e, the UE 115 may switch to communicating according to a second operating mode.

If the second operating mode is different from the first operating mode (e.g., the first operating mode is the half-duplex mode and the second operating mode is one of the full-duplex modes, or vice versa, the first operating mode is the first full-duplex mode and the second operating mode is the second full-duplex mode, or vice versa), the UE 115 or the second UE 115 (or both) may determine that the UE 115 may non-coherently transmit the sidelink message with respect to the sidelink reference signal 410-b. Alternatively, if the second operating mode is the same as the first operating mode (i.e., the UE 115 does not switch operating modes), the UE 115 or the second UE 115 (or both) may determine that the UE 115 may coherently transmit the sidelink message with respect to the sidelink reference signal 410-b. Accordingly, based on the determination, the UE 115 may coherently or non-coherently transmit the sidelink message on the active BWP.

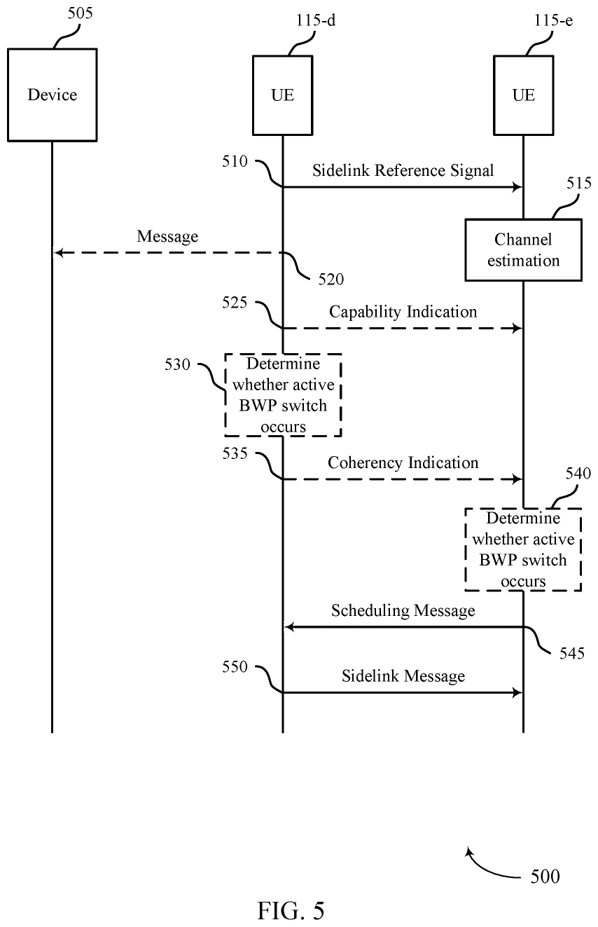

FIG. 5 illustrates an example of a process flow 500 that supports sidelink coherency management in accordance with aspects of the present disclosure. The process flow 500 may implement aspects of the wireless communications systems 100 and 200 or may be implemented by aspects of the wireless communications system 100 and 200 as described with reference to FIGS. 1 and 2, respectively. For example, the process flow 500 may be implemented by a device 505, a UE 115-d, and a UE 115-e to support coherency management for sidelink communications to increase data rates, spectral efficiency, and reliability. The process flow 500 may further be implemented by the device 505, the UE 115-d, and the UE 115-e to provide improvements to coordination between devices, power consumption, resource usage, battery life, and processing capability among other benefits.

The device 505 may be an example of a network entity 105 or a UE 115, as described with reference to FIGS. 1 and 2. The UE 115-d and the UE 115-e may be examples of a UE 115, as described with reference to FIGS. 1 and 2. In the following description of the process flow 500, the operations may be performed in different orders or at different times. Some operations may also be omitted from the process flow 500, and other operations may be added to the process flow 500.

At 510, the UE 115-d may transmit a sidelink reference signal to the UE 115-e on a first active BWP (e.g., a sidelink active BWP). The sidelink reference signal may be associated with a subsequent transmission of a sidelink message on the first active BWP.

At 515, the UE 115-e may perform channel estimation based on the sidelink reference signal. For example, the UE 115-d may transmit the sidelink reference signal over a sidelink channel (e.g., a PSCCH). The UE 115-e may receive the sidelink reference signal and estimate one or more characteristics of the channel (e.g., determine CSI associated with the sidelink channel).

At 520, the UE 115-d may optionally transmit a message to the device 505. For example, if the device 505 is a network entity, the UE 115-d may switch to a second active BWP different from the first active BWP (e.g., an active Uu BWP) to transmit an uplink message to the network entity. Alternatively, if the device 505 is another UE 115, the UE 115-d may switch to the second active BWP (e.g., here a second active sidelink BWP different from the active sidelink BWP) to transmit a second sidelink message.

At 525, the UE 115-d may optionally transmit a capability indication to the UE 115-e. For example, if the UE 115-d has a capability to maintain coherency between uplink transmissions when switching between active Uu BWPs, the UE 115-d may optionally transmit the capability indication to indicate the capability to maintain coherency to the UE 115-e.

At 530, the UE 115-d may optionally determine whether the UE 115-d switches from the first active BWP to the second active BWP. For example, if at 520, the UE 115-d transmits the message to the device 505, the UE 115-d may determine that the UE 115-d switches from the first active BWP to the second active BWP prior to transmitting the sidelink message after transmitting the sidelink reference signal.

At 535, the UE 115-d may optionally transmit a coherency indication to the UE 115-e. For example, based on determining whether the UE 115-d switches active BWPs, the UE 115-d may determine whether the UE 115-d maintains coherency. The UE 115-d may transmit the coherency indication to indicate to the UE 115-e based on whether the UE 115-d maintains coherency. In some examples, if the UE 115-d determines that it maintains coherency, the UE 115-d may refrain from transmitting the coherency indication.

At 540, the UE 115-e may optionally determine whether the UE 115-d switches from the first active BWP to the second active BWP. For example, if at 520, the UE 115-d transmits the message to the device 505, the UE 115-e may determine that the UE 115-d switches from the first active BWP to the second active BWP prior to transmitting the sidelink message and after transmitting the sidelink reference signal. In some examples, the UE 115-e may determine that the UE 115-d transmits the message to the device 505 based on decoding SCI transmitted by the UE 115-d to reserve sidelink resources for transmission of the message.

At 545, the UE 115-e may transmit a scheduling message to the UE 115-d. In some examples, the scheduling message may be based on whether the UE 115-d maintains coherency. For example, if the UE 115-d maintains coherency, the UE 115-e may select a precoding matrix associated with coherent transmission of sidelink messages for the UE 115-d to use to transmit the sidelink message. Alternatively, if the UE 115-d loses coherency, the UE 115-e may select a precoding matrix associated with non-coherent transmission of sidelink messages for the UE 115-d to use to transmit the sidelink message. The UE 115-e may indicate the selected precoding matrix via a PMI included in the scheduling message.

At 550, the UE 115-d may transmit the sidelink message to the UE 115-e. The UE 115-d may coherently or non-coherently transmit the sidelink message based on whether the UE 115-d maintains coherency. Additionally, the UE 115-d may transmit the sidelink message using the indicated precoding matrix.

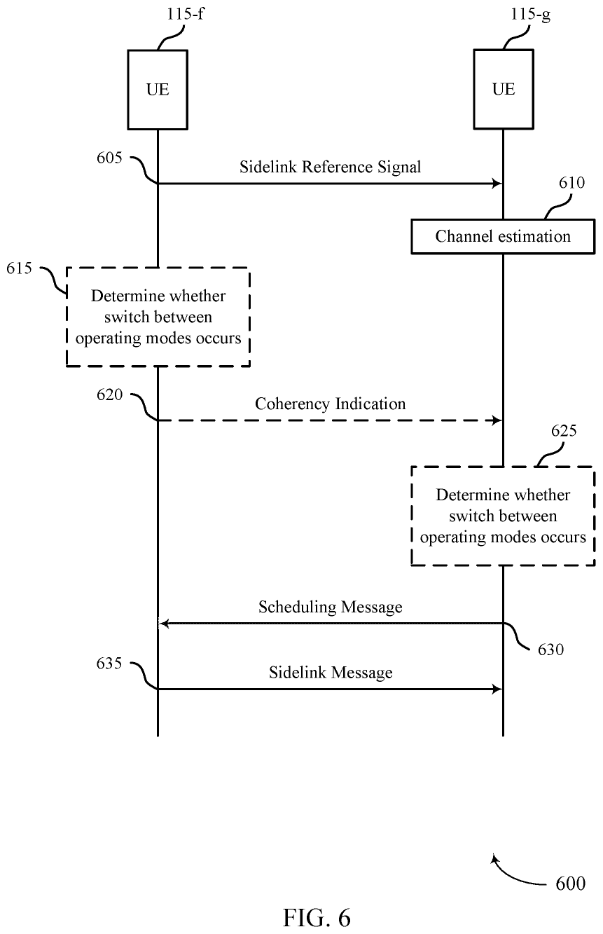

FIG. 6 illustrates an example of a process flow 600 that supports sidelink coherency management in accordance with aspects of the present disclosure. The process flow 600 may implement aspects of the wireless communications systems 100 and 200 or may be implemented by aspects of the wireless communications system 100 and 200 as described with reference to FIGS. 1 and 2, respectively. For example, the process flow 600 may be implemented by a UE 115-f, and a UE 115-g to support coherency management for sidelink communications to increase data rates, spectral efficiency, and reliability. The process flow 600 may further be implemented by the UE 115-f and the UE 115-g to provide improvements to coordination between devices, power consumption, resource usage, battery life, and processing capability among other benefits.

The UE 115-f and the UE 115-g may be examples of a UE 115, as described with reference to FIGS. 1 and 2. In the following description of the process flow 600, the operations may be performed in different orders or at different times. Some operations may also be omitted from the process flow 600, and other operations may be added to the process flow 600.

At 605, the UE 115-f may transmit a sidelink reference signal to the UE 115-g on a first active BWP (e.g., a sidelink active BWP). The sidelink reference signal may be associated with a subsequent transmission of a sidelink message on the first active BWP.

At 610, the UE 115-g may perform channel estimation based on the sidelink reference signal. For example, the UE 115-f may transmit the sidelink reference signal over a sidelink channel (e.g., a PSCCH), and the UE 115-g estimate one or more characteristics of the channel (e.g., determine CSI associated with the sidelink channel) based on the sidelink reference signal.

At 615, the UE 115-f may optionally determine whether the UE 115-f switches (e.g., or will switch) between operating modes. For example, the UE 115-f may determine whether the UE 115-f switches (or will switch) between a full-duplex mode and a half-duplex mode or between a first full-duplex mode and a second full-duplex mode prior to or concurrent with transmitting the sidelink message and after transmitting the sidelink reference signal.

At 620, the UE 115-f may optionally transmit a coherency indication to the UE 115-g. For example, based on determining whether the UE 115-f switches (e.g., or will switch) operating modes, the UE 115-f may determine whether the UE 115-f maintains coherency. The UE 115-f may transmit the coherency indication to indicate to the UE 115-g based on whether the UE 115-f maintains coherency. In some examples, if the UE 115-f determines that it maintains coherency, the UE 115-f may refrain from transmitting the coherency indication.

At 625, the UE 115-g may optionally determine whether the UE 115-f switches (e.g., or will switch) between operating modes. For example, the UE 115-g may determine whether the UE 115-f switches (or will switch) between the full-duplex mode and the half-duplex mode or between the first full-duplex mode and the second full-duplex mode prior to or concurrent with transmitting the sidelink message and after transmitting the sidelink reference signal. Based on determining whether the UE 115-f switches (e.g., or will switch) operating modes, the UE 115-g may determine whether the UE 115-f maintains coherency.

At 630, the UE 115-g may transmit a scheduling message to the UE 115-f. In some examples, the scheduling message may be based on whether the UE 115-f maintains coherency. For example, the UE 115-g may select a precoding matrix, a spatial transmission beam, an antenna group, or a combination thereof, for the UE 115-d to use to transmit the sidelink message based on whether the UE 115-f maintains coherency. The UE 115-g may indicate the selected precoding matrix via a PMI included in the scheduling message.

At 635, the UE 115-f may transmit the sidelink message to the UE 115-g. The UE 115-f may coherently or non-coherently transmit the sidelink message based on whether the UE 115-f maintains coherency. Additionally, the UE 115-f may transmit the sidelink message using the indicated precoding matrix, spatial transmission beam, antenna group, or combination thereof.

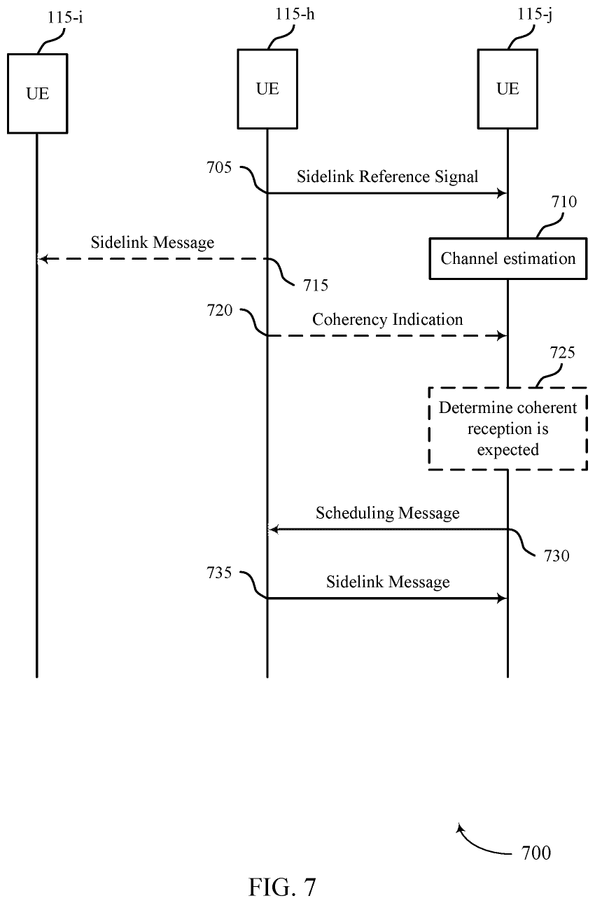

FIG. 7 illustrates an example of a process flow 700 that supports sidelink coherency management in accordance with aspects of the present disclosure. The process flow 700 may implement aspects of the wireless communications systems 100 and 200 or may be implemented by aspects of the wireless communications system 100 and 200 as described with reference to FIGS. 1 and 2, respectively. For example, the process flow 700 may be implemented by a UE 115-h, a UE 115-i, and a UE 115-g to support coherency management for sidelink communications to increase data rates, spectral efficiency, and reliability. The process flow 700 may further be implemented by the UE 115-h, the UE 115-i, and the UE 115-g to provide improvements to coordination between devices, power consumption, resource usage, battery life, and processing capability among other benefits.

The UE 115-h, the UE 115-i, and the UE 115-g may be examples of a UE 115, as described with reference to FIGS. 1 and 2. In the following description of the process flow 700, the operations may be performed in different orders or at different times. Some operations may also be omitted from the process flow 700, and other operations may be added to the process flow 700.

At 705, the UE 115-h may transmit a sidelink reference signal to the UE 115-j on a first CC. The sidelink reference signal may be associated with a subsequent transmission of a sidelink message on the first CC. In some examples, the UE 115-h may be a limited transmission capability UE. Here, the UE 115-h may include a single radio frequency chain and may transmit the sidelink reference signal on the first CC according to a first set of parameters.

At 710, the UE 115-j may perform channel estimation based on the sidelink reference signal. For example, the UE 115-h may transmit the sidelink reference signal over a sidelink channel (e.g., a PSCCH), and the UE 115-j estimate one or more characteristics of the channel (e.g., determine CSI associated with the sidelink channel) based on the sidelink reference signal.

At 715, the UE 115-h may optionally transmit a second sidelink message to the 115-i on a second CC different from the first CC. The UE 115-h may transmit the second sidelink message according to a second set of parameters. For example, the UE 115-h may tune the radio frequency chain to the second set of parameters and may transmit the second sidelink message on the second CC using the radio frequency chain.

At 720, the UE 115-h may optionally transmit a coherency indication to the UE 115-j. For example, based on whether the UE 115-h transmits the second sidelink message, the UE 115-h may determine whether the UE 115-h maintains coherency. The UE 115-h may transmit the coherency indication to indicate to the UE 115-j based on whether the UE 115-h maintains coherency. In some examples, if the UE 115-h determines that it maintains coherency, the UE 115-h may refrain from transmitting the coherency indication.

At 725, the UE 115-j may optionally determine whether the UE 115-h transmitted the second sidelink message to the UE 115-i. For example, if at 715, the UE 115-h transmits the message to the UE 115-i, the UE 115-j may determine that the UE 115-j transmitted the second sidelink message prior to transmitting the sidelink message. In some examples, the UE 115-j may determine that the UE 115-h transmits the second sidelink message based on decoding SCI transmitted by the UE 115-h to reserve sidelink resources for transmission of the second sidelink message. In some examples, the UE 115-j may determine that the UE 115-h transmits the second sidelink message based on the coherency indication.

At 730, the UE 115-j may transmit a scheduling message to the UE 115-h. In some examples, the scheduling message may be based on whether the UE 115-h maintains coherency. For example, the UE 115-j may select a precoding matrix for the UE 115-h to use to transmit the sidelink message based on whether the UE 115-h maintains coherency. The UE 115-j may indicate the selected precoding matrix via a PMI included in the scheduling message.

At 735, the UE 115-h may transmit the sidelink message to the UE 115-j. The UE 115-h may coherently or non-coherently transmit the sidelink message based on whether the UE 115-h maintains coherency. Additionally, the UE 115-h may transmit the sidelink message using the indicated precoding matrix.

FIG. 8 shows a block diagram 800 of a device 805 that supports sidelink coherency management in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to sidelink coherency management). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to sidelink coherency management). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of sidelink coherency management as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at a first wireless device in accordance with examples as disclosed herein. For example, the communications manager 820 may be configured as or otherwise support a means for communicating, with a second wireless device, a sidelink reference signal on a first active BWP, the sidelink reference signal associated with a subsequent communication of a sidelink message on the first active BWP. The communications manager 820 may be configured as or otherwise support a means for determining whether a switch to a second active BWP occurs prior to communicating the sidelink message and after communicating the sidelink reference signal. The communications manager 820 may be configured as or otherwise support a means for communicating the sidelink message on the first active BWP according to a first set of coherency transmission characteristics based on the determining.

Additionally or alternatively, the communications manager 820 may support wireless communications at a first wireless device in accordance with examples as disclosed herein. For example, the communications manager 820 may be configured as or otherwise support a means for communicating, with a second wireless device, a sidelink reference signal on a first active BWP, the sidelink reference signal associated with a subsequent communication of a sidelink message on the first active BWP. The communications manager 820 may be configured as or otherwise support a means for determining whether a switch between a first duplex mode and a second duplex mode occurs prior to or concurrent with communicating the sidelink message and after communicating the sidelink reference signal. The communications manager 820 may be configured as or otherwise support a means for communicating the sidelink message on the first active BWP according to a first set of coherency transmission characteristics based on the determining.

Additionally or alternatively, the communications manager 820 may support wireless communications at a first wireless device in accordance with examples as disclosed herein. For example, the communications manager 820 may be configured as or otherwise support a means for transmitting, to a second wireless device, a sidelink reference signal on a first CC, the sidelink reference signal associated with a subsequent transmission of a first sidelink message on the first CC. The communications manager 820 may be configured as or otherwise support a means for determining whether to transmit, to a third wireless device, a second sidelink message on a second CC prior to transmitting the first sidelink message and after transmitting the sidelink reference signal, where the first sidelink message is transmitted on the first CC using a radio frequency chain according to a first set of parameters and the second sidelink message is transmitted on the second CC using the radio frequency chain according to a second set of parameters that is different from the first set of parameters. The communications manager 820 may be configured as or otherwise support a means for transmitting, to the second wireless device, the first sidelink message according to a first set of coherency transmission characteristics based on the determining.

Additionally or alternatively, the communications manager 820 may support wireless communication at a first wireless device in accordance with examples as disclosed herein. For example, the communications manager 820 may be configured as or otherwise support a means for receiving, from a second wireless device, a sidelink reference signal on a first CC, the sidelink reference signal associated with a subsequent transmission of a first sidelink message on the first CC. The communications manager 820 may be configured as or otherwise support a means for transmitting, to the second wireless device, an indication of a precoding matrix (e.g., a PMI) to use to transmit the first sidelink message, the precoding matrix based on determining whether coherent reception of the sidelink reference signal and the first sidelink message is expected at the first wireless device. The communications manager 820 may be configured as or otherwise support a means for receiving the first sidelink message based on transmitting the indication of the precoding matrix.

By including or configuring the communications manager 820 in accordance with examples as described herein, the device 805 (e.g., a processor controlling or otherwise coupled to the receiver 810, the transmitter 815, the communications manager 820, or a combination thereof) may support techniques reduced power consumption and more efficient utilization of communication resources by supporting coherency management of sidelink communications.

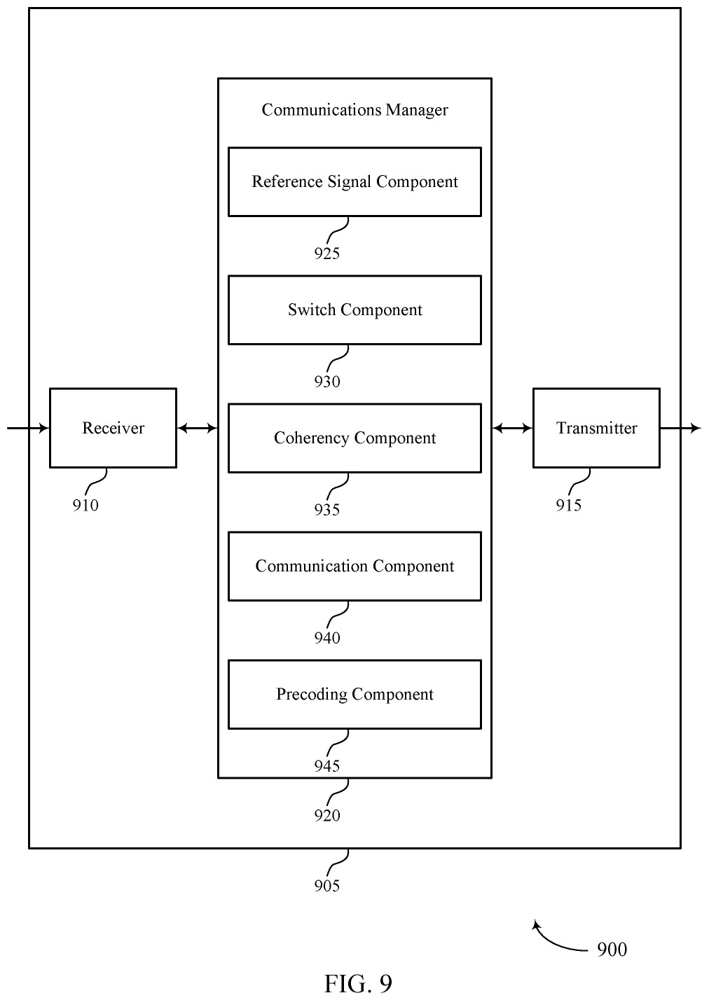

FIG. 9 shows a block diagram 900 of a device 905 that supports sidelink coherency management in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to sidelink coherency management). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to sidelink coherency management). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of sidelink coherency management as described herein. For example, the communications manager 920 may include a reference signal component 925, a switch component 930, a coherency component 935, a communication component 940, a precoding component 945, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a first wireless device in accordance with examples as disclosed herein. The reference signal component 925 may be configured as or otherwise support a means for communicating, with a second wireless device, a sidelink reference signal on a first active BWP, the sidelink reference signal associated with a subsequent communication of a sidelink message on the first active BWP. The switch component 930 may be configured as or otherwise support a means for determining whether a switch to a second active BWP occurs prior to communicating the sidelink message and after communicating the sidelink reference signal. The coherency component 935 may be configured as or otherwise support a means for communicating the sidelink message on the first active BWP according to a first set of coherency transmission characteristics based on the determining.

Additionally or alternatively, the communications manager 920 may support wireless communications at a first wireless device in accordance with examples as disclosed herein. The reference signal component 925 may be configured as or otherwise support a means for communicating, with a second wireless device, a sidelink reference signal on a first active BWP, the sidelink reference signal associated with a subsequent communication of a sidelink message on the first active BWP. The switch component 930 may be configured as or otherwise support a means for determining whether a switch between a first duplex mode and a second duplex mode occurs prior to or concurrent with communicating the sidelink message and after communicating the sidelink reference signal. The coherency component 935 may be configured as or otherwise support a means for communicating the sidelink message on the first active BWP according to a first set of coherency transmission characteristics based on the determining.

Additionally or alternatively, the communications manager 920 may support wireless communications at a first wireless device in accordance with examples as disclosed herein. The reference signal component 925 may be configured as or otherwise support a means for transmitting, to a second wireless device, a sidelink reference signal on a first CC, the sidelink reference signal associated with a subsequent transmission of a first sidelink message on the first CC. The communication component 940 may be configured as or otherwise support a means for determining whether to transmit, to a third wireless device, a second sidelink message on a second CC prior to transmitting the first sidelink message and after transmitting the sidelink reference signal, where the first sidelink message is transmitted on the first CC using a radio frequency chain according to a first set of parameters and the second sidelink message is transmitted on the second CC using the radio frequency chain according to a second set of parameters that is different from the first set of parameters. The coherency component 935 may be configured as or otherwise support a means for transmitting, to the second wireless device, the first sidelink message according to a first set of coherency transmission characteristics based on the determining.

Additionally or alternatively, the communications manager 920 may support wireless communication at a first wireless device in accordance with examples as disclosed herein. The reference signal component 925 may be configured as or otherwise support a means for receiving, from a second wireless device, a sidelink reference signal on a first CC, the sidelink reference signal associated with a subsequent transmission of a first sidelink message on the first CC. The precoding component 945 may be configured as or otherwise support a means for transmitting, to the second wireless device, an indication of a precoding matrix (e.g., a PMI) to use to transmit the first sidelink message, the precoding matrix based on determining whether coherent reception of the sidelink reference signal and the first sidelink message is expected at the first wireless device. The coherency component 935 may be configured as or otherwise support a means for receiving the first sidelink message based on transmitting the indication of the precoding matrix.

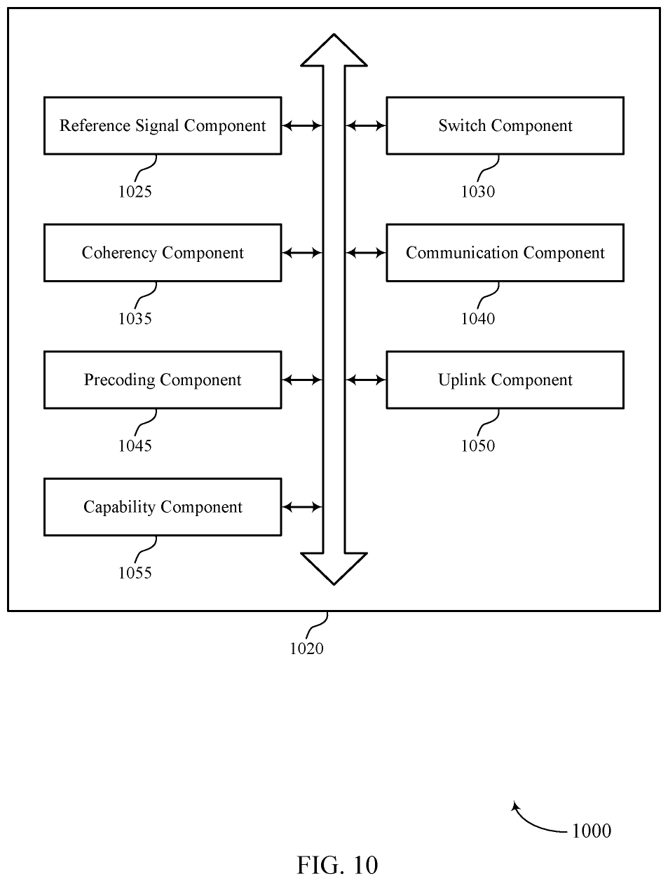

FIG. 10 shows a block diagram 1000 of a communications manager 1020 that supports sidelink coherency management in accordance with aspects of the present disclosure. The communications manager 1020 may be an example of aspects of a communications manager 820, a communications manager 920, or both, as described herein. The communications manager 1020, or various components thereof, may be an example of means for performing various aspects of sidelink coherency management as described herein. For example, the communications manager 1020 may include a reference signal component 1025, a switch component 1030, a coherency component 1035, a communication component 1040, a precoding component 1045, an uplink component 1050, a capability component 1055, or any combination thereof. Each of these components may communicate, directly or indirectly, with one another (e.g., via one or more buses).

The communications manager 1020 may support wireless communications at a first wireless device in accordance with examples as disclosed herein. The reference signal component 1025 may be configured as or otherwise support a means for communicating, with a second wireless device, a sidelink reference signal on a first active BWP, the sidelink reference signal associated with a subsequent communication of a sidelink message on the first active BWP. The switch component 1030 may be configured as or otherwise support a means for determining whether a switch to a second active BWP occurs prior to communicating the sidelink message and after communicating the sidelink reference signal. The coherency component 1035 may be configured as or otherwise support a means for communicating the sidelink message on the first active BWP according to a first set of coherency transmission characteristics based on the determining.

In some examples, to support communicating the sidelink message, the coherency component 1035 may be configured as or otherwise support a means for communicating, based on determining that the switch fails occur, the sidelink message according to the first set of coherency transmission characteristics such that a relative difference between first communication characteristics associated with communicating the sidelink reference signal and second communication characteristics associated with communicating the sidelink message satisfies a threshold relative difference.

In some examples, to support communicating the sidelink message, the coherency component 1035 may be configured as or otherwise support a means for communicating, based on determining that the switch occurs, the sidelink message according to the first set of coherency transmission characteristics such that a relative difference between first communication characteristics associated with communicating the sidelink reference signal and second communication characteristics associated with communicating the sidelink message fails to satisfy a threshold relative difference.

In some examples, first communication characteristics associated with communicating the sidelink reference signal include a phase associated with communicating the sidelink reference signal, a transmission power associated with communicating the sidelink reference signal, a time at which the sidelink reference signal is communicated, or a combination thereof. In some examples, second communication characteristics associated with communicating the sidelink message include a phase associated with communicating the sidelink message, a transmission power associated with communicating the sidelink message, a time at which the sidelink message is communicated, or a combination thereof.

In some examples, the coherency component 1035 may be configured as or otherwise support a means for communicating, based on determining whether the switch occurs, an indication of whether a relative difference between first communication characteristics associated with communicating the sidelink reference signal and second communication characteristics associated with communicating the sidelink message satisfies a threshold relative difference.

In some examples, the uplink component 1050 may be configured as or otherwise support a means for transmitting, prior to communicating the sidelink message, an uplink message to a network entity on the second active BWP, where determining whether the switch occurs is based on transmitting the uplink message.

In some examples, the capability component 1055 may be configured as or otherwise support a means for transmitting an indication of a capability to maintain coherency between uplink transmissions when switching between active BWPs associated with uplink transmissions to a network entity, where communicating the sidelink message is based on transmitting the indication of the capability.

In some examples, the switch component 1030 may be configured as or otherwise support a means for switching to the second active BWP to transmit a second sidelink message prior to communicating the sidelink message. In some examples, the reference signal component 1025 may be configured as or otherwise support a means for transmitting, to the second wireless device, the sidelink reference signal having first transmission characteristics. In some examples, the coherency component 1035 may be configured as or otherwise support a means for transmitting, to the second wireless device, the sidelink message having second transmission characteristics such that a relative difference between the first transmission characteristics and the second transmission characteristics satisfies a threshold relative difference based on the capability.

In some examples, the capability is associated with a particular frequency band or a combination or two or more frequency bands.

In some examples, to support determining whether the switch occurs, the switch component 1030 may be configured as or otherwise support a means for determining whether a switch from a third active BWP to the second active BWP occurs prior to communicating the sidelink message, the first active BWP associated with a first CC, the second active BWP and the third active BWP associated with a second CC that is switched together with the first CC.

In some examples, the second CC is communicated using a same radio frequency chain that is used to communicate the first CC.

In some examples, to support determining whether the switch occurs, the switch component 1030 may be configured as or otherwise support a means for determining that the second wireless device switches to the second active BWP prior to communicating the sidelink message. In some examples, the precoding component 1045 may be configured as or otherwise support a means for transmitting, to the second wireless device and prior to communicating the sidelink message, an indication of a precoding matrix (e.g., a PMI), a spatial transmission beam, an antenna group, or a combination thereof, to use to transmit the sidelink message based on determining that the second wireless device switches to the second active BWP. In some examples, the coherency component 1035 may be configured as or otherwise support a means for receiving, from the second wireless device, the sidelink message based on transmitting the indication of the precoding matrix, the spatial transmission beam, the antenna group, or the combination thereof.

In some examples, to support determining whether the switch occurs, the switch component 1030 may be configured as or otherwise support a means for determining that the second wireless device fails to switch to the second active BWP prior to communicating the sidelink message. In some examples, the coherency component 1035 may be configured as or otherwise support a means for receiving, from the second wireless device, the sidelink message according to the first set of coherency transmission characteristics based on determining that the second wireless device fails to switch to the second active BWP.

In some examples, the first active BWP is an active BWP associated with communicating sidelink messages and the second active BWP is an active BWP associated with transmitting uplink messages to a network entity.

In some examples, the first active BWP and the second active BWP are active BWPs associated with communicating sidelink messages.

Additionally or alternatively, the communications manager 1020 may support wireless communications at a first wireless device in accordance with examples as disclosed herein. In some examples, the reference signal component 1025 may be configured as or otherwise support a means for communicating, with a second wireless device, a sidelink reference signal on a first active BWP, the sidelink reference signal associated with a subsequent communication of a sidelink message on the first active BWP. In some examples, the switch component 1030 may be configured as or otherwise support a means for determining whether a switch between a first duplex mode and a second duplex mode occurs prior to or concurrent with communicating the sidelink message and after communicating the sidelink reference signal. In some examples, the coherency component 1035 may be configured as or otherwise support a means for communicating the sidelink message on the first active BWP according to a first set of coherency transmission characteristics based on the determining.

In some examples, to support communicating the sidelink message, the coherency component 1035 may be configured as or otherwise support a means for communicating, based on determining that the switch fails to occur, the sidelink message according to the first set of coherency transmission characteristics such that a relative difference between first communication characteristics associated with communicating the sidelink reference signal and second communication characteristics associated with communicating the sidelink message satisfies a threshold relative difference.

In some examples, to support communicating the sidelink message, the coherency component 1035 may be configured as or otherwise support a means for communicating, based on determining that the switch occurs, the sidelink message according to the first set of coherency transmission characteristics such that a relative difference between first communication characteristics associated with communicating the sidelink reference signal and second communication characteristics associated with communicating the sidelink message fails to satisfy a threshold relative difference.

In some examples, first communication characteristics associated with communicating the sidelink reference signal include a phase associated with communicating the sidelink reference signal, a transmission power associated with communicating the sidelink reference signal, a time at which the sidelink reference signal is communicated, or a combination thereof. In some examples, second communication characteristics associated with communicating the sidelink message include a phase associated with communicating the sidelink message, a transmission power associated with communicating the sidelink message, a time at which the sidelink message is communicated, or a combination thereof.

In some examples, the first duplex mode is a full-duplex mode and the second duplex mode is a half-duplex mode.

In some examples, the first duplex mode is a first full-duplex mode and the second duplex mode is a second full-duplex mode, the first full-duplex mode associated with a first uplink bandwidth, a first downlink bandwidth, or a combination thereof, the second full-duplex mode associated with a second uplink bandwidth different from the first uplink bandwidth, a second downlink bandwidth different from the second downlink bandwidth, or a combination thereof.

In some examples, the reference signal component 1025 may be configured as or otherwise support a means for transmitting the sidelink reference signal while operating in the first duplex mode. In some examples, the communication component 1040 may be configured as or otherwise support a means for transmitting, prior to communicating the sidelink message and after transmitting the sidelink reference signal, a second sidelink message while operating in the second duplex mode, where determining whether the switch occurs is based on transmitting the sidelink reference signal while operating in the first duplex mode and transmitting the second sidelink message while operating in the second duplex mode.

In some examples, the reference signal component 1025 may be configured as or otherwise support a means for transmitting the sidelink reference signal while operating in the first duplex mode. In some examples, the coherency component 1035 may be configured as or otherwise support a means for transmitting the sidelink message while operating in the second duplex mode, where determining whether the switch occurs is based on transmitting the sidelink reference signal while operating in the first duplex mode and transmitting the sidelink message while operating in the second duplex mode.

In some examples, to support determining whether the switch occurs, the switch component 1030 may be configured as or otherwise support a means for determining that the second wireless device switches between the first duplex mode and the second duplex mode prior to communicating the sidelink message and after communicating the sidelink reference signal. In some examples, the precoding component 1045 may be configured as or otherwise support a means for transmitting, to the second wireless device and prior to communicating the sidelink message, an indication of a precoding matrix (e.g., a PMI), a spatial transmission beam, an antenna group, or a combination thereof, to use to transmit the sidelink message based on determining that the second wireless device switches between the first duplex mode and the second duplex mode. In some examples, the coherency component 1035 may be configured as or otherwise support a means for receiving, from the second wireless device, the sidelink message based on transmitting the indication of the precoding matrix, the spatial transmission beam, the antenna group, or the combination thereof.

Additionally or alternatively, the communications manager 1020 may support wireless communications at a first wireless device in accordance with examples as disclosed herein. In some examples, the reference signal component 1025 may be configured as or otherwise support a means for transmitting, to a second wireless device, a sidelink reference signal on a first CC, the sidelink reference signal associated with a subsequent transmission of a first sidelink message on the first CC. The communication component 1040 may be configured as or otherwise support a means for determining whether to transmit, to a third wireless device, a second sidelink message on a second CC prior to transmitting the first sidelink message and after transmitting the sidelink reference signal, where the first sidelink message is transmitted on the first CC using a radio frequency chain according to a first set of parameters and the second sidelink message is transmitted on the second CC using the radio frequency chain according to a second set of parameters that is different from the first set of parameters. In some examples, the coherency component 1035 may be configured as or otherwise support a means for transmitting, to the second wireless device, the first sidelink message according to a first set of coherency transmission characteristics based on the determining.

In some examples, to support transmitting the first sidelink message, the coherency component 1035 may be configured as or otherwise support a means for transmitting, based on failing to transmit the second sidelink message, the first sidelink message according to the first set of coherency transmission characteristics such that a relative difference between first transmission characteristics associated with transmitting the sidelink reference signal and second transmission characteristics associated with transmitting the first sidelink message satisfies a threshold relative difference.

In some examples, the communication component 1040 may be configured as or otherwise support a means for transmitting the second sidelink message on the second CC. In some examples, to support transmitting the first sidelink message, the coherency component 1035 may be configured as or otherwise support a means for transmitting, based on transmitting the second sidelink message, the first sidelink message according to the first set of coherency transmission characteristics such that a relative difference between first transmission characteristics associated with transmitting the sidelink reference signal and second transmission characteristics associated with transmitting the first sidelink message fails to satisfy a threshold relative difference.

In some examples, first transmission characteristics associated with transmitting the sidelink reference signal include a phase associated with transmitting the sidelink reference signal, a transmission power for transmitting the sidelink reference signal, a time at which the sidelink reference signal is transmitted, or a combination thereof. In some examples, second transmission characteristics associated with transmitting the first sidelink message include a phase associated with transmitting the first sidelink message, a transmission power for transmitting the first sidelink message, a time at which the first sidelink message is transmitted, or a combination thereof.

In some examples, the precoding component 1045 may be configured as or otherwise support a means for receiving an indication of a precoding matrix (e.g., a PMI), a spatial transmission beam, an antenna group, or a combination thereof, to use to transmit the first sidelink message based on the determining, where transmitting the first sidelink message includes transmitting the first sidelink message according to the indicated precoding matrix, spatial transmission beam, antenna group, or combination thereof.

Additionally or alternatively, the communications manager 1020 may support wireless communication at a first wireless device in accordance with examples as disclosed herein. In some examples, the reference signal component 1025 may be configured as or otherwise support a means for receiving, from a second wireless device, a sidelink reference signal on a first CC, the sidelink reference signal associated with a subsequent transmission of a first sidelink message on the first CC. The precoding component 1045 may be configured as or otherwise support a means for transmitting, to the second wireless device, an indication of a precoding matrix (e.g., a PMI) to use to transmit the first sidelink message, the precoding matrix based on determining whether coherent reception of the sidelink reference signal and the first sidelink message is expected at the first wireless device. In some examples, the coherency component 1035 may be configured as or otherwise support a means for receiving the first sidelink message based on transmitting the indication of the precoding matrix.

In some examples, the communication component 1040 may be configured as or otherwise support a means for determining whether coherent reception of the sidelink reference signal and the first sidelink message is expected at the first wireless device based on receiving an indication from the second wireless device that the second wireless device will coherently transmit the first sidelink message.

In some examples, the communication component 1040 may be configured as or otherwise support a means for determining whether coherent reception of the sidelink reference signal and the first sidelink message is expected at the first wireless device based on decoding sidelink control information transmitted by the first wireless device to determine whether the first wireless device transmits a second sidelink message on a second component carrier prior to transmitting the first sidelink message and after transmitting the sidelink reference signal.

In some examples, the precoding component 1045 may be configured as or otherwise support a means for selecting the precoding matrix based on determining that coherent reception of the sidelink reference signal and the first sidelink message is not expected, where the selected precoding matrix is associated with non-coherent transmission of the sidelink reference signal and the first sidelink message.

In some examples, the precoding component 1045 may be configured as or otherwise support a means for selecting the precoding matrix based on determining that coherent reception of the sidelink reference signal and the first sidelink message is expected, where the selected precoding matrix is associated with coherent transmission of the sidelink reference signal and the first sidelink message.

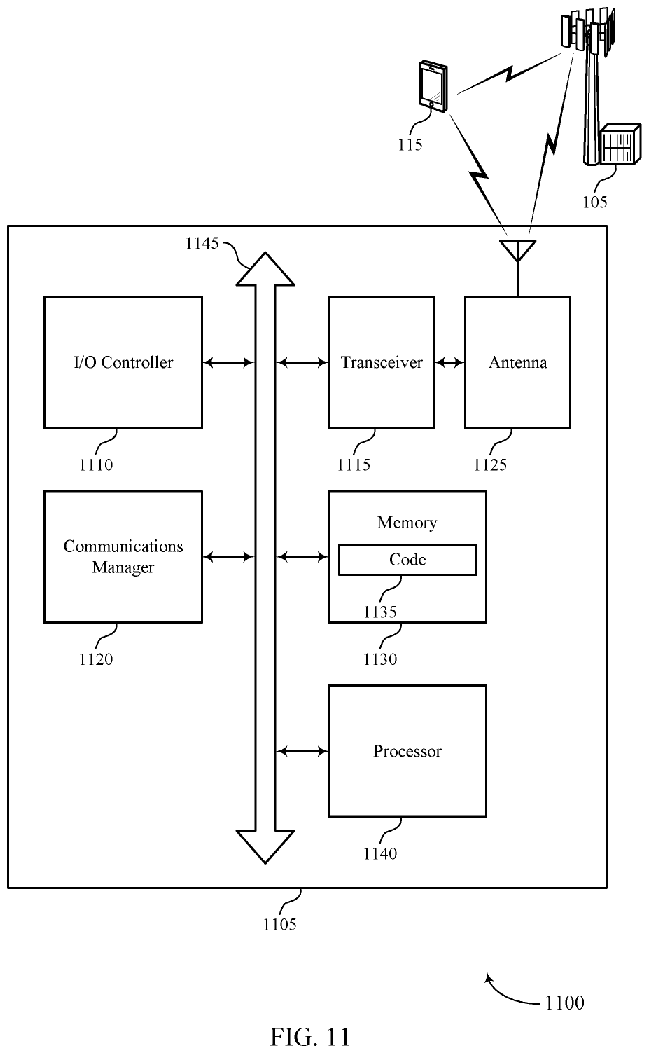

FIG. 11 shows a diagram of a system 1100 including a device 1105 that supports sidelink coherency management in accordance with aspects of the present disclosure. The device 1105 may be an example of or include the components of a device 805, a device 905, or a UE 115 as described herein. The device 1105 may communicate wirelessly with one or more network entities 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting sidelink coherency management). For example, the device 1105 or a component of the device 1105 may include a processor 1140 and memory 1130 coupled to the processor 1140, the processor 1140 and memory 1130 configured to perform various functions described herein.

The communications manager 1120 may support wireless communications at a first wireless device in accordance with examples as disclosed herein. For example, the communications manager 1120 may be configured as or otherwise support a means for communicating, with a second wireless device, a sidelink reference signal on a first active BWP, the sidelink reference signal associated with a subsequent communication of a sidelink message on the first active BWP. The communications manager 1120 may be configured as or otherwise support a means for determining whether a switch to a second active BWP occurs prior to communicating the sidelink message and after communicating the sidelink reference signal. The communications manager 1120 may be configured as or otherwise support a means for communicating the sidelink message on the first active BWP according to a first set of coherency transmission characteristics based on the determining.

Additionally or alternatively, the communications manager 1120 may support wireless communications at a first wireless device in accordance with examples as disclosed herein. For example, the communications manager 1120 may be configured as or otherwise support a means for communicating, with a second wireless device, a sidelink reference signal on a first active BWP, the sidelink reference signal associated with a subsequent communication of a sidelink message on the first active BWP. The communications manager 1120 may be configured as or otherwise support a means for determining whether a switch between a first duplex mode and a second duplex mode occurs prior to or concurrent with communicating the sidelink message and after communicating the sidelink reference signal. The communications manager 1120 may be configured as or otherwise support a means for communicating the sidelink message on the first active BWP according to a first set of coherency transmission characteristics based on the determining.

Additionally or alternatively, the communications manager 1120 may support wireless communications at a first wireless device in accordance with examples as disclosed herein. For example, the communications manager 1120 may be configured as or otherwise support a means for transmitting, to a second wireless device, a sidelink reference signal on a first CC, the sidelink reference signal associated with a subsequent transmission of a first sidelink message on the first CC. The communications manager 1120 may be configured as or otherwise support a means for determining whether to transmit, to a third wireless device, a second sidelink message on a second CC prior to transmitting the first sidelink message and after transmitting the sidelink reference signal, where the first sidelink message is transmitted on the first CC using a radio frequency chain according to a first set of parameters and the second sidelink message is transmitted on the second CC using the radio frequency chain according to a second set of parameters that is different from the first set of parameters. The communications manager 1120 may be configured as or otherwise support a means for transmitting, to the second wireless device, the first sidelink message according to a first set of coherency transmission characteristics based on the determining.

Additionally or alternatively, the communications manager 1120 may support wireless communication at a first wireless device in accordance with examples as disclosed herein. For example, the communications manager 1120 may be configured as or otherwise support a means for receiving, from a second wireless device, a sidelink reference signal on a first CC, the sidelink reference signal associated with a subsequent transmission of a first sidelink message on the first CC. The communications manager 1120 may be configured as or otherwise support a means for transmitting, to the second wireless device, an indication of a precoding matrix (e.g., a PMI) to use to transmit the first sidelink message, the precoding matrix based on determining whether coherent reception of the sidelink reference signal and the first sidelink message is expected at the first wireless device. The communications manager 1120 may be configured as or otherwise support a means for receiving the first sidelink message based on transmitting the indication of the precoding matrix.

By including or configuring the communications manager 1120 in accordance with examples as described herein, the device 1105 may support techniques for improved data rates, spectral efficiency, reliability, latency, coordination between devices, power consumption, resource usage, battery life, and processing capability among other benefits.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of sidelink coherency management as described herein, or the processor 1140 and the memory 1130 may be otherwise configured to perform or support such operations.

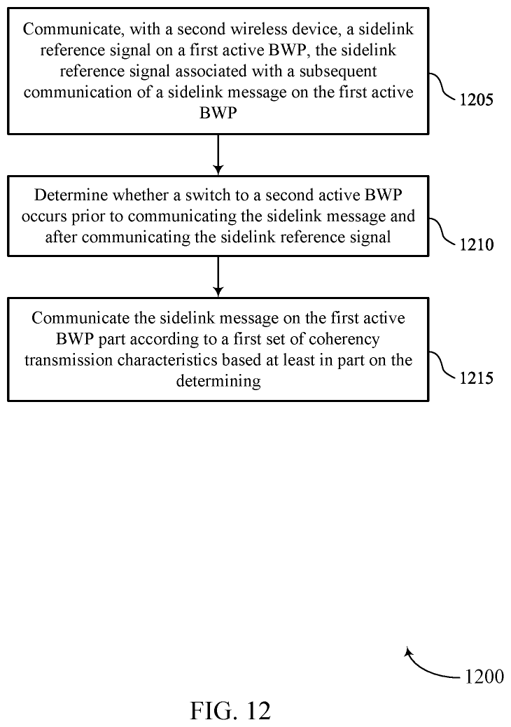

FIG. 12 shows a flowchart illustrating a method 1200 that supports sidelink coherency management in accordance with aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1205, the method may include communicating, with a second wireless device, a sidelink reference signal on a first active BWP, the sidelink reference signal associated with a subsequent communication of a sidelink message on the first active BWP. The operations of 1205 may be performed in accordance with examples as disclosed herein. In some examples, aspects of the operations of 1205 may be performed by a reference signal component 1025 as described with reference to FIG. 10.

At 1210, the method may include determining whether a switch to a second active BWP occurs prior to communicating the sidelink message and after communicating the sidelink reference signal. The operations of 1210 may be performed in accordance with examples as disclosed herein. In some examples, aspects of the operations of 1210 may be performed by a switch component 1030 as described with reference to FIG. 10.

At 1215, the method may include communicating the sidelink message on the first active BWP according to a first set of coherency transmission characteristics based on the determining. The operations of 1215 may be performed in accordance with examples as disclosed herein. In some examples, aspects of the operations of 1215 may be performed by a coherency component 1035 as described with reference to FIG. 10.

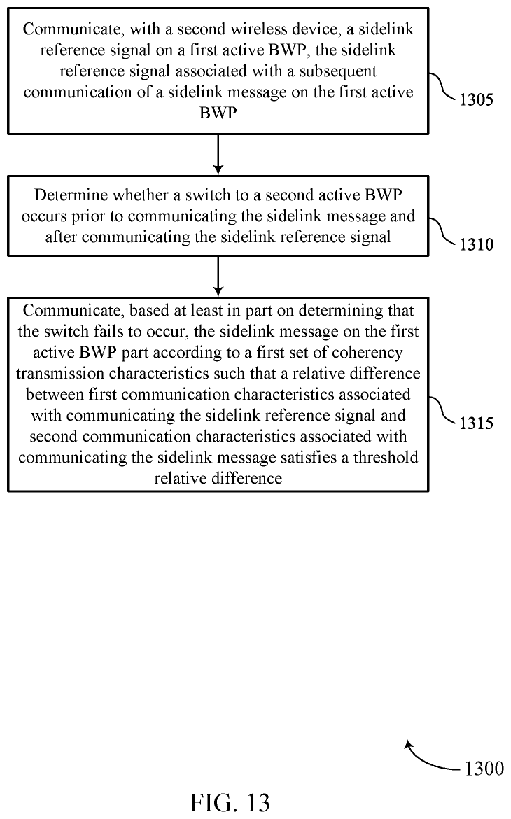

FIG. 13 shows a flowchart illustrating a method 1300 that supports sidelink coherency management in accordance with aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1305, the method may include communicating, with a second wireless device, a sidelink reference signal on a first active BWP, the sidelink reference signal associated with a subsequent communication of a sidelink message on the first active BWP. The operations of 1305 may be performed in accordance with examples as disclosed herein. In some examples, aspects of the operations of 1305 may be performed by a reference signal component 1025 as described with reference to FIG. 10.

At 1310, the method may include determining whether a switch to a second active BWP occurs prior to communicating the sidelink message and after communicating the sidelink reference signal. The operations of 1310 may be performed in accordance with examples as disclosed herein. In some examples, aspects of the operations of 1310 may be performed by a switch component 1030 as described with reference to FIG. 10.

At 1315, the method may include communicating, based on determining that the switch fails to occur, the sidelink message on the first active BWP part according to a first set of coherency transmission characteristics such that a relative difference between first communication characteristics associated with communicating the sidelink reference signal and second communication characteristics associated with communicating the sidelink message satisfies a threshold relative difference. The operations of 1315 may be performed in accordance with examples as disclosed herein. In some examples, aspects of the operations of 1315 may be performed by a coherency component 1035 as described with reference to FIG. 10.

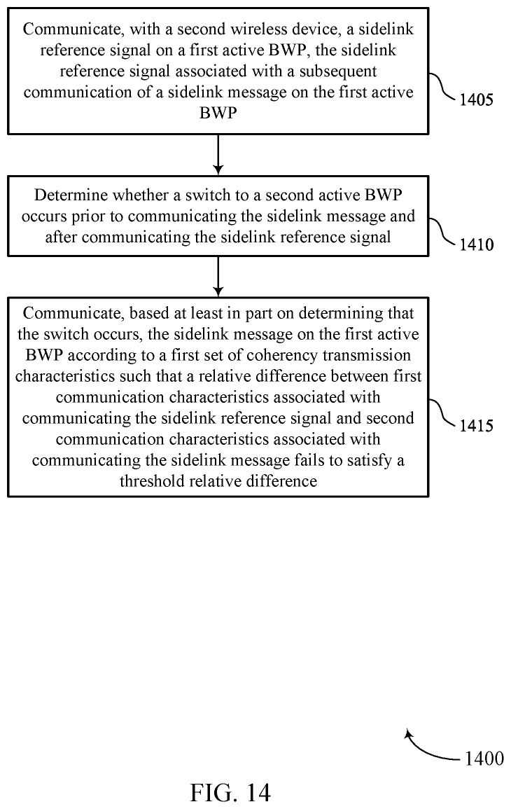

FIG. 14 shows a flowchart illustrating a method 1400 that supports sidelink coherency management in accordance with aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1405, the method may include communicating, with a second wireless device, a sidelink reference signal on a first active BWP, the sidelink reference signal associated with a subsequent communication of a sidelink message on the first active BWP. The operations of 1405 may be performed in accordance with examples as disclosed herein. In some examples, aspects of the operations of 1405 may be performed by a reference signal component 1025 as described with reference to FIG. 10.

At 1410, the method may include determining whether a switch to a second active BWP occurs prior to communicating the sidelink message and after communicating the sidelink reference signal. The operations of 1410 may be performed in accordance with examples as disclosed herein. In some examples, aspects of the operations of 1410 may be performed by a switch component 1030 as described with reference to FIG. 10.

At 1415, the method may include communicating, based on determining that the switch occurs, the sidelink message on the first active BWP according to a first set of coherency transmission characteristics such that a relative difference between first communication characteristics associated with communicating the sidelink reference signal and second communication characteristics associated with communicating the sidelink message fails to satisfy a threshold relative difference. The operations of 1415 may be performed in accordance with examples as disclosed herein. In some examples, aspects of the operations of 1415 may be performed by a coherency component 1035 as described with reference to FIG. 10.

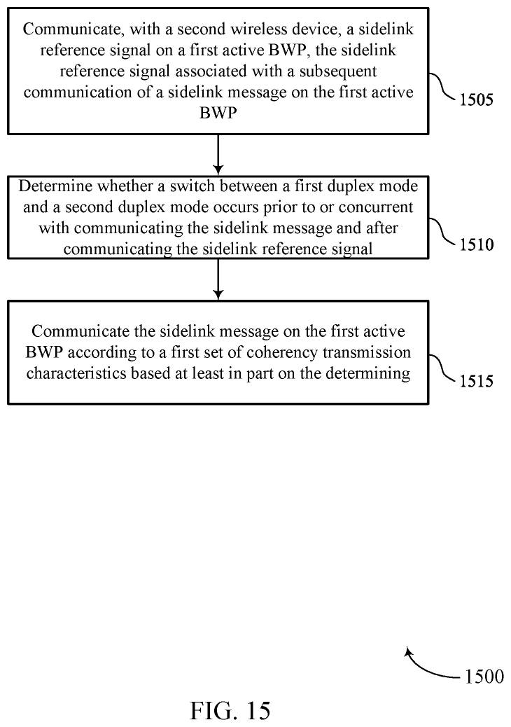

FIG. 15 shows a flowchart illustrating a method 1500 that supports sidelink coherency management in accordance with aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1505, the method may include communicating, with a second wireless device, a sidelink reference signal on a first active BWP, the sidelink reference signal associated with a subsequent communication of a sidelink message on the first active BWP. The operations of 1505 may be performed in accordance with examples as disclosed herein. In some examples, aspects of the operations of 1505 may be performed by a reference signal component 1025 as described with reference to FIG. 10.

At 1510, the method may include determining whether a switch between a first duplex mode and a second duplex mode occurs prior to or concurrent with communicating the sidelink message and after communicating the sidelink reference signal. The operations of 1510 may be performed in accordance with examples as disclosed herein. In some examples, aspects of the operations of 1510 may be performed by a switch component 1030 as described with reference to FIG. 10.

At 1515, the method may include communicating the sidelink message on the first active BWP according to a first set of coherency transmission characteristics based on the determining. The operations of 1515 may be performed in accordance with examples as disclosed herein. In some examples, aspects of the operations of 1515 may be performed by a coherency component 1035 as described with reference to FIG. 10.

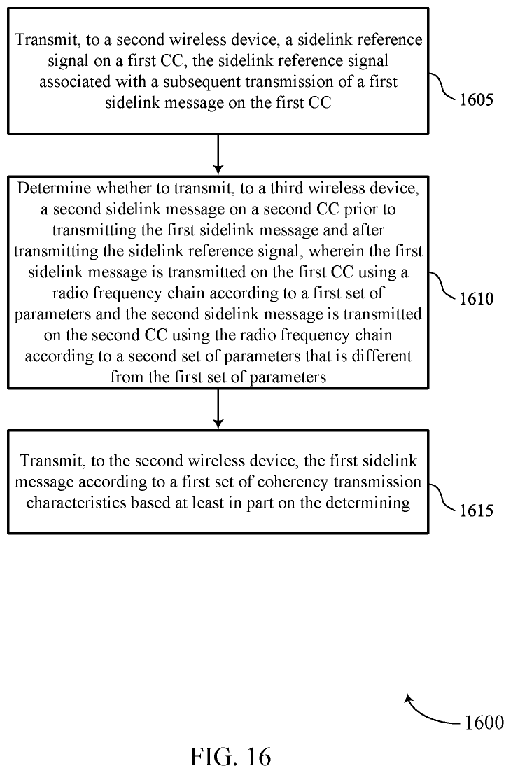

FIG. 16 shows a flowchart illustrating a method 1600 that supports sidelink coherency management in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1605, the method may include transmitting, to a second wireless device, a sidelink reference signal on a first CC, the sidelink reference signal associated with a subsequent transmission of a first sidelink message on the first CC. The operations of 1605 may be performed in accordance with examples as disclosed herein. In some examples, aspects of the operations of 1605 may be performed by a reference signal component 1025 as described with reference to FIG. 10.

At 1610, the method may include determining whether to transmit, to a third wireless device, a second sidelink message on a second CC prior to transmitting the first sidelink message and after transmitting the sidelink reference signal, where the first sidelink message is transmitted on the first CC using a radio frequency chain according to a first set of parameters and the second sidelink message is transmitted on the second CC using the radio frequency chain according to a second set of parameters that is different from the first set of parameters. The operations of 1610 may be performed in accordance with examples as disclosed herein. In some examples, aspects of the operations of 1610 may be performed by a communication component 1040 as described with reference to FIG. 10.

At 1615, the method may include transmitting, to the second wireless device, the first sidelink message according to a first set of coherency transmission characteristics based on the determining. The operations of 1615 may be performed in accordance with examples as disclosed herein. In some examples, aspects of the operations of 1615 may be performed by a coherency component 1035 as described with reference to FIG. 10.

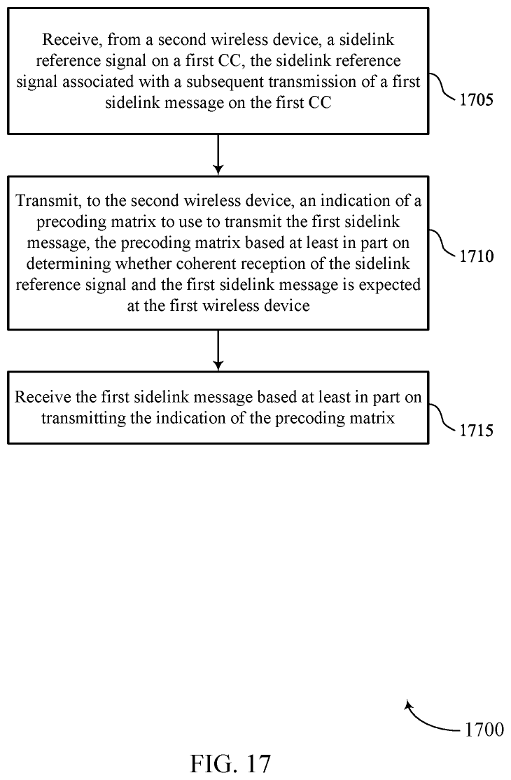

FIG. 17 shows a flowchart illustrating a method 1700 that supports sidelink coherency management in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1705, the method may include receiving, from a second wireless device, a sidelink reference signal on a first CC, the sidelink reference signal associated with a subsequent transmission of a first sidelink message on the first CC. The operations of 1705 may be performed in accordance with examples as disclosed herein. In some examples, aspects of the operations of 1705 may be performed by a reference signal component 1025 as described with reference to FIG. 10.

At 1710, the method may include transmitting, to the second wireless device, an indication of a precoding matrix (e.g., a PMI) to use to transmit the first sidelink message, the precoding matrix based on determining whether coherent reception of the sidelink reference signal and the first sidelink message is expected at the first wireless device. The operations of 1710 may be performed in accordance with examples as disclosed herein. In some examples, aspects of the operations of 1710 may be performed by a precoding component 1045 as described with reference to FIG. 10.

At 1715, the method may include receiving the first sidelink message based on transmitting the indication of the precoding matrix (e.g., the PMI). The operations of 1715 may be performed in accordance with examples as disclosed herein. In some examples, aspects of the operations of 1715 may be performed by a coherency component 1035 as described with reference to FIG. 10.

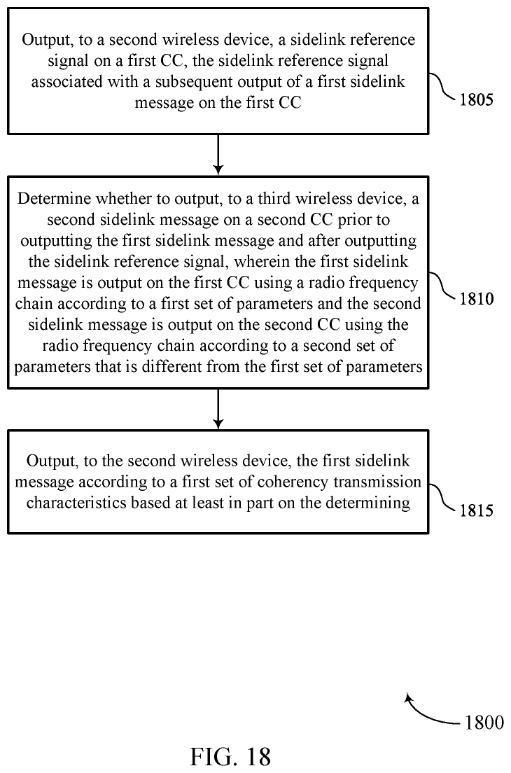

FIG. 18 shows a flowchart illustrating a method 1800 that supports sidelink coherency management in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1805, the method may include outputting, to a second wireless device, a sidelink reference signal on a first CC, the sidelink reference signal associated with a subsequent output of a first sidelink message on the first CC. The operations of 1805 may be performed in accordance with examples as disclosed herein. In some examples, aspects of the operations of 1805 may be performed by a reference signal component 1025 as described with reference to FIG. 10.

At 1810, the method may include determining whether to output, to a third wireless device, a second sidelink message on a second CC prior to outputting the first sidelink message and after outputting the sidelink reference signal, where the first sidelink message is output on the first CC using a radio frequency chain according to a first set of parameters and the second sidelink message is output on the second CC using the radio frequency chain according to a second set of parameters that is different from the first set of parameters. The operations of 1810 may be performed in accordance with examples as disclosed herein. In some examples, aspects of the operations of 1815 may be performed by a communication component 1040 as described with reference to FIG. 10.

At 1815, the method may include outputting, to the second wireless device, the first sidelink message according to a first set of coherency transmission characteristics based on the determining. The operations of 1815 may be performed in accordance with examples as disclosed herein. In some examples, aspects of the operations of 1815 may be performed by a coherency component 1035 as described with reference to FIG. 10.

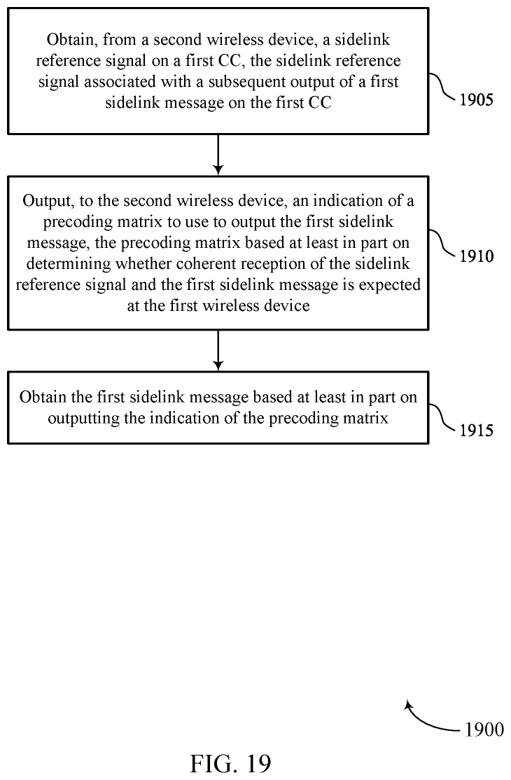

FIG. 19 shows a flowchart illustrating a method 1900 that supports sidelink coherency management in accordance with aspects of the present disclosure. The operations of the method 1900 may be implemented by a UE or its components as described herein. For example, the operations of the method 1900 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1905, the method may include obtaining, from a second wireless device, a sidelink reference signal on a first CC, the sidelink reference signal associated with a subsequent transmission of a first sidelink message on the first CC. The operations of 1905 may be performed in accordance with examples as disclosed herein. In some examples, aspects of the operations of 1905 may be performed by a reference signal component 1025 as described with reference to FIG. 10.

At 1910, the method may include outputting, to the second wireless device, an indication of a precoding matrix (e.g., a PMI) to use to transmit the first sidelink message, the precoding matrix based on determining whether coherent reception of the sidelink reference signal and the first sidelink message is expected at the first wireless device. The operations of 1910 may be performed in accordance with examples as disclosed herein. In some examples, aspects of the operations of 1910 may be performed by a precoding component 1045 as described with reference to FIG. 10.

At 1915, the method may include obtaining the first sidelink message based on outputting the indication of the precoding matrix (e.g., the PMI). The operations of 1915 may be performed in accordance with examples as disclosed herein. In some examples, aspects of the operations of 1915 may be performed by a coherency component 1035 as described with reference to FIG. 10.

The following provides an overview of aspects of the present disclosure:

Aspect 1: A method for wireless communications at a first wireless device, comprising: communicating, with a second wireless device, a sidelink reference signal on a first active BWP, the sidelink reference signal associated with a subsequent communication of a sidelink message on the first active BWP; determining whether a switch to a second active BWP occurs prior to communicating the sidelink message and after communicating the sidelink reference signal; and communicating the sidelink message on the first active BWP according to a first set of coherency transmission characteristics based at least in part on the determining.

Aspect 2: The method of aspect 1, wherein communicating the sidelink message comprises: communicating, based at least in part on determining that the switch fails to occur, the sidelink message according to the first set of coherency transmission characteristics such that a relative difference between first communication characteristics associated with communicating the sidelink reference signal and second communication characteristics associated with communicating the sidelink message satisfies a threshold relative difference.

Aspect 3: The method of aspect 1, wherein communicating the sidelink message comprises: communicating, based at least in part on determining that the switch occurs, the sidelink message according to the first set of coherency transmission characteristics such that a relative difference between first communication characteristics associated with communicating the sidelink reference signal and second communication characteristics associated with communicating the sidelink message fails to satisfy a threshold relative difference.

Aspect 4: The method of any of aspects 1 through 3, wherein first communication characteristics associated with communicating the sidelink reference signal comprise a phase associated with communicating the sidelink reference signal, a transmission power associated with communicating the sidelink reference signal, a time at which the sidelink reference signal is communicated, or a combination thereof; and second communication characteristics associated with communicating the sidelink message comprise a phase associated with communicating the sidelink message, a transmission power associated with communicating the sidelink message, a time at which the sidelink message is communicated, or a combination thereof.

Aspect 5: The method of any of aspects 1 through 4, further comprising: communicating, based at least in part on determining whether the switch occurs, an indication of whether a relative difference between first communication characteristics associated with communicating the sidelink reference signal and second communication characteristics associated with communicating the sidelink message satisfies a threshold relative difference.

Aspect 6: The method of any of aspects 1 through 5, further comprising: outputting, prior to communicating the sidelink message, an uplink message to a network entity on the second active BWP, wherein determining whether the switch occurs is based at least in part on outputting the uplink message.

Aspect 7: The method of any of aspects 1 through 6, further comprising: outputting an indication of a capability to maintain coherency between uplink transmissions when switching between active BWPs associated with uplink transmissions to a network entity, wherein communicating the sidelink message is based at least in part on outputting the indication of the capability.

Aspect 8: The method of aspect 7, further comprising: switching to the second active BWP to output a second sidelink message prior to communicating the sidelink message; outputting, to the second wireless device, the sidelink reference signal having first transmission characteristics; and outputting, to the second wireless device, the sidelink message having second transmission characteristics such that a relative difference between the first transmission characteristics and the second transmission characteristics satisfies a threshold relative difference based at least in part on the capability.

Aspect 9: The method of any of aspects 7 through 8, wherein the capability is associated with a particular frequency band or a combination of two or more frequency bands.

Aspect 10: The method of any of aspects 1 through 9, wherein determining whether the switch occurs comprises: determining whether a switch from a third active BWP to the second active BWP occurs prior to communicating the sidelink message, the first active BWP associated with a first CC, the second active BWP and the third active BWP associated with a second CC that is switched together with the first CC.

Aspect 11: The method of aspect 10, wherein the second CC is communicated using a same radio frequency chain that is used to communicate the first CC.

Aspect 12: The method of any of aspects 1 through 11, wherein determining whether the switch occurs comprises: determining that the second wireless device switches to the second active BWP prior to communicating the sidelink message, the method comprising: outputting, to the second wireless device and prior to communicating the sidelink message, an indication of a precoding matrix, a spatial transmission beam, an antenna group, or a combination thereof, to use to output the sidelink message based at least in part on determining that the second wireless device switches to the second active BWP; and obtaining, from the second wireless device, the sidelink message based at least in part on outputting the indication of the precoding matrix, the spatial transmission beam, the antenna group, or the combination thereof.

Aspect 13: The method of any of aspects 1 through 6 and 10 through 11, wherein determining whether the switch occurs comprises: determining that the second wireless device fails to switch to the second active BWP prior to communicating the sidelink message, the method comprising: obtaining, from the second wireless device, the sidelink message according to the first set of coherency transmission characteristics based at least in part on determining that the second wireless device fails to switch to the second active BWP.

Aspect 14: The method of any of aspects 1 through 13, wherein the first active BWP is an active BWP associated with communicating sidelink messages and the second active BWP is an active BWP associated with outputting uplink messages to a network entity.

Aspect 15: The method of any of aspects 1 through 13, wherein the first active BWP and the second active BWP are active BWPs associated with communicating sidelink messages.

Aspect 16: A method for wireless communications at a first wireless device, comprising: communicating, with a second wireless device, a sidelink reference signal on a first active BWP, the sidelink reference signal associated with a subsequent communication of a sidelink message on the first active BWP; determining whether a switch between a first duplex mode and a second duplex mode occurs prior to or concurrent with communicating the sidelink message and after communicating the sidelink reference signal; and communicating the sidelink message on the first active BWP according to a first set of coherency transmission characteristics based at least in part on the determining.

Aspect 17: The method of aspect 16, wherein communicating the sidelink message comprises: communicating, based at least in part on determining that the switch fails to occur, the sidelink message according to the first set of coherency transmission characteristics such that a relative difference between first communication characteristics associated with communicating the sidelink reference signal and second communication characteristics associated with communicating the sidelink message satisfies a threshold relative difference.

Aspect 18: The method of aspect 16, wherein communicating the sidelink message comprises: communicating, based at least in part on determining that the switch occurs, the sidelink message according to the first set of coherency transmission characteristics such that a relative difference between first communication characteristics associated with communicating the sidelink reference signal and second communication characteristics associated with communicating the sidelink message fails to satisfy a threshold relative difference.

Aspect 19: The method of any of aspects 16 through 18, wherein first communication characteristics associated with communicating the sidelink reference signal comprise a phase associated with communicating the sidelink reference signal, a transmission power associated with communicating the sidelink reference signal, a time at which the sidelink reference signal is communicated, or a combination thereof; and second communication characteristics associated with communicating the sidelink message comprise a phase associated with communicating the sidelink message, a transmission power associated with communicating the sidelink message, a time at which the sidelink message is communicated, or a combination thereof.

Aspect 20: The method of any of aspects 16 through 19, wherein the first duplex mode is a full-duplex mode and the second duplex mode is a half-duplex mode.

Aspect 21: The method of any of aspects 16 through 19, wherein the first duplex mode is a first full-duplex mode and the second duplex mode is a second full-duplex mode, the first full-duplex mode associated with a first uplink bandwidth, a first downlink bandwidth, or a combination thereof, the second full-duplex mode associated with a second uplink bandwidth different from the first uplink bandwidth, a second downlink bandwidth different from the second downlink bandwidth, or a combination thereof.

Aspect 22: The method of any of aspects 16 through 21, further comprising: outputting the sidelink reference signal while operating in the first duplex mode; and outputting, prior to communicating the sidelink message and after outputting the sidelink reference signal, a second sidelink message while operating in the second duplex mode, wherein determining whether the switch occurs is based at least in part on outputting the sidelink reference signal while operating in the first duplex mode and outputting the second sidelink message while operating in the second duplex mode.

Aspect 23: The method of any of aspects 16 through 21, further comprising: outputting the sidelink reference signal while operating in the first duplex mode; and outputting the sidelink message while operating in the second duplex mode, wherein determining whether the switch occurs is based at least in part on outputting the sidelink reference signal while operating in the first duplex mode and outputting the sidelink message while operating in the second duplex mode.

Aspect 24: The method of any of aspects 16 through 23, wherein determining whether the switch occurs comprises: determining that the second wireless device switches between the first duplex mode and the second duplex mode prior to communicating the sidelink message and after communicating the sidelink reference signal, the method comprising: outputting, to the second wireless device and prior to communicating the sidelink message, an indication of a precoding matrix, a spatial transmission beam, an antenna group, or a combination thereof, to use to output the sidelink message based at least in part on determining that the second wireless device switches between the first duplex mode and the second duplex mode; and obtaining, from the second wireless device, the sidelink message based at least in part on outputting the indication of the precoding matrix, the spatial transmission beam, the antenna group, or the combination thereof.

Aspect 25: A method for wireless communications at a first wireless device, comprising: outputting, to a second wireless device, a sidelink reference signal on a first CC, the sidelink reference signal associated with a subsequent output of a first sidelink message on the first CC; determining whether to output, to a third wireless device, a second sidelink message on a second CC prior to outputting the first sidelink message and after outputting the sidelink reference signal, wherein the first sidelink message is output on the first CC using a radio frequency chain according to a first set of parameters and the second sidelink message is output on the second CC using the radio frequency chain according to a second set of parameters that is different from the first set of parameters; and outputting, to the second wireless device, the first sidelink message according to a first set of coherency transmission characteristics based at least in part on the determining.

Aspect 26: The method of aspect 25, wherein outputting the first sidelink message comprises: outputting, based at least in part on failing to output the second sidelink message, the first sidelink message according to the first set of coherency transmission characteristics such that a relative difference between first transmission characteristics associated with outputting the sidelink reference signal and second transmission characteristics associated with outputting the first sidelink message satisfies a threshold relative difference.

Aspect 27: The method of aspect 25, further comprising: outputting the second sidelink message on the second CC, the outputting the first sidelink message comprising: outputting, based at least in part on outputting the second sidelink message, the first sidelink message according to the first set of coherency transmission characteristics such that a relative difference between first transmission characteristics associated with outputting the sidelink reference signal and second transmission characteristics associated with outputting the first sidelink message fails to satisfy a threshold relative difference.

Aspect 28: The method of any of aspects 25 through 27, wherein: first transmission characteristics associated with transmitting the sidelink reference signal comprise a phase associated with transmitting the sidelink reference signal, a transmission power for transmitting the sidelink reference signal, a time at which the sidelink reference signal is transmitted, or a combination thereof; and second transmission characteristics associated with transmitting the first sidelink message comprise a phase associated with transmitting the first sidelink message, a transmission power for transmitting the first sidelink message, a time at which the first sidelink message is transmitted, or a combination thereof.

Aspect 29: The method of any of aspects 25 through 28, further comprising: obtaining an indication of a precoding matrix, a spatial transmission beam, an antenna group, or a combination thereof, to use to output the first sidelink message based at least in part on the determining, wherein outputting the first sidelink message comprises outputting the first sidelink message according to the indicated precoding matrix, spatial transmission beam, antenna group, or combination thereof.

Aspect 30: A method for wireless communication at a first wireless device, comprising: obtaining, from a second wireless device, a sidelink reference signal on a first CC, the sidelink reference signal associated with a subsequent output of a first sidelink message on the first CC; outputting, to the second wireless device, an indication of a precoding matrix to use to output the first sidelink message, the precoding matrix based at least in part determining whether coherent reception of the sidelink reference signal and the first sidelink message is expected at the first wireless device; and obtaining the first sidelink message based at least in part on outputting the indication of the precoding matrix.

Aspect 31: The method of aspect 30, further comprising: determining whether coherent reception of the sidelink reference signal and the first sidelink message is expected at the first wireless device based at least in part on obtaining an indication from the second wireless device that the second wireless device will coherently output the first sidelink message.

Aspect 32: The method of any of aspects 30 through 31, further comprising: determining whether coherent reception of the sidelink reference signal and the first sidelink message is expected at the first wireless device based at least in part on decoding sidelink control information output by the first wireless device to determine whether the first wireless device outputs a second sidelink message on a second CC prior to outputting the first sidelink message and after outputting the sidelink reference signal.

Aspect 33: The method of any of aspects 30 and 32, further comprising: selecting the precoding matrix based at least in part on determining that coherent reception of the sidelink reference signal and the first sidelink message is not expected, wherein the selected precoding matrix is associated with non-coherent transmission of the sidelink reference signal and the first sidelink message.

Aspect 34: The method of any of aspects 30 through 32, further comprising: selecting the precoding matrix based at least in part on determining that coherent reception of the sidelink reference signal and the first sidelink message is expected, wherein the selected precoding matrix is associated with coherent transmission of the sidelink reference signal and the first sidelink message.

Aspect 35: An apparatus for wireless communications at a first wireless device, comprising a processor; and memory coupled with the processor, the processor configured to perform a method of any of aspects 1 through 15.

Aspect 36: An apparatus for wireless communications at a first wireless device, comprising at least one means for performing a method of any of aspects 1 through 15.

Aspect 37: A non-transitory computer-readable medium storing code for wireless communications at a first wireless device, the code comprising instructions executable by a processor to perform a method of any of aspects 1 through 15.

Aspect 38: An apparatus for wireless communications at a first wireless device, comprising a processor; and memory coupled with the processor, the processor configured to perform a method of any of aspects 16 through 24.

Aspect 39: An apparatus for wireless communications at a first wireless device, comprising at least one means for performing a method of any of aspects 16 through 24.

Aspect 40: A non-transitory computer-readable medium storing code for wireless communications at a first wireless device, the code comprising instructions executable by a processor to perform a method of any of aspects 16 through 24.

Aspect 41: An apparatus for wireless communications at a first wireless device, comprising a processor; and memory coupled with the processor, the processor configured to perform a method of any of aspects 25 through 29.

Aspect 42: An apparatus for wireless communications at a first wireless device, comprising at least one means for performing a method of any of aspects 25 through 29.

Aspect 43: A non-transitory computer-readable medium storing code for wireless communications at a first wireless device, the code comprising instructions executable by a processor to perform a method of any of aspects 25 through 29.

Aspect 44: An apparatus for wireless communication at a first wireless device, comprising a processor; and memory coupled with the processor, the processor configured to perform a method of any of aspects 30 through 34.

Aspect 45: An apparatus for wireless communication at a first wireless device, comprising at least one means for performing a method of any of aspects 30 through 34.

Aspect 46: A non-transitory computer-readable medium storing code for wireless communication at a first wireless device, the code comprising instructions executable by a processor to perform a method of any of aspects 30 through 34.

Aspect 47: A method for wireless communications at a first wireless device, comprising: communicating, with a second wireless device, a sidelink reference signal on a first CC, the sidelink reference signal associated with a subsequent communication of a sidelink message on the first CC; determining whether a switch to a second CC occurs prior to communicating the sidelink message and after communicating the sidelink reference signal; and communicating the sidelink message on the first CC according to a first set of coherency transmission characteristics based at least in part on the determining.

Aspect 48: The method of aspect 47, wherein communicating the sidelink message comprises: communicating, based at least in part on determining that the switch fails to occur, the sidelink message according to the first set of coherency transmission characteristics such that a relative difference between first communication characteristics associated with communicating the sidelink reference signal and second communication characteristics associated with communicating the sidelink message satisfies a threshold relative difference.

Aspect 49: The method of aspect 47, wherein communicating the sidelink message comprises: communicating, based at least in part on determining that the switch occurs, the sidelink message according to the first set of coherency transmission characteristics such that a relative difference between first communication characteristics associated with communicating the sidelink reference signal and second communication characteristics associated with communicating the sidelink message fails to satisfy a threshold relative difference.

Aspect 50: The method of any of aspects 47 through 49, wherein first communication characteristics associated with communicating the sidelink reference signal comprise a phase associated with communicating the sidelink reference signal, a transmission power associated with communicating the sidelink reference signal, a time at which the sidelink reference signal is communicated, or a combination thereof; and second communication characteristics associated with communicating the sidelink message comprise a phase associated with communicating the sidelink message, a transmission power associated with communicating the sidelink message, a time at which the sidelink message is communicated, or a combination thereof.

Aspect 51: The method of any of aspects 47 through 50, further comprising: communicating, based at least in part on determining whether the switch occurs, an indication of whether a relative difference between first communication characteristics associated with communicating the sidelink reference signal and second communication characteristics associated with communicating the sidelink message satisfies a threshold relative difference.

Aspect 52: The method of any of aspects 47 through 51, further comprising: outputting, prior to communicating the sidelink message, an uplink message to a network entity on the second CC, wherein determining whether the switch occurs is based at least in part on outputting the uplink message.

Aspect 53: The method of any of aspects 47 through 52, further comprising: outputting an indication of a capability to maintain coherency between uplink transmissions when switching between CCs associated with uplink transmissions to a network entity, wherein communicating the sidelink message is based at least in part on outputting the indication of the capability.

Aspect 54: The method of aspect 53, further comprising: switching to the second CC to output a second sidelink message prior to communicating the sidelink message; outputting, to the second wireless device, the sidelink reference signal having first transmission characteristics; and outputting, to the second wireless device, the sidelink message having second transmission characteristics such that a relative difference between the first transmission characteristics and the second transmission characteristics satisfies a threshold relative difference based at least in part on the capability.

Aspect 55: The method of any of aspects 53 through 54, wherein the capability is associated with a particular frequency band or a combination of two or more frequency bands.

Aspect 56: The method of aspect 47, wherein the second CC is communicated using a same radio frequency chain that is used to communicate the first CC.

Aspect 57: The method of any of aspects 47 through 56, wherein determining whether the switch occurs comprises: determining that the second wireless device switches to the CC prior to communicating the sidelink message, the method comprising: outputting, to the second wireless device and prior to communicating the sidelink message, an indication of a precoding matrix, a spatial transmission beam, an antenna group, or a combination thereof, to use to output the sidelink message based at least in part on determining that the second wireless device switches to the second CC; and obtaining, from the second wireless device, the sidelink message based at least in part on outputting the indication of the precoding matrix, the spatial transmission beam, the antenna group, or the combination thereof.

Aspect 58: The method of any of aspects 47 through 52 and 56, wherein determining whether the switch occurs comprises: determining that the second wireless device fails to switch to the second CC prior to communicating the sidelink message, the method comprising: obtaining, from the second wireless device, the sidelink message according to the first set of coherency transmission characteristics based at least in part on determining that the second wireless device fails to switch to the second CC.

Aspect 59: A method for wireless communications at a first wireless device, comprising: communicating, with a second wireless device, a sidelink reference signal on a first CC, the sidelink reference signal associated with a subsequent communication of a sidelink message on the first CC; determining whether a switch between a first duplex mode and a second duplex mode occurs prior to or concurrent with communicating the sidelink message and after communicating the sidelink reference signal; and communicating the sidelink message on the first CC according to a first set of coherency transmission characteristics based at least in part on the determining.

Aspect 60: The method of aspect 59, wherein communicating the sidelink message comprises: communicating, based at least in part on determining that the switch fails to occur, the sidelink message according to the first set of coherency transmission characteristics such that a relative difference between first communication characteristics associated with communicating the sidelink reference signal and second communication characteristics associated with communicating the sidelink message satisfies a threshold relative difference.

Aspect 61: The method of aspect 59, wherein communicating the sidelink message comprises: communicating, based at least in part on determining that the switch occurs, the sidelink message according to the first set of coherency transmission characteristics such that a relative difference between first communication characteristics associated with communicating the sidelink reference signal and second communication characteristics associated with communicating the sidelink message fails to satisfy a threshold relative difference.

Aspect 62: The method of any of aspects 59 through 61, wherein first communication characteristics associated with communicating the sidelink reference signal comprise a phase associated with communicating the sidelink reference signal, a transmission power associated with communicating the sidelink reference signal, a time at which the sidelink reference signal is communicated, or a combination thereof; and second communication characteristics associated with communicating the sidelink message comprise a phase associated with communicating the sidelink message, a transmission power associated with communicating the sidelink message, a time at which the sidelink message is communicated, or a combination thereof.

Aspect 63: The method of any of aspects 59 through 62, wherein the first duplex mode is a full-duplex mode and the second duplex mode is a half-duplex mode.

Aspect 64: The method of any of aspects 59 through 62, wherein the first duplex mode is a first full-duplex mode and the second duplex mode is a second full-duplex mode, the first full-duplex mode associated with a first uplink bandwidth, a first downlink bandwidth, or a combination thereof, the second full-duplex mode associated with a second uplink bandwidth different from the first uplink bandwidth, a second downlink bandwidth different from the second downlink bandwidth, or a combination thereof.

Aspect 65: The method of any of aspects 59 through 64, further comprising: outputting the sidelink reference signal while operating in the first duplex mode; and outputting, prior to communicating the sidelink message and after outputting the sidelink reference signal, a second sidelink message while operating in the second duplex mode, wherein determining whether the switch occurs is based at least in part on outputting the sidelink reference signal while operating in the first duplex mode and outputting the second sidelink message while operating in the second duplex mode.

Aspect 66: The method of any of aspects 59 through 64, further comprising: outputting the sidelink reference signal while operating in the first duplex mode; and outputting the sidelink message while operating in the second duplex mode, wherein determining whether the switch occurs is based at least in part on outputting the sidelink reference signal while operating in the first duplex mode and outputting the sidelink message while operating in the second duplex mode.

Aspect 67: The method of any of aspects 59 through 66, wherein determining whether the switch occurs comprises: determining that the second wireless device switches between the first duplex mode and the second duplex mode prior to communicating the sidelink message and after communicating the sidelink reference signal, the method comprising: outputting, to the second wireless device and prior to communicating the sidelink message, an indication of a precoding matrix, a spatial transmission beam, an antenna group, or a combination thereof, to use to output the sidelink message based at least in part on determining that the second wireless device switches between the first duplex mode and the second duplex mode; and obtaining, from the second wireless device, the sidelink message based at least in part on outputting the indication of the precoding matrix, the spatial transmission beam, the antenna group, or the combination thereof.

Aspect 68: An apparatus for wireless communications at a first wireless device, comprising a processor; and memory coupled with the processor, the processor configured to perform a method of any of aspects 47 through 58.

Aspect 69: An apparatus for wireless communications at a first wireless device, comprising at least one means for performing a method of any of aspects 47 through 58.

Aspect 70: A non-transitory computer-readable medium storing code for wireless communications at a first wireless device, the code comprising instructions executable by a processor to perform a method of any of aspects 47 through 58.

Aspect 71: An apparatus for wireless communications at a first wireless device, comprising a processor; and memory coupled with the processor, the processor configured to perform a method of any of aspects 59 through 67.

Aspect 72: An apparatus for wireless communications at a first wireless device, comprising at least one means for performing a method of any of aspects 59 through 67.

Aspect 73: A non-transitory computer-readable medium storing code for wireless communications at a first wireless device, the code comprising instructions executable by a processor to perform a method of any of aspects 59 through 67.

Aspect 74: A method for wireless communications at a first wireless device, comprising: communicating, with a second wireless device, a sidelink reference signal on a first active BWP, the sidelink reference signal associated with a subsequent communication of a sidelink message on the first active BWP; determining whether a switch to a second active BWP occurs prior to communicating the sidelink message and after communicating the sidelink reference signal; and communicating the sidelink message on the first active BWP according to a first set of coherency transmission characteristics based at least in part on the determining.

Aspect 75: The method of aspect 74, the communicating the sidelink message comprising: communicating, based at least in part on determining that the switch fails to occur, the sidelink message according to the first set of coherency transmission characteristics such that a relative difference between first communication characteristics associated with communicating the sidelink reference signal and second communication characteristics associated with communicating the sidelink message satisfies a threshold relative difference.

Aspect 76: The method of aspect 74, the communicating the sidelink message comprising: communicating, based at least in part on determining that the switch occurs, the sidelink message according to the first set of coherency transmission characteristics such that a relative difference between first communication characteristics associated with communicating the sidelink reference signal and second communication characteristics associated with communicating the sidelink message fails to satisfy a threshold relative difference.

Aspect 77: The method of any of aspects 74 through 76, wherein first communication characteristics associated with communicating the sidelink reference signal comprise a phase associated with communicating the sidelink reference signal, a transmission power associated with communicating the sidelink reference signal, a time at which the sidelink reference signal is communicated, or a combination thereof; and second communication characteristics associated with communicating the sidelink message comprise a phase associated with communicating the sidelink message, a transmission power associated with communicating the sidelink message, a time at which the sidelink message is communicated, or a combination thereof.

Aspect 78: The method of any of aspects 74 through 77, further comprising: communicating, based at least in part on determining whether the switch occurs, an indication of whether a relative difference between first communication characteristics associated with communicating the sidelink reference signal and second communication characteristics associated with communicating the sidelink message satisfies a threshold relative difference.

Aspect 79: The method of any of aspects 74 through 78, further comprising: transmitting, prior to communicating the sidelink message, an uplink message to a base station on the second active BWP, wherein determining whether the switch occurs is based at least in part on transmitting the uplink message.

Aspect 80: The method of any of aspects 74 through 79, further comprising: transmitting an indication of a capability to maintain coherency between uplink transmissions when switching between active BWPs associated with uplink transmissions to a base station, wherein communicating the sidelink message is based at least in part on transmitting the indication of the capability.

Aspect 81: The method of aspect 80, further comprising: switching to the second active BWP to transmit a second sidelink message prior to communicating the sidelink message, the method comprising: transmitting, to the second wireless device, the sidelink reference signal having first transmission characteristics; and transmitting, to the second wireless device, the sidelink message having second transmission characteristics such that a relative difference between the first transmission characteristics and the second transmission characteristics satisfies a threshold relative difference based at least in part on the capability.

Aspect 82: The method of any of aspects 80 through 81, wherein the capability is associated with a particular frequency band or a combination of two or more frequency bands.

Aspect 83: The method of any of aspects 74 through 82, the determining whether the switch occurs comprising: determining whether a switch from a third active BWP to the second active BWP occurs prior to communicating the sidelink message, the first active BWP associated with a first CC, the second active BWP and the third active BWP associated with a second CC that is switched together with the first CC.

Aspect 84: The method of aspect 83, wherein the second CC is communicated using a same radio frequency chain that is used to communicate the first CC.

Aspect 85: The method of any of aspects 74 through 84, the determining whether the switch occurs comprising: determining that the second wireless device switches to the second active BWP prior to communicating the sidelink message, the method comprising: transmitting, to the second wireless device and prior to communicating the sidelink message, an indication of a precoding matrix, a spatial transmission beam, an antenna group, or a combination thereof, to use to transmit the sidelink message based at least in part on determining that the second wireless device switches to the second active BWP; and receiving, from the second wireless device, the sidelink message based at least in part on transmitting the indication of the precoding matrix, the spatial transmission beam, the antenna group, or the combination thereof.

Aspect 86: The method of any of aspects 74 through 84, the determining whether the switch occurs comprising: determining that the second wireless device fails to switch to the second active BWP prior to communicating the sidelink message, the method comprising: receiving, from the second wireless device, the sidelink message according to the first set of coherency transmission characteristics based at least in part on determining that the second wireless device fails to switch to the second active BWP.

Aspect 87: The method of any of aspects 74 through 86, wherein the first active BWP is an active BWP associated with communicating sidelink messages and the second active BWP is an active BWP associated with transmitting uplink messages to a base station.

Aspect 88: The method of any of aspects 74 through 86, wherein the first active BWP and the second active BWP are active BWPs associated with communicating sidelink messages.

Aspect 89: A method for wireless communications at a first wireless device, comprising: communicating, with a second wireless device, a sidelink reference signal on a first active BWP, the sidelink reference signal associated with a subsequent communication of a sidelink message on the first active BWP; determining whether a switch between a first duplex mode and a second duplex mode occurs prior to or concurrent with communicating the sidelink message and after communicating the sidelink reference signal; and communicating the sidelink message on the first active BWP according to a first set of coherency transmission characteristics based at least in part on the determining.

Aspect 90: The method of aspect 89, the communicating the sidelink message comprising: communicating, based at least in part on determining that the switch fails to occur, the sidelink message according to the first set of coherency transmission characteristics such that a relative difference between first communication characteristics associated with communicating the sidelink reference signal and second communication characteristics associated with communicating the sidelink message satisfies a threshold relative difference.

Aspect 91: The method of aspect 89, the communicating the sidelink message comprising: communicating, based at least in part on determining that the switch occurs, the sidelink message according to the first set of coherency transmission characteristics such that a relative difference between first communication characteristics associated with communicating the sidelink reference signal and second communication characteristics associated with communicating the sidelink message fails to satisfy a threshold relative difference.

Aspect 92: The method of any of aspects 89 through 91, wherein: first communication characteristics associated with communicating the sidelink reference signal comprise a phase associated with communicating the sidelink reference signal, a transmission power associated with communicating the sidelink reference signal, a time at which the sidelink reference signal is communicated, or a combination thereof; and second communication characteristics associated with communicating the sidelink message comprise a phase associated with communicating the sidelink message, a transmission power associated with communicating the sidelink message, a time at which the sidelink message is communicated, or a combination thereof.

Aspect 93: The method of any of aspects 89 through 92, wherein the first duplex mode is a full-duplex mode and the second duplex mode is a half-duplex mode.

Aspect 94: The method of any of aspects 89 through 92, wherein the first duplex mode is a first full-duplex mode and the second duplex mode is a second full-duplex mode, the first full-duplex mode associated with a first uplink bandwidth, a first downlink bandwidth, or a combination thereof, the second full-duplex mode associated with a second uplink bandwidth different from the first uplink bandwidth, a second downlink bandwidth different from the second downlink bandwidth, or a combination thereof.

Aspect 95: The method of any of aspects 89 through 94, further comprising: transmitting the sidelink reference signal while operating in the first duplex mode; and transmitting, prior to communicating the sidelink message and after transmitting the sidelink reference signal, a second sidelink message while operating in the second duplex mode, wherein determining whether the switch occurs is based at least in part on transmitting the sidelink reference signal while operating in the first duplex mode and transmitting the second sidelink message while operating in the second duplex mode.

Aspect 96: The method of any of aspects 89 through 94, further comprising: transmitting the sidelink reference signal while operating in the first duplex mode; and transmitting the sidelink message while operating in the second duplex mode, wherein determining whether the switch occurs is based at least in part on transmitting the sidelink reference signal while operating in the first duplex mode and transmitting the sidelink message while operating in the second duplex mode.

Aspect 97: The method of any of aspects 89 through 96, the determining whether the switch occurs comprising: determining that the second wireless device switches between the first duplex mode and the second duplex mode prior to communicating the sidelink message and after communicating the sidelink reference signal, the method comprising: transmitting, to the second wireless device and prior to communicating the sidelink message, an indication of a precoding matrix, a spatial transmission beam, an antenna group, or a combination thereof, to use to transmit the sidelink message based at least in part on determining that the second wireless device switches between the first duplex mode and the second duplex mode; and receiving, from the second wireless device, the sidelink message based at least in part on transmitting the indication of the precoding matrix, the spatial transmission beam, the antenna group, or the combination thereof.

Aspect 98: A method for wireless communications at a first wireless device, comprising: transmitting, to a second wireless device, a sidelink reference signal on a first CC, the sidelink reference signal associated with a subsequent transmission of a first sidelink message on the first CC; determining whether to transmit, to a third wireless device, a second sidelink message on a second CC prior to transmitting the first sidelink message and after transmitting the sidelink reference signal, wherein the first sidelink message is transmitted on the first CC using a radio frequency chain according to a first set of parameters and the second sidelink message is transmitted on the second CC using the radio frequency chain according to a second set of parameters that is different from the first set of parameters; and transmitting, to the second wireless device, the first sidelink message according to a first set of coherency transmission characteristics based at least in part on the determining.

Aspect 99: The method of aspect 98, the transmitting the first sidelink message comprising: transmitting, based at least in part on failing to transmit the second sidelink message, the first sidelink message according to the first set of coherency transmission characteristics such that a relative difference between first transmission characteristics associated with transmitting the sidelink reference signal and second transmission characteristics associated with transmitting the first sidelink message satisfies a threshold relative difference.

Aspect 100: The method of aspect 98, further comprising: transmitting the second sidelink message on the second CC, the transmitting the first sidelink message comprising: transmitting, based at least in part on transmitting the second sidelink message, the first sidelink message according to the first set of coherency transmission characteristics such that a relative difference between first transmission characteristics associated with transmitting the sidelink reference signal and second transmission characteristics associated with transmitting the first sidelink message fails to satisfy a threshold relative difference.

Aspect 101: The method of any of aspects 98 through 100, wherein: first transmission characteristics associated with transmitting the sidelink reference signal comprise a phase associated with transmitting the sidelink reference signal, a transmission power for transmitting the sidelink reference signal, a time at which the sidelink reference signal is transmitted, or a combination thereof; and second transmission characteristics associated with transmitting the first sidelink message comprise a phase associated with transmitting the first sidelink message, a transmission power for transmitting the first sidelink message, a time at which the first sidelink message is transmitted, or a combination thereof.

Aspect 102: The method of any of aspects 98 through 101, further comprising: receiving an indication of a precoding matrix, a spatial transmission beam, an antenna group, or a combination thereof, to use to transmit the first sidelink message based at least in part on the determining, wherein transmitting the first sidelink message comprises transmitting the first sidelink message according to the indicated precoding matrix, spatial transmission beam, antenna group, or combination thereof.

Aspect 103: A method for wireless communication at a first wireless device, comprising: receiving, from a second wireless device, a sidelink reference signal on a first CC, the sidelink reference signal associated with a subsequent transmission of a first sidelink message on the first CC; transmitting, to the second wireless device, an indication of a precoding matrix to use to transmit the first sidelink message, the precoding matrix based at least in part on determining whether coherent reception of the sidelink reference signal and the first sidelink message is expected at the first wireless device; and receiving the first sidelink message based at least in part on transmitting the indication of the precoding matrix.

Aspect 104: The method of aspect 103, further comprising: determining whether coherent reception of the sidelink reference signal and the first sidelink message is expected at the first wireless device based at least in part on receiving an indication from the second wireless device that the second wireless device will coherently transmit the first sidelink message.

Aspect 105: The method of any of aspects 103 through 104, further comprising: determining whether coherent reception of the sidelink reference signal and the first sidelink message is expected at the first wireless device based at least in part on decoding sidelink control information transmitted by the first wireless device to determine whether the first wireless device transmits a second sidelink message on a second component carrier prior to transmitting the first sidelink message and after transmitting the sidelink reference signal.

Aspect 106: The method of aspect 103, further comprising: selecting the precoding matrix based at least in part on determining that coherent reception of the sidelink reference signal and the first sidelink message is not expected, wherein the selected precoding matrix is associated with non-coherent transmission of the sidelink reference signal and the first sidelink message.

Aspect 107: The method of aspect 103, further comprising: selecting the precoding matrix based at least in part on determining that coherent reception of the sidelink reference signal and the first sidelink message is expected, wherein the selected precoding matrix is associated with coherent transmission of the sidelink reference signal and the first sidelink message.

Aspect 108: An apparatus for wireless communications at a first wireless device, comprising a processor; memory coupled with the processor; and instructions stored in the memory and executable by the processor to cause the apparatus to perform a method of any of aspects 74 through 88.

Aspect 109: An apparatus for wireless communications at a first wireless device, comprising at least one means for performing a method of any of aspects 74 through 88.

Aspect 110: A non-transitory computer-readable medium storing code for wireless communications at a first wireless device, the code comprising instructions executable by a processor to perform a method of any of aspects 74 through 88.

Aspect 111: An apparatus for wireless communications at a first wireless device, comprising a processor; memory coupled with the processor; and instructions stored in the memory and executable by the processor to cause the apparatus to perform a method of any of aspects 89 through 97.

Aspect 112: An apparatus for wireless communications at a first wireless device, comprising at least one means for performing a method of any of aspects 89 through 97.

Aspect 113: A non-transitory computer-readable medium storing code for wireless communications at a first wireless device, the code comprising instructions executable by a processor to perform a method of any of aspects 89 through 97.

Aspect 114: An apparatus for wireless communications at a first wireless device, comprising a processor; memory coupled with the processor; and instructions stored in the memory and executable by the processor to cause the apparatus to perform a method of any of aspects 98 through 102.

Aspect 115: An apparatus for wireless communications at a first wireless device, comprising at least one means for performing a method of any of aspects 98 through 102.

Aspect 116: A non-transitory computer-readable medium storing code for wireless communications at a first wireless device, the code comprising instructions executable by a processor to perform a method of any of aspects 98 through 102.

Aspect 117: An apparatus for wireless communication at a first wireless device, comprising a processor; memory coupled with the processor; and instructions stored in the memory and executable by the processor to cause the apparatus to perform a method of any of aspects 103 through 107.

Aspect 118: An apparatus for wireless communication at a first wireless device, comprising at least one means for performing a method of any of aspects 103 through 107.

Aspect 119: A non-transitory computer-readable medium storing code for wireless communication at a first wireless device, the code comprising instructions executable by a processor to perform a method of any of aspects 103 through 107.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a first wireless device, comprising:
a processor; and
memory coupled with the processor, the processor configured to:
communicate, with a second wireless device, a sidelink reference signal on a first active bandwidth part, the sidelink reference signal associated with a subsequent communication of a sidelink message on the first active bandwidth part;
determine whether a switch to a second active bandwidth part occurs prior to the communication of the sidelink message and after the communication of the sidelink reference signal; and
communicate the sidelink message on the first active bandwidth part in accordance with a first set of coherency transmission characteristics based at least in part on the determination.

2. The apparatus of claim 1, wherein, to communicate the sidelink message, the processor is configured to:
communicate, based at least in part on a determination that the switch fails to occur, the sidelink message in accordance with the first set of coherency transmission characteristics such that a relative difference between first communication characteristics associated with the communication of the sidelink reference signal and second communication characteristics associated with the communication of the sidelink message satisfies a threshold relative difference.

3. The apparatus of claim 1, wherein, to communicate the sidelink message, the processor is configured to:
communicate, based at least in part on a determination that the switch occurs, the sidelink message in accordance with the first set of coherency transmission characteristics such that a relative difference between first communication characteristics associated with the communication of the sidelink reference signal and second communication characteristics associated with the communication of the sidelink message fails to satisfy a threshold relative difference.

4. The apparatus of claim 1, wherein:
first communication characteristics associated with the communication of the sidelink reference signal comprise a phase associated with the communication of the sidelink reference signal, a transmission power associated with the communication of the sidelink reference signal, a time at which the sidelink reference signal is communicated, or a combination thereof; and
second communication characteristics associated with the communication of the sidelink message comprise a phase associated with the communication of the sidelink message, a transmission power associated with the communication of the sidelink message, a time at which the sidelink message is communicated, or a combination thereof.

5. The apparatus of claim 1, wherein the processor is further configured to:
communicate, based at least in part on the determination of whether the switch occurs, an indication of whether a relative difference between first communication characteristics associated with the communication of the sidelink reference signal and second communication characteristics associated with the communication of the sidelink message satisfies a threshold relative difference.

6. The apparatus of claim 1, wherein the processor is further configured to:
output, prior to the communication of the sidelink message, an uplink message to a network entity on the second active bandwidth part, wherein the determination of whether the switch occurs is based at least in part on the output of the uplink message.

7. The apparatus of claim 1, further comprising:
an antenna panel, wherein the processor and antenna panel are further configured to:
output an indication of a capability to maintain coherency between uplink transmissions when the processor is configured to switch between active bandwidth parts associated with uplink transmissions to a network entity, wherein the communication of the sidelink message is based at least in part on the output of the indication of the capability.

8. The apparatus of claim 7, wherein the processor is further configured to:
switch to the second active bandwidth part to output a second sidelink message prior to the communication of the sidelink message;
output, to the second wireless device, the sidelink reference signal having first transmission characteristics; and
output, to the second wireless device, the sidelink message having second transmission characteristics such that a relative difference between the first transmission characteristics and the second transmission characteristics satisfies a threshold relative difference based at least in part on the capability.

9. The apparatus of claim 7, wherein the capability is associated with a particular frequency band or a combination of two or more frequency bands.

10. The apparatus of claim 1, wherein, to determine whether the switch occurs, the processor is configured to:
determine whether a switch from a third active bandwidth part to the second active bandwidth part occurs prior to the communication of the sidelink message, the first active bandwidth part associated with a first component carrier, the second active bandwidth part and the third active bandwidth part associated with a second component carrier that is switched together with the first component carrier.

11. The apparatus of claim 10, wherein a same radio frequency chain is used to communicate the first component carrier and the second component carrier.

12. The apparatus of claim 1, wherein, to determine whether the switch occurs, the processor is configured to:
determine that the second wireless device switches to the second active bandwidth part prior to the communication of the sidelink message, the processor further configured to:
output, to the second wireless device and prior to the communication of the sidelink message, an indication of a precoding matrix, a spatial transmission beam, an antenna group, or a combination thereof, to use to output the sidelink message based at least in part on the determination that the second wireless device switches to the second active bandwidth part; and
obtain, from the second wireless device, the sidelink message based at least in part on the output of the indication of the precoding matrix, the spatial transmission beam, the antenna group, or the combination thereof.

13. The apparatus of claim 1, wherein, to determine whether the switch occurs, the processor is configured to:
determine that the second wireless device fails to switch to the second active bandwidth part prior to the communication of the sidelink message, the processor configured to:
obtain, from the second wireless device, the sidelink message in accordance with the first set of coherency transmission characteristics based at least in part on the determination that the second wireless device fails to switch to the second active bandwidth part.

14. The apparatus of claim 1, wherein the first active bandwidth part is an active bandwidth part associated with communication of sidelink messages and the second active bandwidth part is an active bandwidth part associated with transmission of uplink messages to a network entity.

15. The apparatus of claim 1, wherein the first active bandwidth part and the second active bandwidth part are active bandwidth parts associated with communication of sidelink messages.

16. An apparatus for wireless communications at a first wireless device, comprising:
a processor; and
memory coupled with the processor, the processor configured to:
communicate, with a second wireless device, a sidelink reference signal on a first active bandwidth part, the sidelink reference signal associated with a subsequent communication of a sidelink message on the first active bandwidth part;
determine whether a switch between a first duplex mode and a second duplex mode occurs prior to or concurrent with the communication of the sidelink message and after the communication of the sidelink reference signal; and
communicate the sidelink message on the first active bandwidth part in accordance with a first set of coherency transmission characteristics based at least in part on the determination.

17. The apparatus of claim 16, wherein, to communicate the sidelink message, the processor is configured to:
communicate, based at least in part on a determination that the switch fails to occur, the sidelink message in accordance with the first set of coherency transmission characteristics such that a relative difference between first communication characteristics associated with the communication of the sidelink reference signal and second communication characteristics associated with the communication of the sidelink message satisfies a threshold relative difference.

18. The apparatus of claim 16, wherein, to communicate the sidelink message, the processor is configured to:
communicate, based at least in part on a determination that the switch occurs, the sidelink message in accordance with the first set of coherency transmission characteristics such that a relative difference between first communication characteristics associated with the communication of the sidelink reference signal and second communication characteristics associated with the communication of the sidelink message fails to satisfy a threshold relative difference.

19. The apparatus of claim 16, wherein the first duplex mode is a full-duplex mode and the second duplex mode is a half-duplex mode.

20. The apparatus of claim 16, wherein the first duplex mode is a first full-duplex mode and the second duplex mode is a second full-duplex mode, the first full-duplex mode associated with a first uplink bandwidth, a first downlink bandwidth, or a combination thereof, the second full-duplex mode associated with a second uplink bandwidth different from the first uplink bandwidth, a second downlink bandwidth different from the second downlink bandwidth, or a combination thereof.

21. The apparatus of claim 16, further comprising:
an antenna panel, wherein the processor and antenna panel are further configured to:
output the sidelink reference signal while in operation in accordance with the first duplex mode; and
output, prior to the communication of the sidelink message and after an output of the sidelink reference signal, a second sidelink message while in operation in accordance with the second duplex mode, wherein the determination of whether the switch occurs is based at least in part on the output of the sidelink reference signal while in operation in accordance with the first duplex mode and the output of the second sidelink message while in operation in accordance with the second duplex mode.

22. The apparatus of claim 16, wherein the processor is further configured to:
output the sidelink reference signal while in operation in accordance with the first duplex mode; and
output the sidelink message while in operation in accordance with the second duplex mode, wherein the determination of whether the switch occurs is based at least in part on the output of the sidelink reference signal while in operation in accordance with the first duplex mode and the output of the sidelink message while in operation in accordance with the second duplex mode.

23. The apparatus of claim 16, wherein, to determine whether the switch occurs, the processor is configured to:
determine that the second wireless device switches between the first duplex mode and the second duplex mode prior to the communication of the sidelink message and after the communication of the sidelink reference signal, the processor configured to:
output, to the second wireless device and prior to the communication of the sidelink message, an indication of a precoding matrix, a spatial transmission beam, an antenna group, or a combination thereof, to use to output the sidelink message based at least in part on a determination that the second wireless device switches between the first duplex mode and the second duplex mode; and
obtain, from the second wireless device, the sidelink message based at least in part on the output of the indication of the precoding matrix, the spatial transmission beam, the antenna group, or the combination thereof.

24. An apparatus for wireless communications at a first wireless device, comprising:
a processor; and
memory coupled with the processor, the processor configured to:
output, to a second wireless device, a sidelink reference signal on a first component carrier, the sidelink reference signal associated with a subsequent output of a first sidelink message on the first component carrier;
determine whether to output, to a third wireless device, a second sidelink message on a second component carrier prior to the output of the first sidelink message and after the output of the sidelink reference signal, wherein a radio frequency chain is used to output the first sidelink message on the first component carrier in accordance with a first set of parameters and the radio frequency chain is used to output the second sidelink message on the second component carrier in accordance with a second set of parameters that is different from the first set of parameters; and
output, to the second wireless device, the first sidelink message in accordance with a first set of coherency transmission characteristics based at least in part on the determination.

25. The apparatus of claim 24, wherein, to output the first sidelink message, the processor is configured to:
output, based at least in part on a failure to output the second sidelink message, the first sidelink message in accordance with the first set of coherency transmission characteristics such that a relative difference between first transmission characteristics associated with the output of the sidelink reference signal and second transmission characteristics associated with the output of the first sidelink message satisfies a threshold relative difference.

26. The apparatus of claim 24, wherein the processor is further configured to:
output the second sidelink message on the second component carrier, wherein, to output the first sidelink message, the processor is configured to:
output, based at least in part on the output of the second sidelink message, the first sidelink message in accordance with the first set of coherency transmission characteristics such that a relative difference between first transmission characteristics associated with the output of the sidelink reference signal and second transmission characteristics associated with the output of the first sidelink message fails to satisfy a threshold relative difference.

27. The apparatus of claim 24, further comprising:
an antenna panel, wherein the processor and antenna panel are further configured to:
obtain an indication of a precoding matrix, a spatial transmission beam, an antenna group, or a combination thereof, to use to output the first sidelink message based at least in part on the determination, wherein, to output the first sidelink message, the processor is configured to output the first sidelink message in accordance with the indicated precoding matrix, spatial transmission beam, antenna group, or combination thereof.

28. An apparatus for wireless communication at a first wireless device, comprising:
a processor; and
memory coupled with the processor, the processor configured to:
obtain, from a second wireless device, a sidelink reference signal on a first component carrier, the sidelink reference signal associated with a subsequent transmission of a first sidelink message on the first component carrier;
output, to the second wireless device, an indication of a precoding matrix to use to output the first sidelink message, the precoding matrix based at least in part on a determination of whether coherent reception of the sidelink reference signal and the first sidelink message is expected at the first wireless device; and
obtain the first sidelink message based at least in part on the output of the indication of the precoding matrix.

29. The apparatus of claim 28, further comprising:
an antenna, wherein the processor is further configured to:
determine whether coherent reception of the sidelink reference signal and the first sidelink message is expected at the first wireless device based at least in part on a reception of an indication from the second wireless device that the second wireless device will coherently output the first sidelink message.

30. The apparatus of claim 28, wherein the processor is further configured to:
determine whether coherent reception of the sidelink reference signal and the first sidelink message is expected at the first wireless device based at least in part on a configuration of the processor to decode sidelink control information output by the first wireless device to determine whether the first wireless device outputs a second sidelink message on a second component carrier prior to the output of the first sidelink message and after the output of the sidelink reference signal.
